(19) United States
(12) Patent Application Publication
(10) Pub. No.: US 2020/0333045 A1
(43) Pub. Date: Oct. 22, 2020

(54) IMPROVED WATER HEATER CONTROL ARRANGEMENT AND ASSEMBLY

(71) Applicant: Rheem Australia PTY Limited, Rydalmere, New South Wales (AU)

(72) Inventors: Lee KERNICH, Rydalme, New South Wales (AU); Brendan BOURKE, Rydalme, New South Wales (AU); Peter KERR, Rydalme, New South Wales (AU); Quentin Arthur Carl ADAM, Rydalme, New South Wales (AU); Grant STEPA, Rydalme, New South Wales (AU)

(21) Appl. No.: 16/753,466

(22) PCT Filed: Apr. 27, 2018
(86) PCT No.: PCT/AU2018/050383

§ 371 Date: Apr. 3, 2020

(30) Foreign Application Priority Data
Oct. 4, 2017 (AU) PCT/AU2017/051081
Jan. 31, 2018 (AU) 2018200745

(51) Int. Cl. F24H 9/20; F24H 1/18; F24H 1/20; H02J 3/38; G05B 19/042

(52) U.S. Cl. CPC F24H 9/2021; F24H 1/185; F24H 1/202; G05B 2219/2658; G05B 19/042; H02J 2300/24; H02J 3/381

(57) ABSTRACT

An electric water heater tank adapted for connection to a controller, the tank including one or more electrical heating elements temperature sensing means mounted on the exterior of the tank wall and adapted to obtain a measurement of the temperature of the water in the tank, the temperature sensing means and each heating element being connected to an externally accessible connection means. The tank can include one or more heating element control means each connected to a corresponding one of the heating elements. The element control means can be connected to the externally accessible connection means.

### FIELD OF THE INVENTION

This invention relates to storage water heaters. This invention also relates to the utilization of renewable energy, and control systems relating to water heaters. This invention also relates to the control of electric water heaters.

### BACKGROUND OF THE INVENTION

Storage water heaters include an internal water tank, an outer jacket surrounding and spaced from the tank, the space between the tank and the jacket being substantially filled with thermal insulating material. The jacket can include apertures to allow inlet and outlet pipes to be connected to the tank through the jacket. In addition, apertures can be provided to enable additional items, such as electrical heating elements, to be connected to the interior or exterior of the tank.

Traditionally, power has been connected to the electrical heating elements of an electrical water heater via temperature control and thermal cut-out switches using a hard wired connection which requires an electrician to connect the power to the water heater.

The insulating material in electrically powered water heaters can be foam plastics which can be injected into the space between the tank and the jacket. This usually requires the provision of temporary closures, such as plastic caps, to close the jacket apertures to contain the foam between the tank and the jacket while the foam is being injected. Once the foam has set, the caps can be removed.

The inlet and outlet pipe fittings can be installed before the foam is applied, the jacket apertures being closed around the fittings by seals adapted to prevent the foam leaking from the insulation space around the fittings.

Utility companies have previously offered feed-in tariffs to encourage customers to adopt renewable energy sources such as solar photovoltaic or wind power, paying the customer more than the rate which the utilities charge customers for mains power. However, some utilities are now reducing or eliminating feed-in tariffs. Thus customers may prefer to prioritize the internal use of their renewable energy before using mains power and before delivering power to the mains. To do this, the customer will need to have a control system which implements this prioritization.

Australian patent no. 2005306582 (WO2006/053386), the contents of which are incorporated herein by reference, discloses a thermosensor strip supporting a number of individual thermistors which can be applied to the external wall of a water heater tank to obtain a measure of the tank water at a number of vertically separated points.

Climate science has generated a move to the use of renewable energy to produce electricity.

Rheem's Australian patent application 2016250449 (PCT/AU2017/051081), the contents of which are incorporated herein by reference, describes an arrangement for modulating the amount of renewable power delivered to a water heater or other appliance.

The sources of some forms of renewable energy, such as solar and wind, have a highly variable output. For example, solar collector output varies with the amount of insolation impinging on the collector, and this varies gradually with the position of the sun and rapidly with the passing of clouds. Similarly, wind generators are subject to wind fluctuations. While the invention is applicable to the different forms of renewable energy, the invention is described primarily in the context of a solar photovoltaic energy system.

With the adoption of smart electricity meters, power companies can charge different tariffs during periods of the day according to the load on the power generator equipment.

There are many ways of using solar energy and the invention will be described in the context of a solar electric storage water heater. Solar thermal water heating systems heat a heat transfer fluid and use this to heat water in a storage tank. Solar photovoltaic (PV) water heating systems convert solar energy to electric energy and use the electrical energy to heat a resistive heating unit in the tank. Water heating consumes about a quarter of a typical household's electricity usage for households equipped with electric water heaters. Water heating also makes up a significant portion of gas consumption for households with gas water heating. Solar energy is tariff free.

Solar thermal water heaters have a disadvantage in relation to solar electric water heaters in that, at low levels of insolation, if there is insufficient solar input to heat the heat transfer fluid above the temperature of the water in the tank, no useful energy can be collected. On the other hand, as long as there is sufficient solar input to a solar photovoltaic (PV) collector to generate electrical output, the heating unit can still deliver heat to the water in the tank due to the higher energy value of the PV energy, the thermal system having no useable energy when the temperature of the heat transfer fluid is not hotter than the water in the tank.

There are many roof top PV systems installed in Australia. These systems were popularised due to a generous feed in tariff that enabled their owners to receive a reasonable payback for their investment. Some solar PV systems were designed to maximize the benefit of the feed in tariff and delivered the PV power to the utility grid system. However, home owners with PV collectors may wish to use the PV energy to replace some or all of their utility grid power consumption. As water heating is a significant portion of household consumption, this invention proposes a system and method to utilize solar PV to supply a water heater.

One problem with solar energy is that it can be subject to random fluctuations especially on partially cloudy days.

Typically, electric storage water heaters have a single heating unit.

WO2014089215 describes a method of using DC from the solar collector to power the heating unit. A disadvantage of DC is that it is difficult to interrupt a DC current, and connector contacts can be eroded by sparks on switching the current off.

U.S. Pat. No. 5,293,447 (1994) describes a means for improving efficiency by measuring the incoming solar energy intensity and switching the resistance to approximate the maximum power point (MPP) at low levels of insolation. The heating unit is driven by DC from the PV collector. The system requires a separate heating unit for use with utility grid power.

Modulation of the current supplied to heating units is known. However, it has the problem that modulation systems may generate unacceptable amounts of electromagnetic interference or cause fluctuations in the power system.

It is desirable to provide an efficient means of delivering energy from the solar photovoltaic collector to the heating unit assembly of a water heater tank which mitigates or resolves one or more of these problems.

It is desirable to provide a means to facilitate internal consumption of PV energy or for adapting existing systems to this end.

It is also desirable to provide an effective means of adding heat to water in a water heater tank.

It is also desirable to devise a heating assembly which can be adapted to operate with existing water heater tanks.

Power supply utilities need to be able to deliver power over varying load conditions. Various factors can affect the demand for electric power, such as time-of-day, weather, network failure, generator failure and the like.

One known form of load management has been load shifting which has been applied to disconnecting non-critical customer loads, such as water heaters, from peak demand periods to off-peak periods. One method of doing this is ripple control, in which the utility sends a ripple signal over the power lines at a frequency different from the supply frequency. The ripple signal is detected at customer premises where a ripple detector detects the ripple signal and disconnects power to the water heater. A second ripple signal can be utilized to return power to the water heater. In some applications of ripple control, power to the water heater is measured by a separate meter so it can be charged at a concessional rate. One drawback of ripple control is that, where a large number of loads are switched off simultaneously, the sudden change in load can adversely affect the stability of the power generation system.

The Demand Response Enabling Devices (DRED) system is a more recent version of power line signalling to control air-conditioning loads.

Another imperative for power utilities is to reduce the amount of greenhouse gasses produced during power generation. Many power utilities have introduced renewable power sources such as solar and wind powered generators. A problem with these renewable power sources is that the output from such sources is intermittent and variable. Accordingly, power utilities have a requirement for a means of accommodating these fluctuations in power generation as well as fluctuations in demand.

RHEEM's co-pending patent application PCT/AU2017/051081, the disclosure of which is incorporated herein by reference, discloses a water heater having a multi-blade electrical heating element unit in which the blades can be energized individually or in combination to provide a range of power inputs to the water heater.

In addition, PCT/AU2017/051081 discloses a set of blade power ratings which can be operated in a mode to substantially reduce or eliminate a step change in power delivered to the water heater using a controlled method of modulating power to a single one of the blades.

Any reference herein to known prior art does not, unless the contrary indication appears, constitute an admission that such prior art is commonly known by those skilled in the art to which the invention relates, at the priority date of this application.

### SUMMARY OF THE INVENTION

Terms such as “left”, “right”, “upwardly” and “downwardly”, “horizontal”, “vertical”, “top”, “bottom”, “above”, “below” are used as relative terms for the purpose of description and do not define a strict requirement.

The term “thermosensor strip” as used herein, in the description and the claims, to refer to an elongate member having one or more thermosensor devices, such as thermistors, or to denote a strip containing a continuous thermosensor layer.

The term “externally accessible” as used herein, in the description and the claims, includes the case of a removable cover over the power connections, as well as connection means accessible from the outside of the water heater jacket or other cover on the water heater.

According to an embodiment of the invention, there is provided a water heating system including:
a water tank;
at least one electrical heating element unit;
the electrical heating unit including one or more independently controllable blades;
each blade being connected to an electrical power line via at least one corresponding power control arrangement;
wherein each electrical heating unit is inserted into the tank via a corresponding aperture in the tank.

The electrical element unit can include two blades.

The electrical element unit can include three blades.

The power control arrangement can include a switch.

The power control arrangement can include a power modulation device.

The power modulation device can produce a continually variable power output.

The water heating system can include a controller adapted to control each power control arrangement.

The controller can be adapted to change the maximum water temperature setting between a first temperature and a second temperature higher than the first temperature in response to a maximum temperature control signal.

The water heating system can also include a renewable energy supply, wherein the controller is adapted to change the maximum water temperature setting between a first temperature and a second temperature higher than the first temperature when sufficient renewable power is available.

The controller can be responsive to external control signals to operate one or more of the power control devices to control the amount of power delivered to the or each electrical heating element unit.

The controller can be responsive to external control signals to operate one or more of the power control devices to control the amount of power delivered to the or each electrical heating element unit.

The external control signal can be selected from one or more of: power line signalling; wireless; physical line.

The electrical heating element unit can include a mounting flange

The tank can include an electrical heating element unit mount.

The electrical heating element unit can include a connection terminal for each blade and a common terminal common to all blades.

The water heating system can be powered by solar power or mains power.

The water heating system can include a directional power meter.

There is also disclosed a method of controlling the delivery of electric power to an electrical water heater including one or more electrical heating blades, the method including the steps of: monitoring for the presence of one or more external power regulation signals; in the absence of an external power regulation signal, delivering mains power to the water heater the, or each, blade in accordance with a first routine;

in the presence of an external regulation signal; analyzing the external regulation signal; and depending on the analysis of the external regulation signal, either varying the power delivered to the blades, or cutting off the power to the blades.

The external regulation signal can be selected from: one or more power variation signals; and a cut off signal.

According to an embodiment of the invention, there is provided a method of controlling the delivery of power to an electrical water heater having access to both renewable power and mains power, the method including the steps of: monitoring the availability of renewable power for heating the water in the water heater; where renewable power is available; monitoring for the presence of an external override signal; where the override signal is not present; monitoring the heat content of the water heater; when the heat content is below a threshold value, delivering renewable power to the water heater; when the content is equal to or above the threshold value, delivering the renewable power to the mains power grid; where the override signal is present, delivering the excess renewable power to the mains grid.

According to an embodiment of the invention, there is provided an electrical water heater controlling arrangement including a water tank, at least two heating element blades, each blade being separately controllable via power control means, a controller adapted to control the power control means, the controller including an instruction store or memory, the controller having a programming input via which instructions can be stored in the instruction store or memory.

The instructions can be sent to the programming input via a communication link.

According to an embodiment of the invention, there is provided an electric water heater adapted for connection to a controller, the heater including a tank, one or more electrical heating elements, temperature sensing means mounted on the exterior of the tank wall and adapted to obtain a measurement of the temperature of the water in the tank, the temperature sensing means and each heating element being connected to an externally accessible connection means.

The present invention also provides an electric water heater tank adapted for connection to a controller, including one or more electrical heating elements, each heating element being connected to an externally accessible connection means, wherein the tank is configured with one or more of the following: temperature sensing means adapted to obtain a measurement of the temperature of the water in the tank; a power control device being connected to the externally accessible connection means; one or more temperature control switches each connected to a corresponding one of the heating elements; a heat sink.

The water heater can include one or more heating element control means each connected to a corresponding one of the heating elements.

The heating element control means can include one or more thermal cut-out switches adapted to disconnect power from the or each electrical heating element when the temperature of the water exceeds a first threshold temperature.

The heating element control means can include one or more temperature control switches, each switch being adapted to disconnect power from a corresponding one of the electrical heating elements.

The or each temperature control switch can be connected to the externally accessible connection means.

The present invention provides an electric water heater having a tank, one or more heating elements located at different heights within the tank, and one or more first element controllers, each associated with a corresponding one of the heating elements;
the heating elements having electrical connections projecting through the wall of the tank;
each first element controller being mounted adjacent to, or the vicinity of the electrical connections of the heating elements. The first element controllers can be interconnected by a first harness carrying power and control conductors.

The element controllers can include a first electrical cut-out switch including first temperature sensing means adapted to cut off power to the corresponding heating element when the temperature of the water reaches a first threshold temperature.

Each element controller can include second temperature sensing means and power control switches adapted to cut off power to the corresponding heating element when the temperature of the water reaches a second threshold temperature lower than the first temperature threshold.

Each element controller can include a power switch controller controlling corresponding power switches.

The power control switches can be mounted on or near respective ones of the first element controllers.

The electrical water heater can include one or more thermosensors, a second harness including first connector for a thermosensor, second connector for power, a third connector for external connection.

The water heater can include one or more thermosensors mounted on the exterior of the tank and connected to one of the element controllers, the or each element controller being responsive to temperature information from the or each thermosensor to control the or each electrical heating element.

According to an embodiment of the invention, there is provided an electrical water heater element control unit including:
a first PCB including first electrical components, and a first electrical connector;
a second PCB including second electrical components, and a second electrical connector being a mating connector for the first connector;
the first and second connectors being dimensioned and oriented so that, when the first and second connectors are engaged, the second PCB is located in close proximity to the first PCB and the first electrical components, and or in a separate plane from the plane of the first PCB and the first electrical components.

The first electrical components can include one or more power switching devices, and the second electrical components can include a power switch controller adapted to control the power switching device or devices on the first PCB.

The electrical water heating element control unit can include a mounting frame adapted to facilitate mounting of the first PCB on an electrical cut-out switch.

According to another embodiment of the invention, there is provided an electrical water heating element control assembly including an electrical water heating element control unit mounted on an electrical cut-out switch.

The present invention also provides an electrical water heater including a tank, a first heating element, and one or more further heating elements located at different heights within the tank, and two or more element controllers, each associated with a corresponding one of the heating elements; the heating elements having electrical connections projecting through the wall of the tank; each element controller being mounted adjacent to, or in the vicinity of, the electrical connections of the heating elements.

A wiring harness can be utilised to connect the first heating element with the other heating elements, which can include a single connector adapted to connect both signalling and power wires to external connections and or one or more controllers.

The first heating element and or the one or more further heating elements can include two or more blades,

The element controller can include an electric cut-out and or relays to control blades of the first heating element and or the one or more further heating elements.

The blades can be of the same resistance and or power output rating or are of differing resistance and or power output rating.

According to another embodiment of the invention, there is provided a method of providing at least a minimum volume of usable hot water in a water the method including the steps of:
A. setting a minimum volume of hot water;
B. determining whether the water heater contains the minimum volume of usable hot water;
C. determining whether renewable power is available; and
D. where renewable power is not available and the water heater contains less than the minimum volume of usable hot water:
E. applying mains power to the water heater heating elements until either
E1. the water heater contains the minimum volume of usable hot water, or
E2. renewable power becomes available, and,
F. when the water heater contains the minimum volume of usable hot water,
G. switching the mains power to the water heater heating elements off; and
H. when renewable power becomes available before the water heater contains the minimum volume of usable hot water,
I. switching the mains power to the water heater heating elements off, and
J. switching the renewable power to the heating elements on until either:
J1. the water heater contains a second volume of usable hot water greater than the minimum volume of usable hot water, or
J2. the renewable power becomes unavailable; and,
K. where step C determines that renewable power is available,
L. switching the renewable power to the heating elements on until either:
L1. the water heater contains a second volume of usable hot water greater than the minimum volume of usable hot water, or
L2. the renewable power becomes unavailable; and
M. where condition L1 applies, switching the renewable power to the heating elements off;
N. where condition L2 applies, returning to step B;
O. repeating steps B to J2 or C and K to L2 depending on the availability of renewable power to ensure that the minimum volume of hot water is maintained.

The water heater can include a mains power source and a source of renewable power.

According to a further embodiment of the invention, there is provided an electric water heater including: a tank;
one or more electrical heating elements within the tank;
electrical connections for the heating elements projecting through the wall of the tank;
at least one thermosensor;
a combined wiring harness having an externally accessible first external connector adapted to connect both power wires and signalling wires to external circuitry via a complementary second external connector.

The external connector can be located within or outside a jacket.

The combined wiring harness can include a signalling connector adapted to connect one or more signalling wires to a signalling cable to the external connector.

The wiring harness can include a power connector adapted to deliver power from the external connector to the or each heating element.

The water heater can include an external controller, the signalling wires being connected to the controller.

The water heater can include one or more external power switches responsive to the external controller to control delivery of power to the heating elements.

According to another embodiment of the invention, there is provided an electric water heater including a tank, a power control element, and a heat sink, the tank including a cold water inlet proximate the lower end of the tank and a hot water outlet proximate the upper end of the tank, the heat sink being mounted on a first heat sink attachment proximate the lower end of the tank, the power control element being mounted on the heat sink.

A first heat sink mounting attachment can be attached to the wall of the tank proximate to the lower end of the tank.

The heat sink can include a curved surface adapted to conform to the wall of the tank or to have a slightly smaller radius than the curve of the tank wall.

The heat sink can include a heat conductive body having a tank mounting surface, the tank mounting surface having a contour complementary to a portion of a wall of a water heater tank.

The heat sink can include a first mounting recess adapted to accommodate a mounting member attached to a wall of a tank, and a second mounting recess adapted to accommodate a second mounting member, the second recess communicating with the first mounting recess whereby the second mounting member is enabled to interconnect with the first mounting member.

The heat sink can include a component mount.

According to a further embodiment of the invention, there is provided a foam dam adapted to exclude foam insulation from the heating element control arrangements.

The foam dam can be adapted to conform to a tank wall.

The foam dam can be adapted to conform to a jacket wall.

According to another embodiment of the invention there is provided a water heater including such a foam dam.

According to an embodiment of the invention, there is provided a foam dam adapted to provide an insulation free space in an injection foam insulation space, the dam including first and second attachable sections, each section being designed to define a complementary portion of the insulation free space, each attachable section including:
one or more interlock arrangements adapted to mate with corresponding interlock arrangements on the other attachable section;
each interlock arrangement including a first interlock member and a second interlock member, the first and second interlock members being adapted to produce mutually opposite interlocking forces when the two attachable sections are assembled together.

The first interlock member of a first attachable section can include

a first profiled member having a first interlocking face directed away from a second attachable section, wherein the second attachable section includes a second profiled member having a second interlocking face directed away from the first attachable section, the second profiled member of the second interlock arrangement being inverted with respect to the first profiled member, the first and second interlocking faces being engaged to prevent tangential separation of the first and second attachable sections.

Each profiled member can be tapered to facilitate engagement.

The second interlock member of a first attachable section can include a first inclined surface divergent towards the second attachable section.

According to an embodiment of the invention, there is provided a water heater having two or more heating elements and associated heating element control arrangements located at separate positions in the tank.

The heating element control arrangements can include a thermal cut-out switch.

The heating element control arrangements can include a temperature controller.

The control elements can be interconnected with a control harness.

A thermosensor can be connected to at least one of the control elements.

According to an embodiment of the invention, there is provided a temperature sensor assembly housing including an elongate tubular member having a tank-contacting surface of thermally conductive material, the tubular member including one or more internal channels, each channel being adapted to receive a thermosensor assembly.

The temperature sensor assembly housing can include an end cap to close a distal end of the tubular member.

According to an embodiment of the invention, there is provided an electric water heater adapted for connection to a controller, the heater including a tank, one or more electrical heating elements, and temperature sensing means adapted to obtain a measurement of the temperature of the water in the tank, the temperature sensing means and each heating element being connected to an externally accessible connection means.

The water heater can include one or more heating element control means each connected to a corresponding one of the heating elements.

The heating element control means can include one or more thermal cut-out switches adapted to disconnect the or each electrical heating element when the temperature of the water exceeds a first threshold temperature.

The heating element control means can include one or more temperature control switches, each switch being adapted to disconnect power from a corresponding one of the electrical heating elements when the temperature of the water exceeds a second threshold temperature.

The or each temperature control switch control means can be connected to the externally accessible connection means.

The temperature sensing means can be or are adapted to obtain temperature of water at different heights in the tank.

The temperature sensing means can be located outside or inside of the tank.

According to another embodiment of the invention, there is provided a thermostat mounting including a relay board and a thermostat controller board mounted to the relay board.

The relay board can be mounted to a thermal cut out switch.

According to a further embodiment of the invention, there is provided an improved water heater having two or more heating elements and at least one tank temperature sensors, with power/control/data cabling terminating in a plug or socket, whether in side jacket or mounted through jacket, for later connection to an external controller.

The present invention also provides a method of installing a water heater including a tank configured with at least a temperature sensor and one or more heating element connected to an externally accessible connection means, the method including the steps of installing the tank at a user's premises, and connecting a variable power supply and controller to the externally accessible connection means.

The tank can be configured with a heat sink and power control device.

The tank can be configured with temperature control switches proximate the or each heating element.

The method can include the step of installing temperature control switches upstream of the connection means.

The method can include the step of installing the power control device upstream of the connection means.

According to an embodiment of the invention, there is provided a control system for a variable energy source utility grid feed-in system having at least a first energy consuming component having a first supply priority, and a second energy consuming component having a second energy supply priority, the first energy supply priority being greater than the second energy supply priority, the controller receiving current flow information identifying current inflow from the utility grid or current flow to the utility grid, the controller being adapted to control the flow of energy to the second energy consuming component, the controller being adapted to control the delivery of energy from the variable energy source in order of priority to the first energy consuming component, the second energy consuming component, and the utility grid feed-in.

The control system can include a status monitoring means adapted to monitor a condition of the second energy consuming component for use in regulating the flow of energy to the second energy consuming component.

The status monitoring means can include at least one of a thermostat or a temperature sensor.

The status monitoring means can include a battery charge monitor.

According to an embodiment of the invention, there is provided a first controller for a variable energy source utility grid feed-in system having a first energy consuming component having a first supply priority, and at least a second energy consuming component having a second energy supply priority, the first energy supply priority being greater than the second energy supply priority, the controller receiving status information from the energy storage component, the controller receiving current flow information identifying current inflow from the utility grid or current flow to the utility grid, the energy storage component having a controllable load controlled by the controller, the controller being adapted to control the controllable load to prioritize deliver energy from the variable energy source in order to the first energy consuming component, the second energy consuming component, and the utility grid feed-in.

The second energy consuming component can be a water heater.

The status information can be temperature information.

The controllable load can include a modulator adapted to modulate the variable energy source, and at least a first and a second heating element, wherein the modulator modulates the delivery of energy to the first heating element under the control of the controller.

At least the second heating element is switchable.

All heating elements can be switchable.

According to an embodiment of the invention there is provided a water heating system having: a water storage tank having: a temperature sensor; a heating unit having at least first and second heating elements at least one of which is switchable; a controller adapted to receive temperature information from the temperature sensor and current flow direction information from a current sensor sensing the inflow or outflow of utility grid current; a modulator adapted to modulate the flow of energy from a variable energy source to at least the first heating element under the control of the controller; wherein at least the second heating element is switchable under the control of the controller; the controller being adapted to control the modulator and the switching of the or each switchable heating element to prioritize delivery of energy from the variable energy source to internal consumption systems before utility grid feed-in.

All the heating elements except the first heating element can be switchable under the control of the controller.

Alternatively, all the heating elements can be switchable under the control of the controller.

The impedance of the heating elements of a heating unit can be R, R/1, R/2 . . . R/(N−1), where R is the resistance of the first heating element, and N is the number of heating elements in the heating unit.

Each successive heating element can draw the same amount of power as the power drawn by the sum of the preceding heating elements.

The variable energy source can be a photovoltaic (PV) energy source.

According to an embodiment of the invention, there is provided a variable energy supply system adapted to provide utility grid feed-in, the variable energy supply system including one or more consumption components, one of which is a water heating system, the variable energy supply system including: a variable energy source; an energy converter to convert the output from the variable source to an alternating energy supply equivalent to an alternating utility grid supply; wherein the water heating system includes a water heater tank including at least at least first and second heating elements, at least one of which is switchable; a modulator to modulate the alternating energy supply from the inverter; a controller adapted to control the modulator and the switching of the or each switchable heating element to prioritize delivery of energy from the variable energy source to internal consumption systems before utility grid feed-in.

The system can include a bidirectional utility grid current sensor adapted to indicate to the controller the direction of energy flow to or from the utility grid, wherein the controller increases the energy to the heating elements until all the energy from the variable energy source is consumed by the internal consumption systems or until energy is drawn from the utility grid.

A heating unit can have N heating elements, a first element can have an power rating of V²/R1, a second heating element can have power rating of V²/R1, and the remaining elements can have power ratings increasing by V²/R1 to a power rating of (N−1)*V²/R1. The heating elements can be connected in parallel.

The or each heating unit can include first, second and third heating elements, wherein the first element is modulated, the modulated element having a first power rating of V²/R1, the second element has a second power rating of V²/R1, and the third element has an power rating of 2*V²/R1.

Each heating element of the first heating unit can be switchable.

The variable energy source can be a solar photovoltaic (PV) energy supply system including a first temperature sensor adapted to measure the temperature of water in the tank and to communicate the temperature measurement to the controller, the controller being adapted to switch off the delivery of energy to the tank when the temperature of the water exceeds a threshold value.

The solar photovoltaic (PV) energy supply system can include a battery chargeable by the PV collector, the controller being adapted to switch PV energy from the PV collector to the water heater when other loads are met and the battery is fully charged before power is diverted to the water heater.

The solar photovoltaic (PV) energy supply system can include a utility grid energy connection adapted to supply energy to the first heating unit under control of the controller when the output from the PV collector is below a minimum value.

The solar photovoltaic (PV) energy supply system can include first and second multi-element heating units, and a changeover switch controlling the neutral connection of the two heating units, corresponding elements of the first and second heating units being controlled by the same switches.

According to an embodiment of the invention, there is provided a method of utilizing solar photovoltaic energy in an impedance load, the impedance load including two or more impedance components, at least one of which is switchable, the method including the steps of:
converting DC energy from a solar photovoltaic (PV) collector to produce an unmodulated alternating supply;
modulating the unmodulated alternating supply to produce a modulated alternating supply;
applying the modulated alternating supply to one or more of the load components.

The method of utilizing solar photovoltaic energy can include the step of:

applying the modulated alternating supply to only one of the impedance components.

The method of utilizing solar photovoltaic energy can include the step of:

monitoring the direction of energy flow to or from the utility grid.

The method of utilizing solar photovoltaic energy can include the step of:
applying the unmodulated alternating supply to at least one other impedance component.
The method can include the steps of: initially reducing the modulated alternating supply voltage to a minimum value, and
increasing the modulated alternating supply voltage until a maximum current is drawn, or
until the maximum modulated alternating supply voltage is reached,
in the case where modulated alternating supply voltage is reached,
reducing the modulated alternating supply voltage to the minimum,
switching on a second impedance component,
increasing the modulated alternating supply voltage applied to the first impedance element, and repeating steps i) to l) until energy flow to the utility grid ceases.

The method can include the steps of:

monitoring the direction of energy flow to or from the utility grid.

The method can include the steps of:
varying the modulation of the modulated alternating supply;
determining when the flow of energy to the utility grid ceases; and
maintaining the modulation at a level which maintains the energy delivered to the first impedance at or approximate to the level where the flow of energy to the utility grid ceases.

The first impedance component can be switchable.

All the heating elements of the first heating unit can be switchable.

According to an embodiment of the invention there is provided a method of utilizing a variable energy source together with an alternating utility grid supply to provide power for at least two loads, at least a first of the loads being controllable, the utility grid supply and the variable energy source being connected to a common conductor, wherein the first load is prioritized after the remaining load or loads, and the variable energy supply is adapted to deliver its available energy to the loads in priority to the utility grid supply, the method including the steps of:
monitoring the flow of current to or from the utility grid supply;
where current is flowing to the utility grid supply, increasing the energy supplied to the first load until either:
A. the flow of current to the utility grid ceases; or
B. the maximum energy available from the variable energy source is delivered to the first load.

The first load can include two or more heating elements; wherein a first heating element is supplied from the variable energy source via a controllable power modulator, and wherein the remaining heating elements are switchable in a parallel configuration with the first heating element; and
the step of increasing the energy supplied to the first heating element can be performed by continually increasing the output from the power modulator until either:
C. the flow of current to the utility grid ceases; or
D. the output of the modulator reaches a maximum;
wherein, if the modulator output reaches the maximum,
the modulator output is reduced,
a second heating element is switched on in parallel with the first heating element, and
the modulator output is continually increased, until either condition C or condition D is reached, wherein if condition D is reached, the process of switching on further heating elements in parallel is carried out until either all the heating elements are switched on and the modulator output is at the maximum; or until the flow of current to the utility grid ceases.

The method can further include repeatedly reducing the modulator output to zero, switching each of the remaining heating elements on sequentially and increasing the modulator output to its maximum or until the flow of current to the utility grid ceases.

According to an embodiment of the invention, there is provided a method of operating a water heater connected to a utility grid and to a variable energy source, the heater having an upper heating unit and a lower heating unit, wherein at least the upper heating unit has two or more heating elements, the method including the steps of detecting the flow of energy from the variable energy source to the utility grid, applying a first amount of energy to the upper heating unit, and applying a second amount of energy to the lower heating unit, increasing the amount of energy delivered to the upper heating unit, monitoring the flow of energy from the variable energy source to the utility grid, and ceasing to increase the delivery of energy from the variable energy source to the upper heating unit when the flow of energy from the variable energy source to the utility grid ceases.

According to an embodiment of the invention, there is provided a controller for a solar PV energy supply system adapted to provide utility grid energy feed-in, and to deliver energy to one or more internal consumption systems one of which is a water heating system having a heating unit with one or more heating elements, wherein the solar PV energy is converted to an alternating PV energy supply controllable by the controller, the controller being adapted to monitor the direction of energy flow to or from the utility grid and to control the alternating PV energy supply to prioritize the energy delivered to the internal consumption systems in preference to the utility grid feed-in.

The water heating system includes a storage tank with at least one heating unit and an energy modulator adapted to modulate the alternating PV energy supply, the heating unit having at least two switchable heating elements at least one of which is supplied with energy from the modulator, the controller being adapted to control the modulator to prioritize delivery of energy to the water heater in preference to the utility grid energy feed-in.

The controller can be adapted to initially reduce the modulator output to zero and apply the modulator output to a first heating element, and progressively increase the modulator output to a maximum, and progressively switch in additional heating elements as required until maximum energy is delivered from the PV collector or the flow of energy to the utility grid ceases.

When switching in each successive heating element, the controller reduces the modulator output to the first heating element to zero, and then progressively increases the modulator output to the first heating element.

According to an embodiment of the invention, there is provided a method of utilizing solar photovoltaic energy in a system having a first load circuit, a water heater and a utility grid feed-in path, the system including a controller controlling delivery of the PV energy to the water heater, wherein the controller prioritizes the delivery of PV collector energy to the first load, the water heater and the utility grid feed-in.

The method can include the step of: providing hysteresis in the switching of elements.

Hysteresis can be provided by imposing non-zero modulated energy to the switchable element during each switching operation.

Hysteresis can be provided by imposing delaying the switching of elements.

The system can include a PV storage battery, and wherein the controller can prioritize the delivery of PV collector energy to the first load, the water heater, the battery, and the utility grid feed-in.

According to an embodiment of the invention, there is provided a variable energy usage arrangement for a water heater the arrangement to control energy flow from a variable energy supply and a utility grid supply to a water heater, the arrangement including a controller, a modulator, a heating unit having at least first and second heating elements and an attachment flange, wherein the second and any further heating elements being switchable, the controller being adapted to control the modulator and the switchable elements, the modulator being adapted to deliver a controllable power output to the first heating element under the control of the controller, the attachment flange being adapted for sealed attachment to a water heater tank, the controller being adapted to monitor the direction of current flow outwards to the utility grid supply or inwards from the utility grid supply, the controller being adapted to control the modulator and the switchable elements, to minimize or eliminate current flow out to the utility grid supply.

### BRIEF DESCRIPTION OF THE DRAWINGS

A detailed description of a preferred embodiment will follow, by way of example only, with reference to the accompanying figures of the drawings, in which:

FIG. 1 illustrates a storage water heater according to an embodiment of the invention.

FIG. 2 illustrates an exploded view of the water heater of FIG. 1.

FIG. 3 illustrates a view of the tank of the water heater of FIG. 1 a view of the water heater tank, with its outer jacket absent.

FIG. 4 is a front view of the water heater of FIG. 3.

FIG. 5 illustrates a view of the water heater of FIGS. 3 and 4.

FIGS. 6A to 6H illustrate various embodiments of temperature sensor arrangements according to embodiments of the invention.

FIGS. 7A to 7D illustrate various views of a foam dam according to an embodiment of the invention.

FIGS. 8A to 8F illustrate various views of the interlocking elements of the foam dam according to an embodiment of the invention.

FIGS. 8G to 8I illustrate details of the interlocking elements of the foam dam.

FIGS. 9A to 9F illustrate various views of a section of the foam dam of FIG. 7.

FIG. 10 illustrates a front view of an assembled foam dam according to an embodiment of the invention.

FIG. 11A illustrates a partial view of a tank's flange attachment for a heating element.

FIG. 11B illustrates a first exploded view of the foam dam of FIG. 10.

FIG. 12 illustrates a second exploded view of the foam dam of FIG. 10.

FIGS. 13A, 13B, 13C, 13D, 13E illustrate section views of a foam dam according to an embodiment of the invention.

FIG. 14A illustrates a water heater tank and control arrangement according to an embodiment of the invention.

FIG. 14B illustrates a flow chart for a mode of operating a water heater according to an embodiment of the invention.

FIG. 15A illustrates a water heater tank according to an embodiment of the invention.

FIG. 15AA illustrates a method of installing a water heater according to an embodiment of the invention.

FIGS. 15B and 15C illustrate continuous thermosensor strips according to an embodiment of the invention.

FIG. 15D schematically illustrates an electric water heater arrangement according to an embodiment of the invention.

15E schematically illustrates an electric water heater arrangement according to an embodiment of the invention.

FIG. 15F is a block diagram illustrating functional elements of a water heater control system according to an embodiment of the invention.

FIGS. 16A & 16B illustrate features of a water heater with a heat sink according to an embodiment of the invention.

FIG. 17 illustrates an underside view of the water heater of FIG. 16.

FIG. 18 illustrates a water heater with a heat sink according to an embodiment of the invention.

FIG. 18A illustrates a method of installing a water heater according to an embodiment of the invention.

FIG. 19 illustrates a second water heater with a heat sink according to an embodiment of the invention.

FIG. 19A illustrates a water heater similar to FIG. 19 with a heat sink, and an internal blind tube, in to which is mounted a plurality of thermosensors.

FIG. 20 illustrates a heat sink mounting arrangement according to an embodiment of the invention.

FIGS. 21A and 21B illustrates other views of the heat sink of FIG. 20.

FIG. 22 illustrates a second foam dam for the heat sink of FIG. 20 according to an embodiment of the invention.

FIG. 23 illustrates a controller circuit board arrangement according to an embodiment of the invention.

FIG. 24 illustrates a first exploded view of a thermal cut-out switch and a controller assembly according to an embodiment of the invention.

FIG. 25 illustrates a second exploded view of a thermal cut-out switch and a controller assembly according to an embodiment of the invention.

FIG. 26 illustrates a section view of a controller and thermal cut-out switch assembly of FIG. 27.

FIG. 27 illustrates a controller and thermal cut-out switch assembly according to an embodiment of the invention.

FIG. 28 illustrates a side view of the controller and thermal cut-out switch assembly of FIG. 27.

FIG. 29 illustrates an exploded view of the controller and thermal cut-out switch assembly of FIG. 27.

FIG. 30 shows a wiring diagram for a relay board and wiring harness assembly according to an embodiment of the invention.

FIG. 31A illustrates a PV water heater arrangement according to an embodiment of the invention.

FIG. 31B illustrates an embodiment of the invention including a thermostat and a power control arrangement according to an embodiment of the invention.

FIG. 31C illustrates an embodiment of the invention having one modulated switchable element and one switchable, non-modulated element.

FIG. 32A illustrates a PV water heater arrangement according to another embodiment of the invention.

FIG. 32B illustrates a modified circuit diagram for a dual element water heating system according to an embodiment of the invention.

FIG. 32C shows detail of a parallel arrangement of a triac and a relay.

FIGS. 33A, 33B, 33C and 33D illustrate heating element switching plans according to corresponding embodiments of the invention.

FIG. 34 illustrates a flow diagram showing a method of operating a water heating system according to an embodiment of the invention.

FIG. 35 illustrates modes of modulating AC power.

FIG. 36 illustrates a heating unit having two separately operable heating elements.

FIG. 37 is a schematic illustration of a water heater control system with power line signalling according to an embodiment of the invention.

FIG. 38 is a schematic illustration of a water heater control system with power line signalling according to an embodiment of the invention.

FIG. 39 is a schematic illustration of a water heater control system with power line signalling according to an embodiment of the invention.

FIG. 40 is a schematic illustration of a water heater control system with power line signalling according to an embodiment of the invention.

FIG. 41 is a schematic illustration of a water heater control system with power line signalling according to an embodiment of the invention.

FIG. 42 is a schematic illustration of a water heater control system with power line signalling according to an embodiment of the invention.

FIG. 43 is a schematic illustration of a water heater control system with power line signalling according to an embodiment of the invention.

FIG. 44 is a schematic illustration of a water heater control system with power line signalling according to an embodiment of the invention.

FIG. 45 is a schematic illustration of a water heater control system with power line signalling according to an embodiment of the invention.

FIG. 46 is a schematic illustration of a multi-blade water heating element unit for use in a water heating system according to an embodiment of the invention.

FIG. 47 schematically illustrates a section of a water heater tank wall including an element mount.

FIG. 48 illustrates a schematic of a water heater system according to an embodiment of the invention;

FIG. 49 schematically illustrates a controller for a water heater control system according to an embodiment of the invention.

FIG. 50 is a flow diagram illustrating a method of controlling a water heating system in accordance with an embodiment of the invention.

FIG. 51 is a flow diagram illustrating a method of controlling a water heating system in accordance with an embodiment of the invention.

FIG. 52 shows an exploded view of a controller according to an embodiment of the invention.

FIG. 53 shows the piggy-back printed circuit board mounted to relay board.

FIG. 54 illustrates a switching configuration for a three blade heating element according to an embodiment of the invention.

FIG. 55 illustrates a switching configuration for a three blade heating element according to an embodiment of the invention.

FIG. 56 illustrates a switching configuration for a three blade heating element according to an embodiment of the invention.

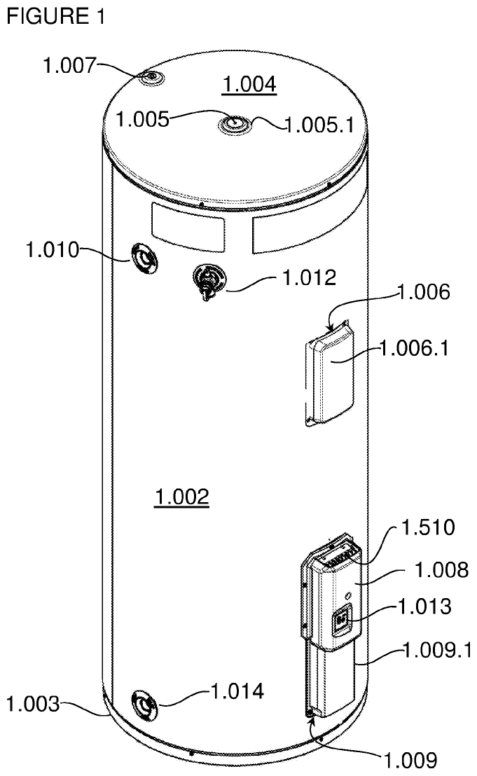

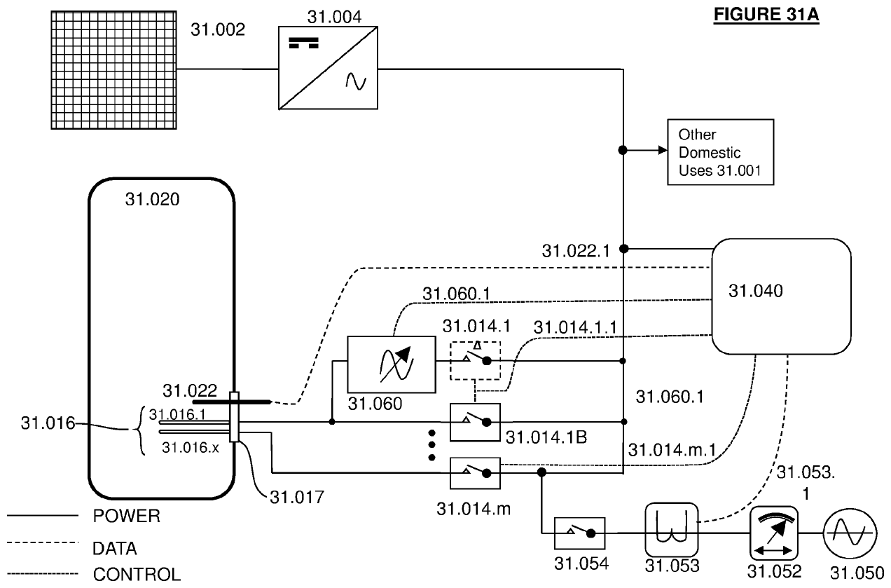

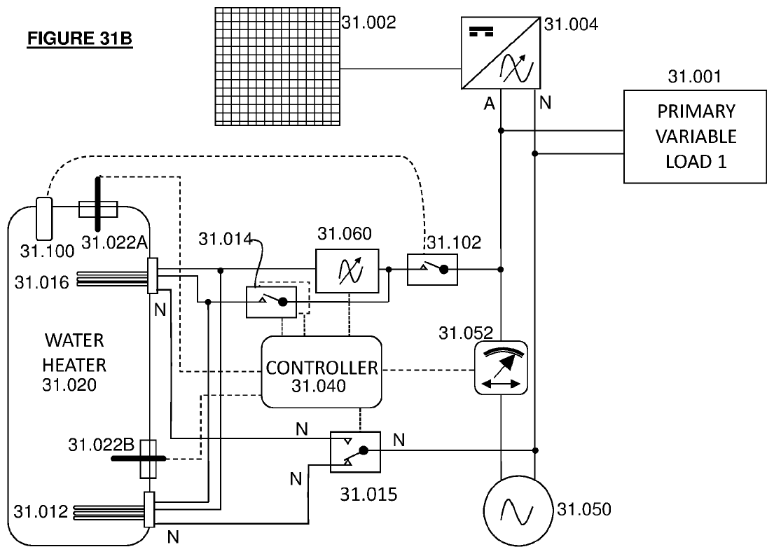

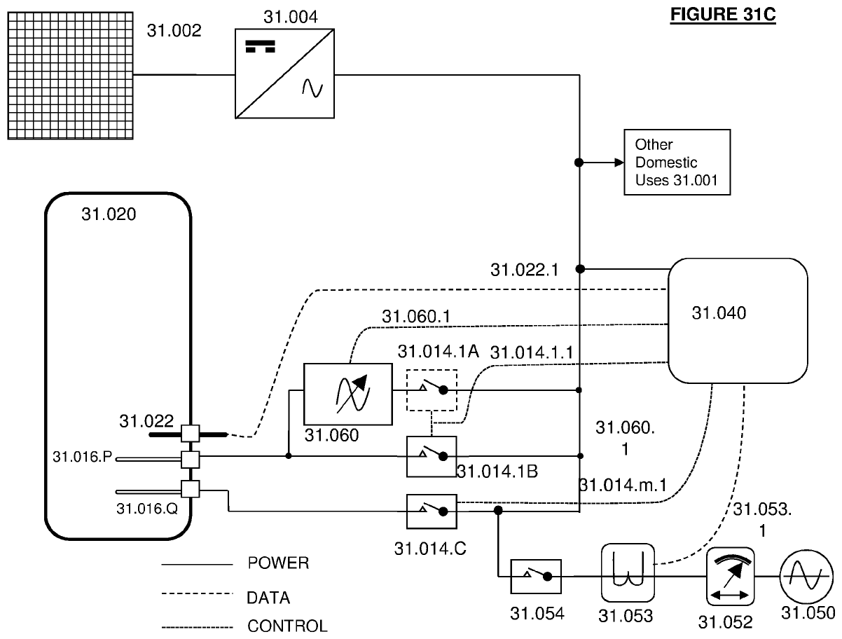

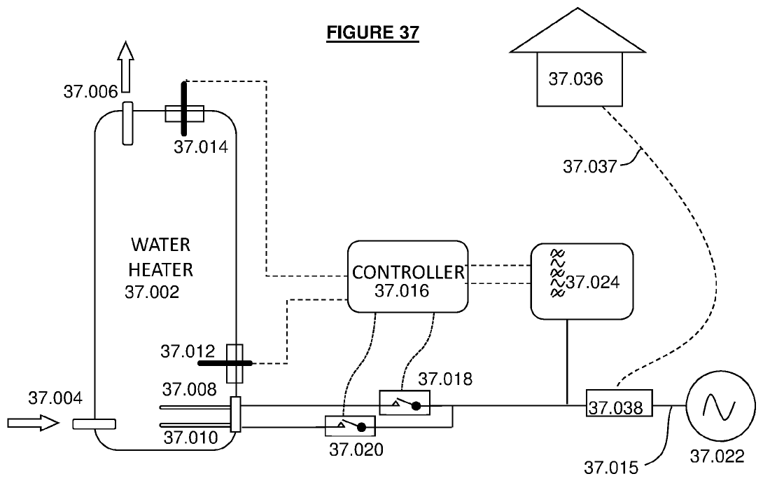

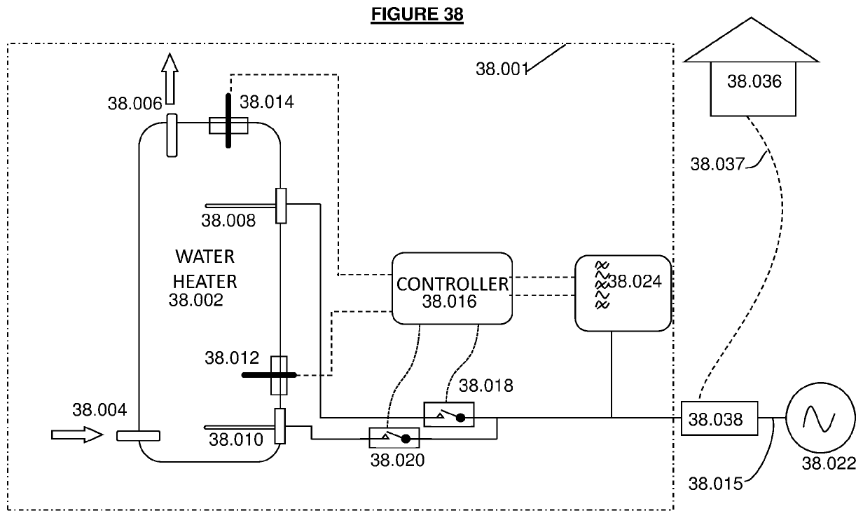

The numbering scheme used in the drawings is that the digits after the first decimal point are item numbers and the digits preceding decimal point correspond to the drawing number. If two decimal points are present the digits after the second decimal point is an extension used where it is desirable to emphasize similar or related items. For FIGS. 1 to 30 the digits after the first decimal point are item numbers, and these item numbers are used throughout these FIGS. 1 to 30 in a consistent fashion where the same feature, part or component is indicated, and its use purpose and function are substantially the same in these FIGS. 1 to 30. For FIGS. 31 to 36 the digits after the first decimal point are item numbers, and these item numbers are used throughout these FIGS. 31 to 36 in a consistent fashion where the same feature, part or component is indicated, and its use purpose and function are substantially the same in these FIGS. 31 to 36. For FIGS. 37 to 56 the digits after the first decimal point are item numbers, and these item numbers are used throughout these FIGS. 37 to 56 in a consistent fashion where the same feature, part or component is indicated, and its use purpose and function are substantially the same in these FIGS. 37 to 56.

### DETAILED DESCRIPTION OF THE EMBODIMENT OR EMBODIMENTS

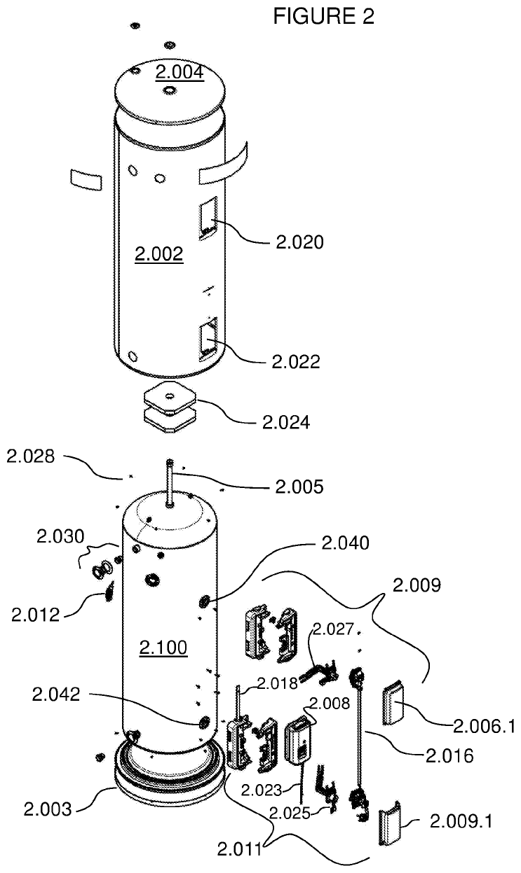

FIG. 1 illustrates a water heater according to an embodiment of the invention. The water heater includes an outer jacket 1.002 which encloses the water tank (see item 2.100 in FIG. 2), with the jacket 1.002 having a larger diameter than the tank 2.100 to provide an annular space which is filled with insulation. The insulation is inserted into the space by injection of a foam plastics.

The lower end of the jacket is closed by a base 1.003.

The jacket 1.002 is closed at the top by a lid 1.004 which also encloses an insulation space above the tank. The lid includes an aperture 1.005.1 for a sacrificial anode 1.005 which is provided to assist the tank to resist corrosion. A second aperture 1.007 is provided as the injection point for the foam insulation.

The jacket 1.002, 2.002 includes a number of apertures which provide access to the tank for water pipe inlet 1.014, water pipe outlet 1.010, relief valve 1.012, upper element switching assembly 1.006 located under cover 1.006.1, and lower element switching assembly 1.009 located under cover 1.009.1. In one embodiment, the switching assembly can include a thermal cut-out switch. In another embodiment, the switching assemblies can include both a thermal cut-out switch and a temperature controlled relay arrangement. In the embodiment of FIG. 1, the switching assemblies 1.006 and 1.009 include both thermal cut-out switches and temperature regulating relay switches. A control circuit cover 1.008 can enclose a controller having associated power modulating devices. Such devices produce a significant amount of heat. The controller is mounted on the outside of the jacket 1.002. The heat producing electronic devices in the controller can be attached to a heat sink 1.510. The heat sink 1.510 can be a flanged air-cooled heat sink with the cover 1.008 including an aperture to permit air-flow over the heat sink.

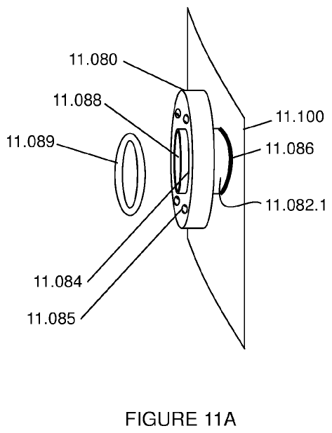

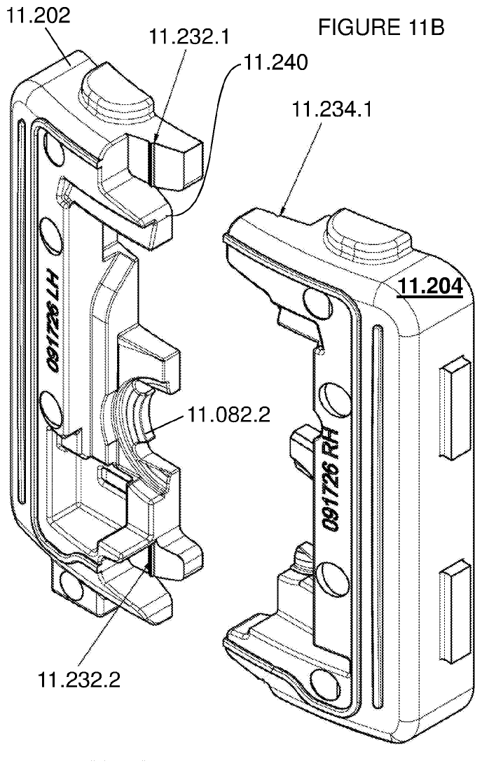

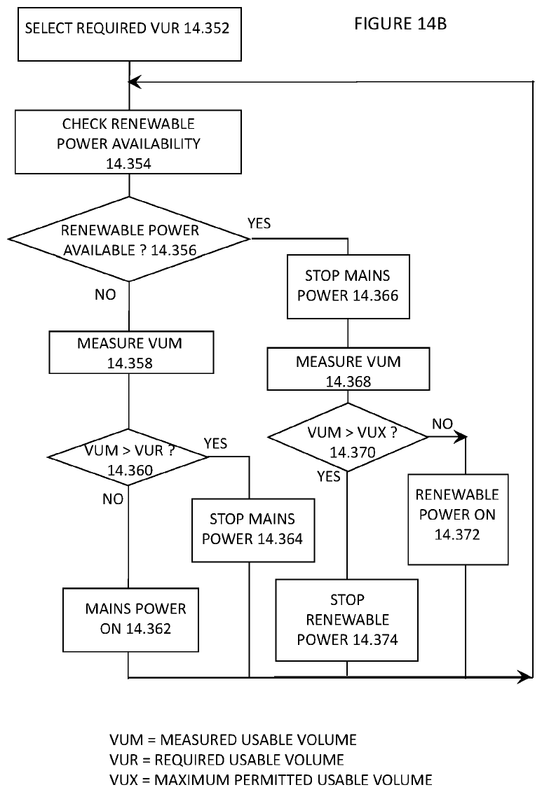

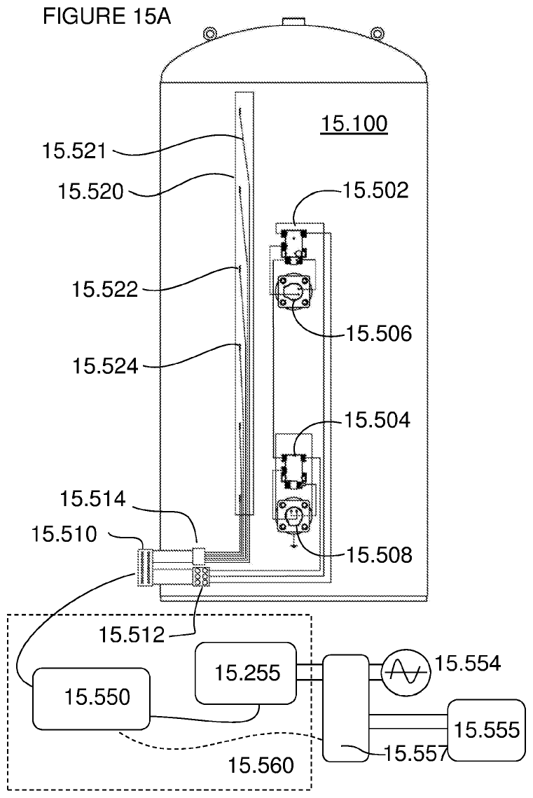

The element controllers 1.006 and 1.009 are connected to corresponding electrical heating elements which are inserted through sealed openings into the tank as discussed below with reference to FIG. 11. Mains power is delivered to the control boxes, cut-out switches, and electrical heating elements via an external connector. An external interface can include connections for power and, optionally, signalling, as discussed below with reference to FIG. 14. The controller 1.008 can include a user interface 1.013 which can include an ON/OFF switch, and can provide additional functionality enabling the user to programme the operation of the water heater, or input data or change an operating parameter of the system, in which case a display can be associated with the user interface 1.013. In one embodiment, the display can include a number of differently coloured LEDs. An external connector can include both power and signalling pins as discussed below with reference to 14.510 in FIGS. 14A and 14B. The user interface can include one or more visual indicators, such as LEDs, showing the status of the water heater.

The apertures in the jacket 1.002 and lid 1.004, other than the injection point 1.007 must be closed during injection of the foam for example by removable caps. As discussed below, foam dams are provided to prevent foam escaping via the control box apertures.

FIG. 2 illustrates an exploded view of the water heater of FIG. 1.

The lid 2.004 is attachable to the jacket 2.002 by rivets 2.028.

The jacket 2.002 includes control box apertures 2.020 and 2.022.

Spacers 2.024 are provided with central apertures to permit the sacrificial anode 2.005 to pass through to the interior of tank 2.100 via the lid 2.004. The spacers can be made from an insulating material such as foamed plastics.

Relief valve 2.012 and hot water outlet assembly 2.030 are attachable to tank 2.100.

The upper control box and upper foam dam are shown at 2.009, and the lower control box and lower foam dam are shown at 2.011. Temperature sensor 2.018 extends against the tank wall and connects with the control assembly via a breakout aperture in the dam. A breakout is a portion of the article which can be removed, for example, to permit a cable or thermosensor strip to pass through the wall of the foam dam.

Cable harness 2.016 facilitates the delivery of mains power to the upper control box for upper heating element 2.027 as well as the exchange of monitoring signals and control signals. A lower heating element 2.025 is adapted to be inserted inside the tank via a flange 2.042 having a through hole therein providing access to the interior of the tank 2.100. The element 2.025 can have a bend in it. Similarly, upper heating element 2.027 is adapted to be inserted within the tank. Each heating element can have one or more heating blades.

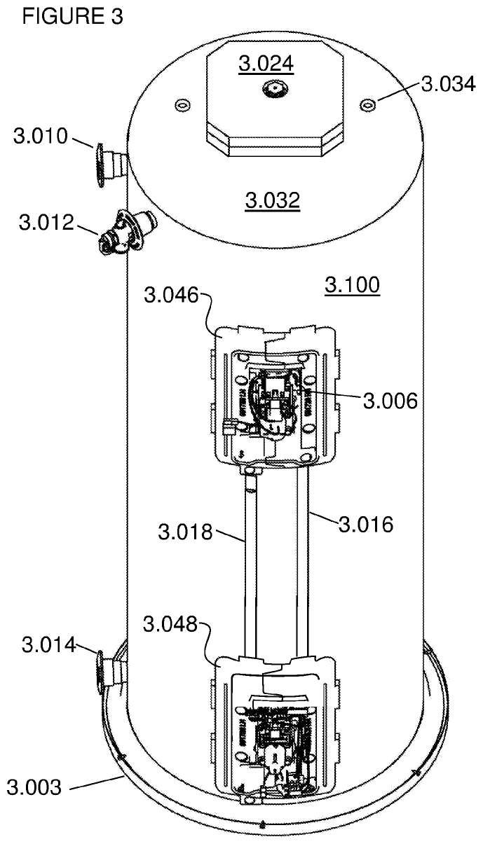

FIG. 3 illustrates a water tank of FIGS. 1 and 2 with the outer jacket 2.002 removed, and the controller 2.008 also removed as it is mounted to the outer jacket. The tank 3.100 is cylindrical and closed at the top by a plus end (convex) tank lid 3.032. The lower and of the tank can also be closed by a base such as minus end. The lid can include lifting rings 3.034 to facilitate handling of the tank during manufacturing processes such as enamelling and assembly.

Preferably, the upper and lower foam dams can be of the same design. However, the upper foam dam 3.046 and the lower foam dam 3.048 can be have different shapes or dimensions to accommodate different controller configurations.

The upper hot water outlet is shown at 3.010. It includes a flange at its distal end to close the outlet aperture in the jacket. The lower cold water inlet 3.014 also includes a closure flange. The relief valve 3.012 likewise includes a closure flange for its aperture in the jacket.

The upper control box 3.006 is connected with lower control box 3.008 by cable harness 3.016.

An external temperature sensor strip 3.018, herein referred to as a thermosensor strip, is in contact with the outside of tank 3.100, and is connected to the lower control box 3.008.

The tank is seated on a base 3.003.

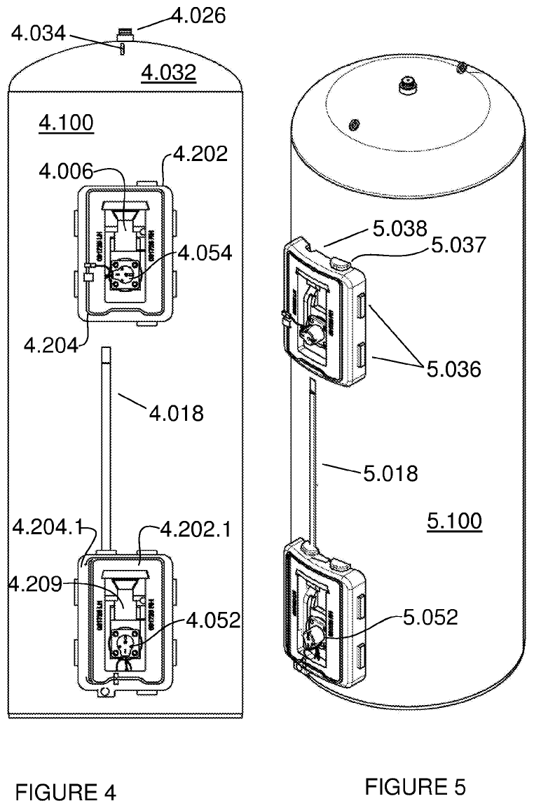

FIG. 4 and FIG. 5 illustrate a front view and an isometric view of the tank 2.100, 3.100 and sub assembly of FIGS. 2 and 3, respectively labelled water heater tank 4.100, 5.100 with lid 2.004 and jacket 2.002 and base 30.03 removed. In this embodiment, the upper element controller receives control signals via a harness (which is not present of ease of illustration) from the lower element controller.

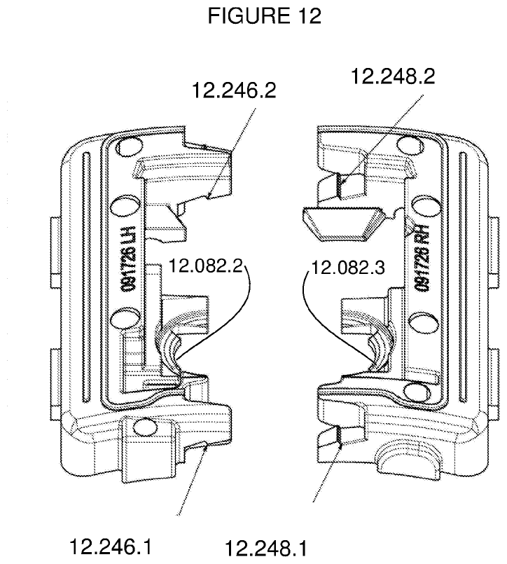

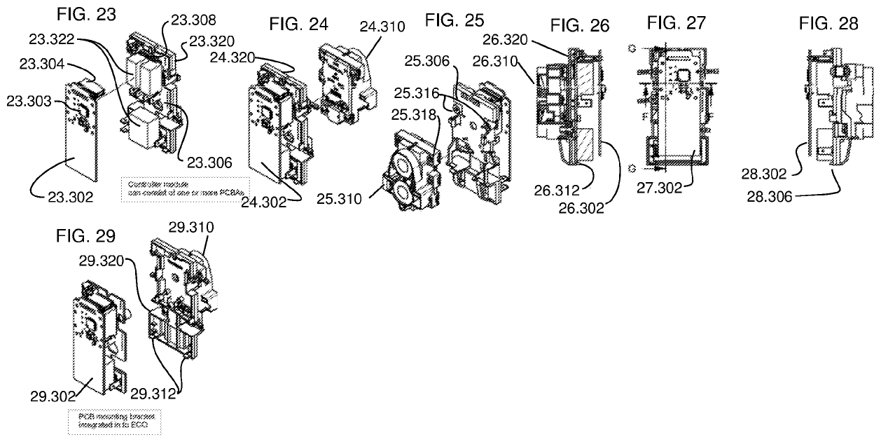

An aperture 4.210 is provided in upper foam dam to accommodate an upper control assembly. The upper foam dam consists of a right hand dam segment 4.202 and left hand dam segment 4.204. The segments of the foam dam are fitted around a tank mounted flange which stands of from the tank wall and is provided with a through hole to permit a heating element to be inserted into and affixed to the tank. An inwardly directed rim on each segment of the dam fits under the element flange to hold the dam segment against the tank wall (see, e.g., 12.082.2, 12.082.3 in FIG. 12 below). As discussed below with reference to FIG. 23, each control assembly can include a pair of PCBs, with one of the PCBs mounted on the other PCB so that the one PCB is located in close proximity to the other PCB and a first set of electrical components, and or in a separate plane from the plane of the other PCB and the first set of electrical components. A lower foam dam consisting of a right hand segment also includes a corresponding aperture 4.209 to accommodate a lower control assembly. An external controller (not shown: see 10.008 in FIG. 1), which is attached to the outside of the jacket and connected to the harness (3.016 in FIG. 3) can manage the control assemblies as discussed below.

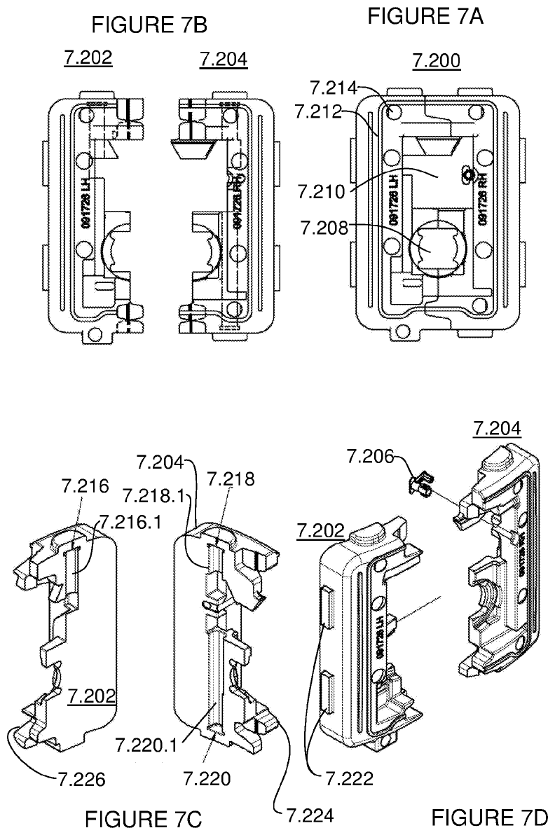

Thermosensor strip 4.018, 5.018 extends some distance up the outside wall of the tank from the lower control assembly 4.008. As will be discussed below, the thermosensor strip can include one or more temperature sensing elements. Where there are two or more sensing elements, they can be located at different heights on the tank wall. The upper control assembly can be connected to, and responsive to, an upper “local” thermistor which can be mounted on the inner side of the upper foam dam, as shown below with reference to 7.206 in FIG. 7D.

The lower element controller can likewise be provided with a “local” thermistor to measure the temperature of incoming cold water.

Terminations for the lower electrical heating element 4.052 and the upper electrical heating element 4.054 are attached to the tank wall by watertight sealing flanges. Power is delivered to the electrical heating elements via corresponding controllers enclosed in the corresponding foam dams. In addition, a thermal cut-out switch can be provided in series with relays of the element controllers. The element controllers can be mounted on the thermal cut-out switch.

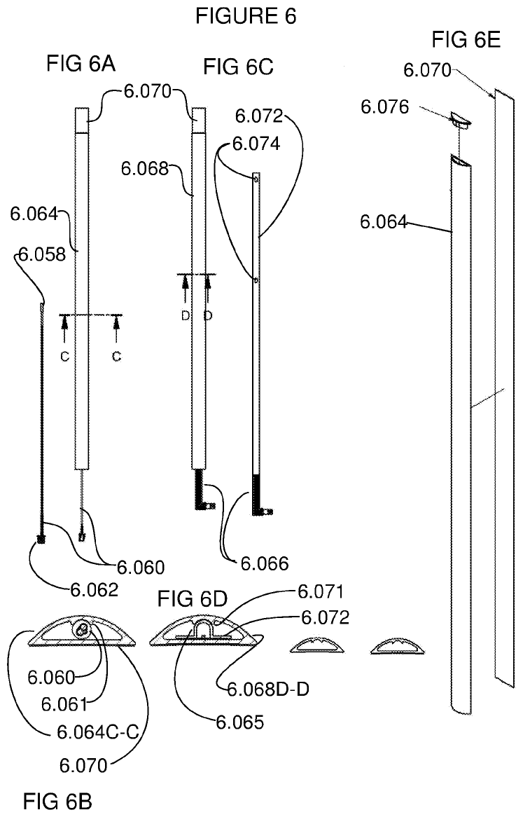

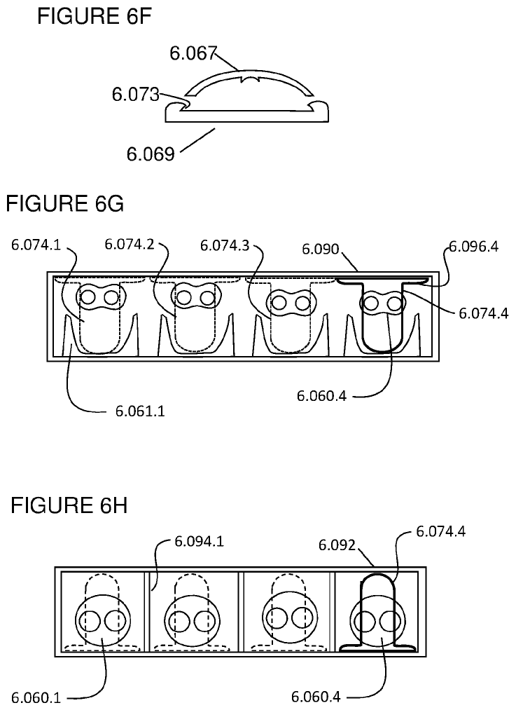

FIGS. 6A to 6H illustrate various configurations of thermosensor strips according to embodiments of the invention.

FIG. 6A shows a wired thermosensor housing 6.064 containing a first wired thermosensor arrangement 6.060. The housing can be a thermally conductive extrusion. The first thermosensor arrangement 6.060 is also shown outside the housing 6.064. The first wired thermosensor arrangement can include one or more thermosensors such as thermistors, e.g. 6.058, each connected via two wires to the controller. The first thermosensor strip has a connector 6.062 adapted to connect the thermosensor to an associated controller. The embodiment of FIG. 6A includes a single thermistor 6.058, the thermosensor strip 6.060 including a pair of wires connecting the thermosensor 6.058 to the connector 6.062.

The thermosensor strip is contained in an extrusion 6.064. The housing can be affixed to the tank by a double sided adhesive strip 6.070 or by a layer of adhesive. Preferably the adhesive and housing are thermally conductive so temperature changes in the tank are quickly registered by the thermosensor. The foaming in process ensures that the foam pressure is applied to the thermosensor strip 4.018, 5.018 forcing it into “better” contact with the tank by pushing against the inner surface of the jacket.

FIG. 6B shows a section view at C-C (FIG. 6A) of the thermosensor strip housing 6.064 and thermosensor 6.060. The hollow D-shaped profile 6.064C-C of the thermosensor housing 6.064 includes an internal channel 6.061 adapted to accommodate the thermosensor wires 6.060. The extrusion can include a channel 6.061 adapted to hold the thermosensor wires.

FIG. 6C illustrates a second thermosensor arrangement including a housing 6.068 and flexible PCB thermosensor strip 6.072 having thermosensors 6.074 mounted thereon. The thermosensor strip 6.072 can include a termination 6.066 adapted to be connected to the associated controller. Conductive tracks on the thermosensor strip enable the thermistor to be connected to a controller.

FIG. 6D shows a section view at D-D (FIG. 6C) of the thermosensor strip housing 6.068 and thermosensor strip 6.066. The hollow D-shaped profile 6.068D-D includes an internal channel adapted to accommodate the thermosensors 6.074 mounted on the PCB strip 6.072. A bracket 6.065 engages the internal channel in the housing to hold the thermistors against the base of the housing.

FIG. 6E illustrates the extrusion 6.064 and adhesive strip 6.070. A closure cap 6.076 can be provided to close the distal end of the housing extrusion 6.064. The housing can be made of a suitable thermal conductive material. In the present embodiment the housing is made of aluminium.

In the embodiment of FIG. 6F, the housing can be composed of two extrusions, a substantially flat base extrusion 6.069 and a cover extrusion 6.067, the base and cover including a complementary longitudinal snap-fit arrangement 6.073 along their longitudinal sides.

FIG. 6G illustrates a section through a multi-thermosensor strip according to an embodiment of the invention. A hollow tube extrusion 6.090 includes a plurality of open thermistor channels such as 6.061.1 having a substantially “U” shape. The channels are adapted to receive thermistor wires such as 6.060.4. Thermistors 6.074.4 can be located at different lengths along the housing. The thermistor can have a wide footing such as 6.096.4 on the side facing the wall of the water heater tank to provide a larger thermal contact surface.

FIG. 6H illustrates a section through another multi-thermosensor strip according to an embodiment of the invention similar to that of FIG. 6G. The thermosensor housing includes an extrusion 6.092. In the embodiment of FIG. 6H, the channels of FIG. 6G have been replaced by closed channels defined by internal walls such as 6.094.1. The thermosensors, such as 6.074.4 can be connected to two-wire cable such as 6.060.4.

FIGS. 7A to 7D show various views of a 2-piece foam dam 7.200 adapted to shield control elements on the tank during the foam injection process. As shown in FIG. 7B, the foam dam includes a first half 7.202 and a mating second half 7.204. The assembled dam is designed to define a first aperture 7.208 which is designed to engage under a stand-off flange on the tank wall and which surrounds a through hole enabling insertion of a heating element. Upper aperture 7.210 is designed to accommodate a thermal cut-out switch on which a control assembly is mounted. The control assembly can include power relays which are connected in series with the thermal cut-out switch and connected to an electrical heating element within the tank, and whose electrical connections pass through the flange sealed to the wall of the tank.

FIG. 7C illustrates the tank-facing sides (the inner surface) of the dam elements 7.202 and 7.204. The inner surface of the dam segments is curved to match the cylindrical tank wall. Breakouts 7.216, 7.218, 7.220 provide access to corresponding channels and recesses 7.216.1, 7.218.1, 7.220.1. These channels and recesses are adapted to accommodate components such as cables and connectors 2.016, 2.023, and thermosensor strip 2.018 shown in FIG. 2.

FIG. 7D is an exploded view of a foam dam according to an embodiment of the invention showing the two halves 7.202, 7.204 of the dam. A thermistor carrier 7.206 can be provided to hold a temperature sensor adjacent to the tank wall and to provide a connection to a controller.

The two halves of the foam dam can be moulded in a single die having the two halves in a back-to-back arrangement and joined by intercommunicating channels. Peripheral projections 7.222 are residual foam formations formed by the intercommunicating channels from the moulding process to form the foam dam.

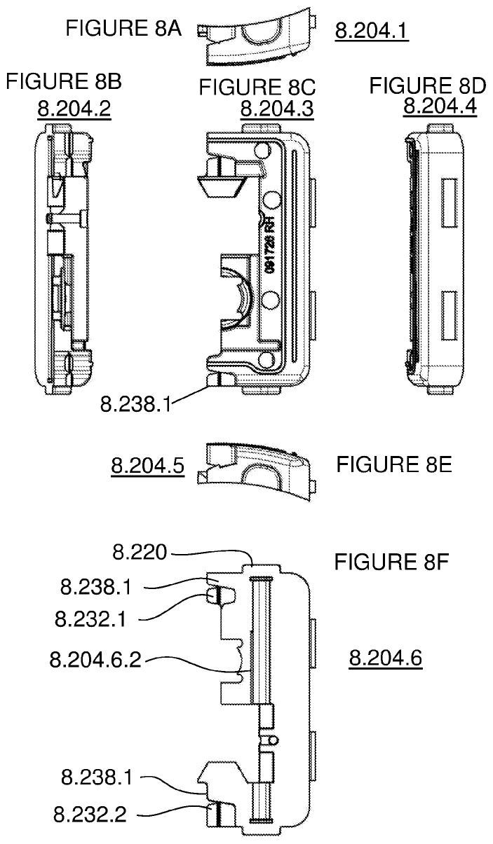

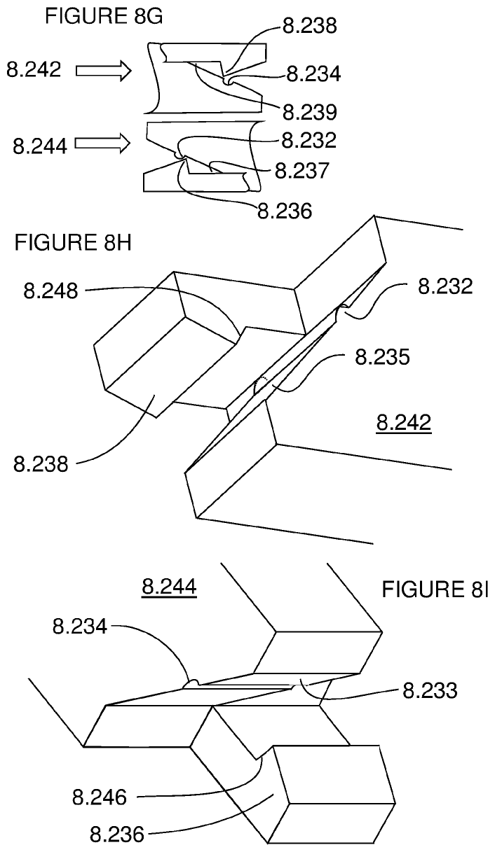

The two halves of the dam 7.202, 7.204 can be held together by one or more types of latching arrangements. A latching arrangement according to an embodiment of the invention is described in detail below with reference to FIGS. 8G & 8H.

Once the thermosensor strip, thermal cut-out, element control assemblies and other tank mounted items are installed, the foam dam can be fitted around the tank-mounted items, the breakouts having been opened to permit passage of the connecting cable and thermosensor strip. The dam is located in a position around the heating element flange with the opening 7.208 located around the flange. The outer jacket 1.002 is located over the dam 7.200, the outer surface of the dam being curved to match the cylindrical curve of the jacket, and the inner surface of the dam being curved to match the tank wall so that the dam is firmly held between the jacket and the tank. When the foam insulation is injected to fill the space between the jacket and the tank, the dam excludes the injected insulating foam from the apertures 7.208, 7.210.

FIG. 8A to 8F show orthogonal views of a right hand section of a foam dam according to an embodiment of the invention.

FIG. 8A is a top view 8.204.1, illustrating the curves surfaces of the foam dam.

FIG. 8B illustrates a left side view 8.204.2.

FIG. 8C illustrates a front view 8.204.3. An element of a latching arrangement 8.236 can be seen at the lower end of FIG. 8C.

FIG. 8D illustrates a right side view 8.204.4.

FIG. 8E illustrates an underside view 8.204.5 again illustrating the curved surfaces of the dam adapted to conform to the tank wall and the jacket wall.

FIG. 8F is an inverted rear view 8.204.6 of a right hand section of a foam dam of FIG. 8C. Latching elements 8.238.1 and 8.238.2 are triangular profiled projections adapted to engage with complementary triangular profiled latching elements on the left hand section of the foam dam as described below. Latching ridges 8.232.1, 8.232.2 are adapted to engage with latching ridges on a left hand section of the foam dam as described below.

FIG. 8G is a schematic illustration showing detail of a double latching arrangement. The upper latching element arrangement 8.242 can be part of the left hand foam dam segment, while the lower latching element arrangement 8.244 can be part of the right hand section of the foam dam. However, it is clear that these latching arrangements are interchangeable between the dam sections. The latching arrangements are engaged when the two halves of the foam dam are assembled together.

The triangular profiled latching elements 8.236, 8.238 engage so faces 8.248 and 8.246 are interlocked. The latched triangular profiles resist tangential separation of the dam sections.

The inclined surfaces 8.233, 8.235 of the latching arrangement on their own would not provide useful engagement forces. However, the ridge 8.232 and the groove 8.234 are in register when the sections of the dam are assembled to resist radial separation, radial being referred to the tank circumference. The tank wall and the jacket wall also resist radial separation.

A first latching arrangement includes a pair of complementary triangular latching profiles. FIG. 7D is an exploded view of the dam 7.200. The left hand portion of the dam 7.202 includes an upwardly facing triangular profile latching element 7.236 adapted to engage a corresponding downwardly triangular latching element located at 7.238. When the dam halves are assembled, the upwardly and downwardly facing triangular latching elements engage to hold the two halves together against separating forces. The firm pressure exerted on the halves of the dam by the jacket and tank wall holds the dam halves together.

A second latching arrangement according to an embodiment of the inventions is provided by a groove and ridge arrangement. Mating inclined (referred to the tangent plane of the cylindrical surfaces of the dam sections (the datum tangent)) surfaces 8.233 (FIG. 8H), 8.235 (FIG. 8I) include a latching groove 8.234 and a latching ridge 8.232 respectively. The inclined planes can be inclined at an angle of less than 45° above (8.237 in FIG. 8G) or below the datum tangent as shown at 8.239 in FIG. 8G to provide engagement between the ridge and groove which resists separation transverse to the ridge and groove. For example, the included angles 8.237, 8.239 can be approximately 30°.

A double latching arrangement can be provided by having a complementary pair of triangle latching elements 8.236, 8.238 as described above, and a pair of inclined surfaces 8.233, 8.235 carrying a latching groove 8.234 and ridge 8.232.

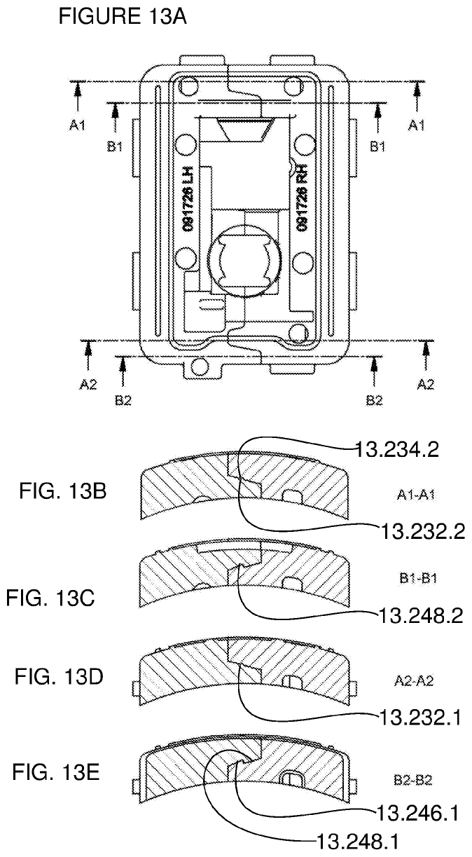

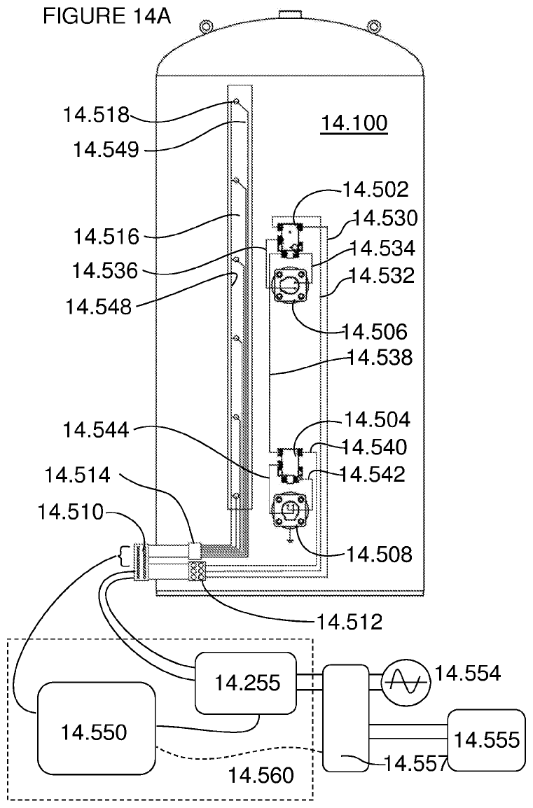

FIG. 8G schematically illustrates a side view of a double latching arrangement. FIGS. 8H & 8I schematically illustrate a perspective view of a double latching arrangement. A triangular-profiled upwardly facing triangular latching element 8.236, and a downwardly facing latching groove 8.234 located on inclined surface 8.233. Complementary triangular profiled latching element 8.238 on the other section of the foam dam is designed to engage triangular engagement element 8.236 when the foam dam is assembled so that the surfaces 8.246 and 8.248 are engaged to resist separating forces. The faces 8.246, 8.248 engage when the dam is assembled as shown, for example in FIG. 13D.

The included angles 8.237, 8.239 of the inclined surface can be less than 45°. The included angles can be of the order of 20°.

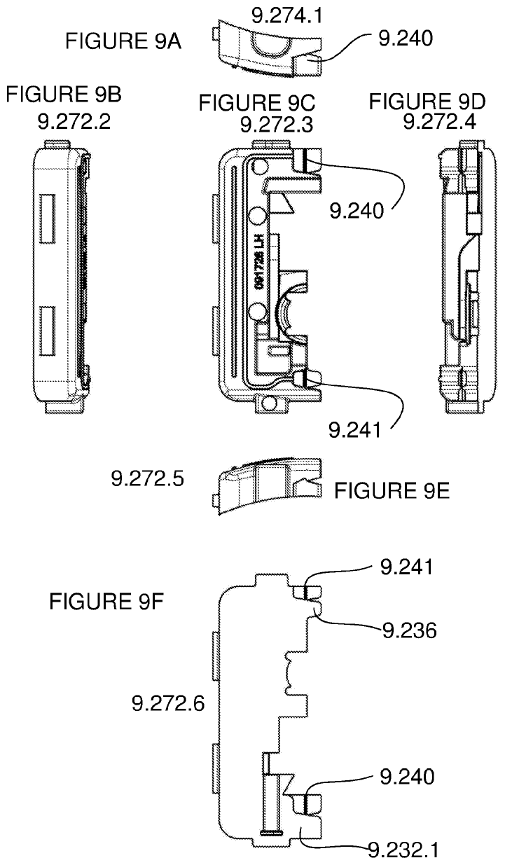

FIGS. 9A to 9F illustrate views of a left hand side or complementary dam section to interface with the dam section of FIG. 7. FIG. 9A illustrates a top view 9.274.1 of the complementary dam section. FIG. 9B shows a left side view 9.272.2 of the complementary dam section. FIG. 9C shows a front view 9.272.3 of the complementary dam section. FIG. 9D shows a right side view 9.272.4 of the complementary dam section. FIG. 9E shows a bottom view 9.272.5 of the complementary dam section. FIG. 9F shows an inverted rear view 9.272.6 of the complementary dam section. The double latching arrangements are seen at the top and bottom of FIG. 9F with the lower latching profile 9.236 (rear view) and the latching profile 9236 being adapted to engage with latching profile 8.236.

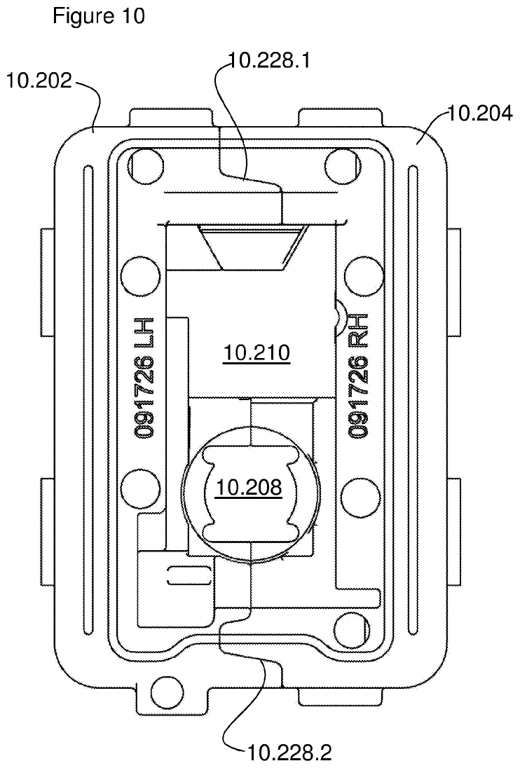

FIG. 10 illustrates a foam dam assembled from the foam dam sections of FIGS. 7 and 9. A junction line 10.228.1, 10.228.2 indicates the join between the two sections of the foam dam. Lower aperture 10.208 is provided to accommodate the element mounting flange on the tank, while upper aperture 10.203 can accommodate a heating element controller mounted on an electric cut-out switch.

FIG. 11A illustrates a flange attachment on a tank 11.100 to facilitate the attachment of a heating element to a tank. A flange 11.080 has a stand-off stub tube 11.082.1 welded around an element insertion aperture in the wall of tank 11.100. The flange 11.080 can include threaded holes such as 11.085 to enable a mating flange on the heating element to be sealingly attached to the tank flange 11.080. A seat 11.084 for an O-ring seal 11.089 ensures a water tight seal when the element flange is attached to the tank flange. Instead of the raised ring 11.084, the O-ring 11.089 can be retained on the element flange in a groove before the two flanges are attached. A through-hole 11.088 allows the heating element to be inserted into the tank. The element includes an element flange (not shown in detail) which can include matching holes to align with the threaded holes 11.085 of the tank flange 11.080 to allow bolts to be screwed into the threaded holes 11.085 to compress the O-ring seal between the flanges and hold the element in place within the tank.

As shown in FIG. 11B, the dam is made in two compatible sections. This allows the dam to be assembled around the controller and electrical cut-out switch after the controller and electrical cut-out switch have been installed on the tank, and before the jacket is applied. Once the jacket is applied, the foam insulation can be injected into the space between the tank and the jacket. The dam prevents the injected foam insulation from contacting the controller and electrical cut-out switch. As can be seen in FIG. 11B, the foam dam segment 11.202 includes a rim 11.082.2 around aperture 10.208 (FIG. 10). A corresponding rim (not shown) is also provided on dam segment 11.204. The dam segments of the dam are assembled around the standoff tube 11.082.1 with the rim 11.082.2 fitting snugly under the flange 11.080 (interference fit) and around the stub 11.082.1. The engagement elements (see, e.g., FIG. 8) can be engaged. Thus the flange 11.080 holds the assembled dam against the tank while the engagement elements hold the segments of the dam against tangential separation.

FIG. 12 is an exploded isometric illustration of a foam dam according to an embodiment of the invention. The triangular profiled latching elements are shown at 12.248.1 and 12.248.2 on the right hand section of the dam and the mating triangular profiled latching elements 12.246.1 and 12.246.2 are shown on the left hand section of the dam.

FIG. 13 illustrates an assembled foam dam according to an embodiment of the invention, and FIGS. 13B to 13E illustrate sections along A1-A1, B1-B1, A2-A2, and B2-B2.

FIG. 13B shows a section through the inclined faces with downward facing groove 13.234.2 and upward facing ridge 13.232.2 engaged.

FIG. 13C shows the triangular profiles 13.246.2 and 13.248.2 engaged.

FIG. 13D shows the inclined faces with groove 13.234.1 and ridge 13.232.1 engaged.

FIG. 13E shows the triangular profiled latching elements 13.246.1 and 13.248.1 engaged.

FIG. 14A illustrates a water heater tank of another embodiment of the invention. In this embodiment, the control functionality for the heater elements, other than the thermal cut-out switch) is external to the water heater and is connected via connector 14.510 to a power connector 14512 and a temperature signal connector 14.514. This arrangement provides versatility as to the type of controller which can be connected to the water heater.

The thermosensor strip 14.516 extends over the major part of the exterior of the tank 14.100.

Australian patent no. 2005306582 (WO2006/053386), the contents of which are incorporated herein by reference, discloses a thermosensor strip 14.516 supporting a number of individual thermistors, such as 14.518, which can be applied to the external wall of a water heater tank to obtain a measure of the tank water at a number of vertically separated points. Having several temperatures sensors increases the accuracy of a system adapted to calculate the volume of usable hot water.

The water heater tank of FIG. 14A is a 2-element water tank 14.100. Before the jacket and insulation are applied to the tank, a number of items are mounted on the tank, including upper and lower thermal cut-out switches 14.502, 14.504, upper and lower heating element flanges 14.506, 14.508, with associated heating elements inside the tank and multi-element thermosensor strip 14.516 with one or more individual temperature sensors 14.518, which can be, for example, individual thermistors. The thermosensor strip extends over a substantial portion of the height of the tank. Thermistors can have positive or negative temperature coefficients, the resistance increasing or decreasing respectively with increasing temperature.

Each thermistor, such as 14.518, has an individual wire connection such as 14.549 and a common wire connection 14.548. The common wire and the individual wires are connected to a thermosensor strip multi-wire connector 14.514. The multi-wire connector 14.514 and a mains connector 14.512 connect to a combined connector 14.510. The power switches 14.502, 14.504 are connected to the mains supply via connector 14.512. The thermosensor strip 14.516 is connected to the multi-wire connector 14514. The combined connector connects with both the mains connector 14.512 and thermosensor connector 14.514 so the devices can be connected using a single connector.

Power to the elements is delivered via the thermoswitches 14.502, 14.504 which can autonomously interrupt current to the elements if the temperature of the tank wall adjacent to the thermoswitch exceeds a predetermined value. Thermoswitches can also be referred to as electrical cut-out switches or thermal cut-out switches.

An external control processor 14.550 can receive temperature information from the thermosensor strip and can send control information to a power modulator 14.255 in response thereto. The power modulator receives power from either a power supply 14.554 or a renewable power supply 14.555 such as solar or wind power. A power source selector 14.557 can be programmed to select either the mains power or the renewable power based on the availability of the renewable power and the temperature or heat content of the water heater. In one alternative, the power selector can be controlled by the control processor 14.550. The power can be chosen such that renewable power is delivered when available in preference to mains power.

In another alternative, the renewable power source output can be connected directly to the mains power input. When renewable power is available, it will be preferentially utilized to supply local loads because the mains power supply is delivered over a higher impedance due to the network impedance.

The resistance of each thermistor can be measured by resistance measuring circuit. A single resistance measuring circuit can be connected to each thermistor's individual wire (14.549) in turn (polling) while the resistance of each thermistor is measured and stored individually. The resistance measurement for each thermistor can be performed by applying a known current or voltage to the thermistor for a short time so a snapshot of the status of the temperature of the water in the tank can be obtained. The polling of the thermistors can be carried out continually or at predetermined or controllable intervals of time.

Because the thermosensor strip sensor 14.516 extends over a substantial portion of the height of the tank, the individual thermistor values can provide an indication of the thermal content of the tank which can be calculated by the processor/controller 14.550.

The arrangement of FIG. 14A can be used to control the operation of the water heater. FIG. 14B illustrates an embodiment of a method according to the invention, in which a measure of “usable” hot water can be determined by measuring the temperature of the incoming cold water and by calculating the volume of water in the tank above a predetermined temperature, for example, between 35° C. and 40° C. Optionally, the user may choose a higher temperature. Usable hot water can be used to determine the time during which the water heater can deliver hot water above the predetermined temperature at a given flow rate.

In an embodiment of the invention, using a system including a processor such as that illustrated at 14.550 in the arrangement of FIG. 14A, the system can monitor the usable volume of hot water and determine whether to turn on the heating elements of the water heater using renewable or mains power. In co-pending application AU2016250449, the contents of which are incorporated herein by reference, describes a system adapted to selectively utilize renewable power or mains power. The system can enable a greater volume of usable hot water (VUX) to be stored using renewable power than when using mains power (VUR). This enables a user to utilize renewable power in preference to mains power. In FIG. 14B, a selection of the required usable volume of hot water (VUR) is made at step 14.352. The system then checks the availability of renewable power at steps 14.354 and 14.356. If no renewable power is available, a calculation of the available usable hot water (VUM) from the temperature sensor readings at step 14.358. VUM is checked against VUR at step 14.360, and if VUM is less than VUR, mains power is switched on for the water heater elements at step 14.362. If VUM exceeds VUR, the mains power to the water heater is switched off at step 14.364.

Where renewable power is determined to be available at step 14.356, the mains power to the water heater is switched off at step 14.366. As described in co-pending application AU2016250449, the renewable power can autonomously replace mains power when the renewable power is available. The system then checks whether the measured volume of hot water VUM is greater than a pre-set maximum VUX at steps 14.338 and 14.370. VUX can be greater than VUR so additional renewable power can be stored as hot water. If VUM is less than VUX, renewable power is applied to the heater elements at step 14.372 and the system continues to monitor the availability of renewable power and to monitor VUM in relation to VUX via loop 14.354, 14.356, 14.368, 14.370, 14.370. If VUM exceeds VUX, the renewable power is disconnected from the heating elements at step 14.374. The system then continues to monitor availability of renewable power and determines whether there is a need to apply mains or renewable power to obtain the required volume of usable hot water.

The formula:

Vu=V(1+(Th−Tu)/(Tu−TC), where
Vu=volume of usable hot water,
V=volume of water at temperature Th,
Tu=temperature of usable water, and
Tc=temperature of cold water,
can be used to determine an indication of the volume of useable hot water.

This can then be used to calculate the number of showers or other uses. This enables the user to programme the water heater to limit the amount of mains power delivered to the water heater when renewable power is not available by selecting a minimum volume of usable water.

By dividing the tank into volumes between each sensor and using the temperature at the bottom of each volume a total volume of usable hot water can be calculated.

This provides a conservative estimate as all water between two sensors is assumed to be at the temperature of the lower sensor. Other options such as using an average temp for each volume may overestimate useable volume, especially where the temperature sensors are widely spaced.

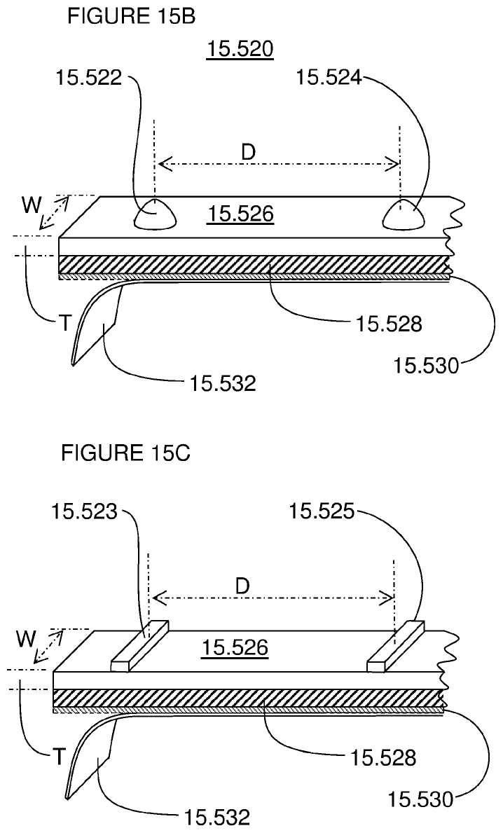

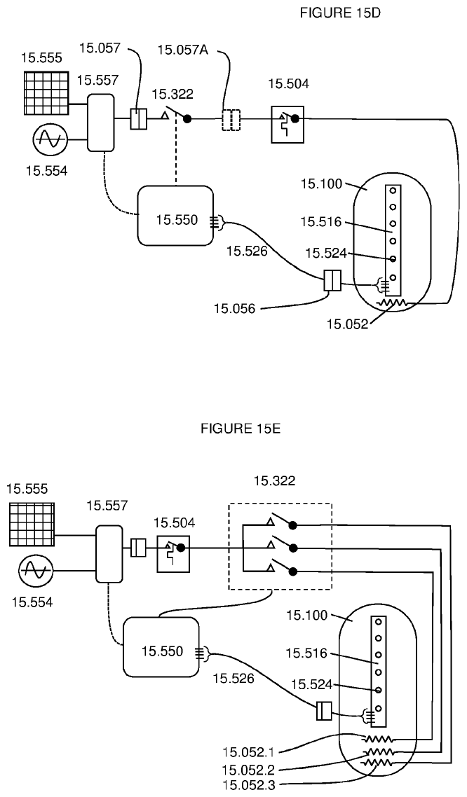

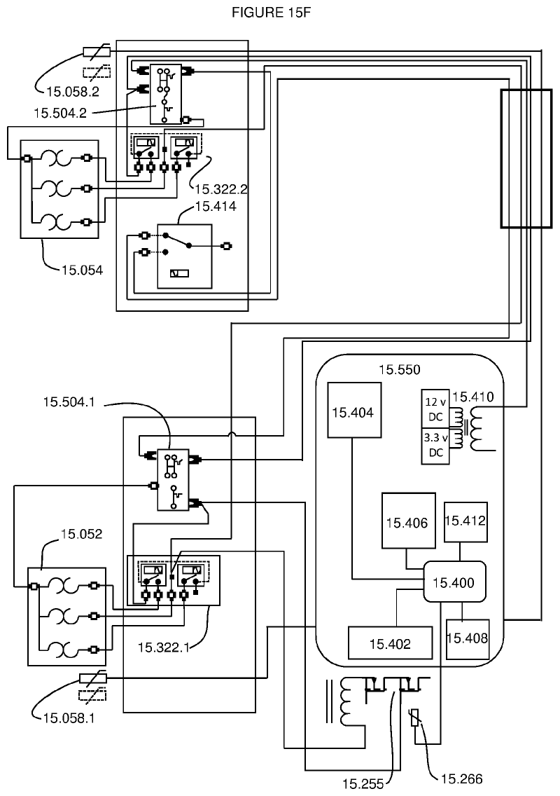

FIG. 15A shows a tank arrangement similar to that of FIG. 14A, the difference being that the thermosensor strip 14.516 with individual thermistors is replaced by a continuous thermosensor strip 15.520. In this arrangement, there is no common wire and resistance can be measured between adjacent contacts such as 15.522, 15.524.

FIG. 15AA illustrates a method of installing a water heater according to an embodiment of the invention. In step 15.150, a tank configured with the temperature sensor 15.520 and heating element or elements 15.508, 15.506 connected to an externally accessible connection means 15.510, with or without temperature control switches is installed at a customer's premises. In a second step 15.152, a variable power supply 15.558 and power controller 15.550 are connected to the externally accessible connection means 18.510. In the case where the temperature control switches are not installed on the tank, they can be installed upstream of the connection means 15.510.

FIG. 15B illustrates a segment of an embodiment of the continuous thermosensor strip (CTS) according to an embodiment of the invention. The CTS 15.520 can include a layer of thermistor material 15.526 on a suitable substrate 15.528. Optionally, the opposite side of the substrate can include an adhesive layer 15.530 which can be protected prior to use by a peel-off removable protective adhesive-release layer 15.532 which adheres to the adhesive lightly. A protective insulating layer (not shown) can be applied over the thermistor material layer. The substrate can be rigid or flexible. The substrate can be a flexible printed circuit board (PCB). The flexible PCB can include an intermediate layer compatible with the thermistor material to facilitate deposition of the thermistor material. A number of electrical contacts, such as 15.522, 15.524 are in contact with the thermistor layer 15.526. While the contacts are shown as domed shapes, they can have other shapes. For example, the contacts may extend across the width W of the thermosensor strip. The resistance between a pair of such contacts is determined by the spacing of the contacts, D, the width of the thermistor layer, W, the thickness of the thermistor layer, T, the thermal coefficient of resistance of the thermistor layer, CT, the reference value of the resistance of the thermistor material at a given reference temperature, and the temperature of the thermistor layer.

The resistance between adjacent contacts can be polled individually in a manner analogous to that of the embodiment of FIG. 14A.

A thermosensor strip 15.520 can be attached to the tank wall using a suitable adhesive. The adhesive can be heat conductive. The continuous thermosensor strip has two or more electrical connection points 15.522, 15.524. The resistance between any two adjacent connection points corresponding to the average temperature between the two connection points. Processor 15.550 can calculate a temperature profile for the water in the tank and use this to calculate appropriate control commands for the heating elements.

FIG. 15C shows an alternative arrangement to that of FIG. 15B, in which the contacts 15.523, 15.525, extend substantially the width of the thermistor layer.

FIG. 15D shows a schematic arrangement of functional elements of a single element, single blade water heater control arrangement according to an embodiment of the invention. The tank 15.100 includes a single element, single blade heating element 15.052, and an external thermosensor strip, such as continuous thyristor strip 15.516 extending over substantially the length of the tank and including a number of contact points 15.524. These measuring points from the thermosensor strip are connected to processor 15.550 via cable 15.526. The processor 15.550 can be programmed to control relay 15.322 to switch heating element 15.502 on or off depending on one or more predetermined conditions, such as the volume of usable hot water. Mains (15.554) or renewable (15.555) power can be delivered to heating element 15.052 selectively via series connection of relay 15.322 and thermal cut-out switch 15.504. A thermosensor strip with a number of discrete thyristors measures temperature at individual points. A continuous thyristor thermosensor provides a measure of the average temperature between contact points. The individual connections 15.524 on the thermosensor strip15.516 are connected by conductors (not show) to an externally accessible connection means 15.056. The connection means 15.056 connects these outputs to an external controller 15.550 which can calculate, for example, the thermal content of the water heater, and control the delivery of power to the element via switch 15.322. A power connector arrangement including externally accessible connection means 15.057 enables the power to be connected to the water heater via thermal cut-out switch 15.504 and temperature control switch 15.322. As indicated at the start of this description, the term “externally accessible” as used herein, in the description and the claims, includes the case of a removable cover over the power connections, as well as connection means accessible from the outside of the water heater jacket or other cover on the water heater. It will also be understood that power connections to water heaters are required to be hard wired so that the power connection will remain under an electrical safety cover and conduit will be required to carry otherwise exposed external wiring. An exposed connector can be used for any extra low voltage and or signal wires.

Electric water heaters are usually required to have a thermal cut-out switch such as 15.504 FIG. 15D. The arrangement of FIG. 15D enables power (15.554, 15.555, 15.557) and external controller 15.550 to be connected to a water tank provisioned with one or more electrical heating elements 15.052 via connector means without the need for the power to be hard wired to the thermal cut-out switch 15.504 and temperature control switch 15.322. Thus the monitor/signalling connection means 15.056, and the power connection means 15.057 enable power and control functionality to be connected to the tank. This provides the user with the ability to choose power and control from suppliers other than the tank supplier.

While FIG. 15D shows separate power and control connectors, an integrated power and control connector means as shown at 14.510 in FIG. 14A can be used to further simplify installation. The connector means can be of a plug and socket construction, or of a terminal block construction, or other suitable connection arrangement.

In an alternative arrangement, the power connector can be placed on the downstream side of the temperature control switch 15.322 as shown in dotted outline at 15.057A. This embodiment provides the additional flexibility of enabling the temperature control switch 15.322 to be supplied either in combination with the controller 15.550 or to be obtained from a different source.

FIG. 15E illustrates a water heater with a multi-blade heating element 15.052.1, 15.025.2, 15.02.3. Each blade can be controlled independently by controller 15.550 via corresponding ones of the multi-switch relay 15.322. A single thermal cut-out switch 15.504 can be located upstream of the relay so it is able to isolate all three heating element blades. The heating element blades may each be of the same resistance and or power rating, or as is preferred and as is described in PCT/AU2017/051081, they can be of differing resistance and or power rating such as a three bladed element with two blades at each of 900 W and a third blade at 1800 W.

FIG. 15F is a block diagram illustrating functional elements of a water heater control system 15.550. A microcontroller 15.400 includes a control input functionality 15.402 which can be used to set various water heater operating conditions such as water temperature, legionella control, top or bottom heating element selection. A communications controller 15.406 can be used to provide communication with the controller 15.550. Functionality can be provided by software, firmware or hardware, or manual inputs, or a combination of two or more of the forging.

A display 15.404 can include any suitable display devices such as LEDs, LCD and the like to indicate the status of the water heater. Temperature measurements can be delivered to the controller by one or more temperature sensors such as one or more lower temperature sensors 15.058.1, and one or more upper temperature sensors 15.058.2. The lower temperature sensors can be used to measure operating water temperature and can also be used to provide an input for a legionella control cycle. As discussed in relation to FIG. 14A, a continuous temperature sensor strip 14516 can provide a temperature profile of the water in the tank.

Thermal cut-out switches 15.504, 15.504.2 guard against overheating.

Upper and lower multi-blade heating elements 15.054, 15.052 are controlled by the controller 15.550 via temperature control switches 15.322.2, 15.322.1 The controller will normally be programmed to operate the upper heating element 15.054 before lower heating element 15.052 to speed up the availability of heated water. A top or bottom element selector switch 15.414 is controlled by controller 15550 using heating element selection routine 15.412 to select the appropriate heating element.

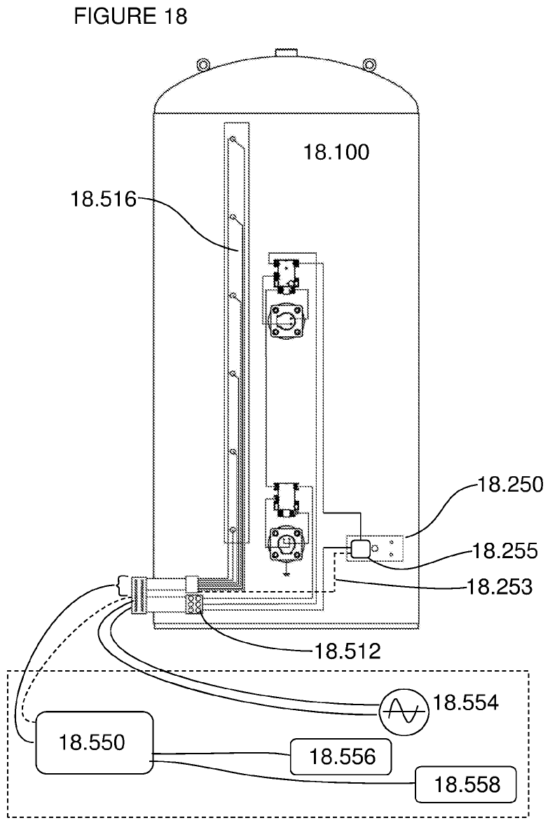

When operating on renewable power, the power delivered to the heating elements can be modulated via power control device 15.255 which can be, for example, a thyristor or the like. A current sensor 15.408 can monitor current to the heating elements. The power device 15.255 can be air cooled with large cooling fins, fan cooled using smaller fins or mounted on a heat sink as discussed below with reference to, for example, FIG. 18. The temperature of the cower control device can be monitored by temperature sensor 15.266 to enable the microcontroller 15.400 to ensure the operating temperature of the power control device is not exceeded.

DC power is derived via transformer and converter arrangement 15.410. This can provide, for example, a 12 v DC output and a 3.3 v DC output.

The controller 15.550 can be mounted on the outer PCB 23.302 of FIG. 23.

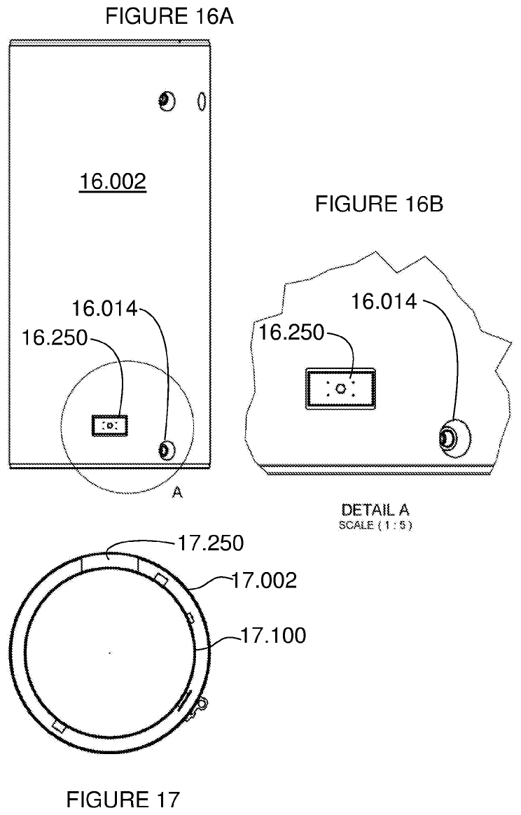

FIGS. 16A and 16B illustrate features of a water heater according to an embodiment of the invention. In some applications, such as with solar electric power, it can be advantageous to the user to have a system which modulates the power delivered to the water heater element(s). Solar electric systems can include inverters to ensure they have an output voltage and frequency compatible with the AC mains voltage. Because considerable power needs to be dissipated when modulating the solar power supply, it is necessary to ensure that the power control element does not exceed its maximum rated temperature. Some form of heat sink is necessary to dissipate the “waste” energy. Heat sinks are usually bulky and have fins to provide a greater energy dissipating surface. We have found that a heat sink can be attached to the lower section of the tank because the temperature of the water at the lower portion of the tank below the heating elements is substantially cooler than the temperature of the water above the heating element. The temperature in the lower portion of the tank can be below 40° C. Water is a more efficient cooling medium than air, and this enables the use of a smaller thyristor and a more compact heat sink. This arrangement is illustrated in FIGS. 16A, 16B, 17, 18, 19, 20, 21A & 21B.

As shown in FIGS. 16A & 16B, provision is made in the jacket 16.002 for the mounting of a heat sink 16.250 near the bottom of the water heater. In this embodiment, the heat sink is mounted near the cold water inlet 16.014.

FIG. 17 is an underside view of a water heater according to an embodiment of the invention, in which the tank 17.100, jacket 17.002 and heat sink aperture 17.020 are shown.

FIG. 18 shows a heat sink 18.250 mounted on a water heater tank 18.100 being the same as tank 14.100 of FIG. 14. The heat sink can be used to disperse heat from power losses used in modulating the power delivered to the heating elements. A power modulation device 18.255, such as a power transistor, thyristor or MOSFET can be physically and thermally in contact with the heat sink 18.250. The power modulator can be controlled by controller 18.550 via dashed line 18.253. Power can be delivered to the water heater from either the mains power 18.551 or renewable (e.g., solar or wind) power source 18.555.

The external controller 18.550 can be associated with a user interface device 18.556 such as a touch-screen, push-button and LED array, or keypad to enable the user to programme the operation of the water heater.

In addition, the controller can be associated with a communication interface 18.558, such as a modem, Wi-Fi link or the like, to enable the controller 18.550 to be programmed remotely via a communication network such as the world wide web or internet.

The controller 18.550 can be incorporated in a home or commercial site automation system. The user interface 18.556 and communications interface 18.558 can be integrated with the processor 18.550. A meter 18.553 can record the delivery of power from the mains 18.554 and to the mains from renewable power source 18.555.Additionally, the meter can record the delivery of power from the renewable power source to domestic applications such as to the water heater.

FIG. 18A illustrates a method of installing a water heater according to an embodiment of the invention. In step 18.150, a tank configured with the temperature sensor 18.520 and heating element or elements 18.508, 18.506 connected to an externally accessible connection means 18.510, a heat sink 18.250 and power control device 18.255 with or without additional temperature control switches is installed at a customer's premises. In a second step 18.152, a variable power supply 18.558 and power controller 18.550 are connected to the externally accessible connection means 18.510.

In alternative embodiment, the power control device 18.255 can be incorporated in the external circuitry upstream of the connection means 18.510 as described above with reference to FIG. 15AA.

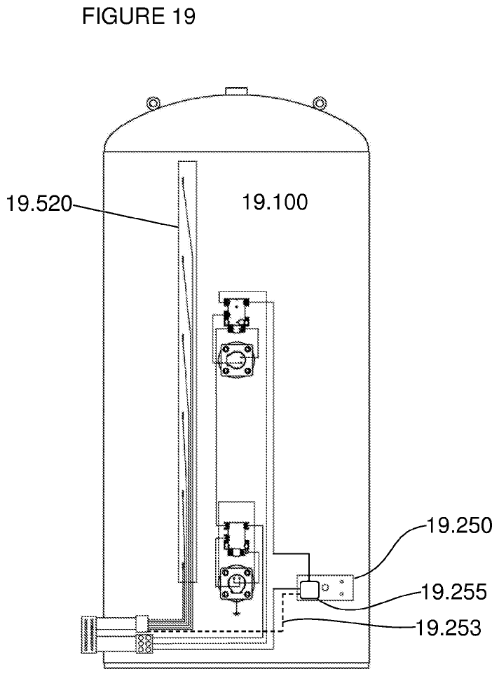

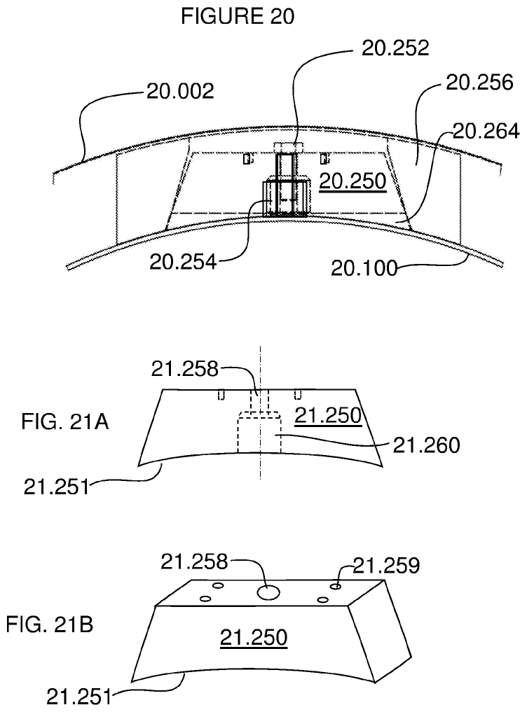

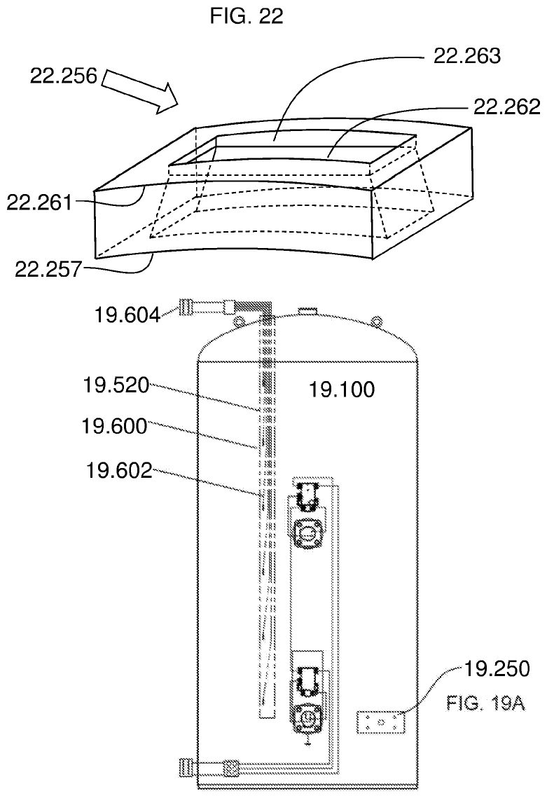

The arrangement of FIG. 19 is similar to that of FIG. 18, using the tank 15.100 of FIG. 15A, the thermosensor strip of FIG. 18 being replaced by the continuous thermistor strip 19.520 as described above with reference to FIG. 15.

Illustrated in FIG. 19A is an embodiment of a water heater, where the thermosensor signal connector 19.604 is separate from the power connector at the base of the tank. This embodiment includes a blind tube 19.600, shown in broken line-work as it is inside the tank, enters the tank 19.100 from the plus end at the top of the tank. It will pass through a fitting similar to that illustrated in FIG. 11A, so that the blind tube can be sealed with respect to the tank to prevent egress of water under pressure, by an O-ring or such like. Installed in the tube 19.600 is an array of six temperature sensors 19.602 on a continuous strip 19.520, so that temperature, in this case the average temperature in 5 bands, in the tank 19.100 can be measured. If individual temperature sensors were utilised, the temperature at six different heights would be measured. For ease of illustration the items 19.253 and 19.255 are not shown. If desired one of the temperature sensor housing assemblies, as described herein with reference to FIGS. 6A to 6H, can be utilised with the blind tube 19.600, to position temperature sensors at appropriate heights within the tank 19.100.

FIG. 20 illustrates in hidden detail view a heat sink mounting arrangement according to an embodiment of the invention. A heat sink 20.250 is attached to the tank wall 20.100 using a captive nut 20.254 attached to the tank wall, and a bolt 20.252. A heat sink foam dam 20.256, further described with reference to FIG. 22, prevents ingress of foam insulation in proximity to the heat sink during injection of the foam insulation. The heat sink foam dam is held between the tank wall and the jacket 20.002. The foam dam 20.256, surrounds heat sink 20.250. The heat sink is mounted to the tank wall 20.100 by bolt 20.252 attached to nut 20.252 which is affixed to the tank wall 20.100. The heat sink can have a straight base, as shown in FIG. 20, with the resulting gap between the base of the heat sink and the curved wall of the tank filled with heat conductive pate 20.264.

FIGS. 21A and 21B illustrate a heat sink similar to that of FIG. 20, but with a curved base 21.251 to match the curve of the tank wall. The heat sink can be a solid block of aluminium or other heat conductive material. In practice, the curved base 21.251 can have a slightly smaller radius than the wall of the tank so that, when the bolt 20.252 is tightened, the tank wall can deform slightly to mate with the curve 21.251. The heat sink will usually have a different coefficient of thermal expansion from that of the tank wall. However, this can be compensated for to some extent by applying sufficient compressive force to the heat sink via the bolt 20.252.

The heat sink of FIG. 21A includes a first recess 21.260 adapted to accommodate the nut 20.254, and a second bore 21.258 adapted to enable the bolt 20.252 to engage the nut.

The heat sink 20.250 includes a pair of communicating holes 20.258, 20.260 which form a through hole. Hole 20.260 accommodates captive nut 20.254 affixed to the tank wall. Hole 20.258 permits the bolt 20.252 to engage the nut and hold the heat sink in contact with the tank wall. The heat sink 20.250 can include a concave face 20.251 adapted to conform to the wall of the tank 20.100. The heat sink can have a trapezoidal shape with a curved base, the base being wider than the top and providing a larger contact area for heat transfer to the tank wall. Tapped screw holes 21.259 are provided for the attachment of a power modulation device such as a thyristor. The heat sink can be made from a metal with good thermal conductivity such as aluminium. The heat sink can be designed with a slight mismatch with the cylinder outer diameter such that when the single attachment bolt is tensioned, the metal faces will mate together and provide improved heat transfer across the boundary. The base of the heat sink 21.251 can have a slightly smaller radius of curvature than the curvature of the tank wall at room temperature so that the thermal expansion at a chosen operating temperature, e.g., 60° C., the curve of the heat sink base will match the curve of the tank wall. The heat transfer capability into the water can be enhanced by addition of heat conductive paste between this interface and the switching component interfaces.

One or more power modulating devices, such as a thyristor or power transistor, can be mounted on the heat sink. Heat from the modulating device is transferred through the tank wall to the water inside the tank, so the heat from the modulating device is used to heat the water in the tank.

FIG. 22 illustrates a foam dam 22.256 adapted to enclose a heat sink according to an embodiment of the invention. The heat sink dam has a curved underside 22.257 to match the curvature of the tank wall, and a curved upper side 22.261 to match the curvature of the jacket. The heat sink dam includes an aperture 22.262 to accommodate a heat sink such as 22.250 described above. The top of the aperture 22.263 can be open to provide access to the heat sink. The foam dam 20.256 can be a single piece foam dam placed over the heat sink when the heat sink has been attached to the tank wall.

FIG. 23 illustrates an exploded view of a double-PCB arrangement to provide a compact assembly for a controller according to an embodiment of the invention. A first PCB assembly 23.302 contains one or more circuit components and a first connector element such as multi-pin plug 23.304. A second PCB assembly 23.306 contains one or more circuit components and a second connector element such as socket 23.308. The connector elements 23.304 and 23.308 are mating multi-contact connectors and are dimensioned so that, when engaged, the first controller PCB 23.302 is spaced above, or overlies or is adjacent to the components on the second PCB assembly 23.306. The first PCB assembly 23.302 can be cantilevered above the second PCB assembly 23.306 from the connectors 23.304, 23.308.

The first PCB assembly 23.302 can include a control chip, such as a programmable controller, ASIC, or microprocessor 23.303 connected via connector 23.304-23.308 to control the components on the second PCB 23306. In this embodiment, PCB 23.306 can include relays such as 23.322 controlling an electrical element having one or more blades.

FIG. 24 illustrates a first exploded view of the combined double PCB assembly of FIG. 23 and a thermal cut-out switch 24.310.

The PCBs can be physically mounted on a thermal cut-out switch such as 24.310 shown in FIG. 24. A mounting bracket 24.320 can be used to enable the PCBs to be attached to the thermal cut-out switch.

Mounting bracket 24.320 is connected to the thermal cut-out switch 24.210, for example, by screws. Alternatively, the mounting bracket can be integrated with the thermal cut-out switch housing. The mounting bracket carries connection elements such as snap fit elements (26.312 in FIG. 26) to engage with PCB 24.306.

The arrangement of FIG. 24 thus provides a triple layer arrangement of: A—electrical cut-out switch, B—power switching relays, and C—power switch controller. Power is delivered to the electrical heating element via a series connection of the power control relays and the electrical cut-out switch. This arrangement provides a compact assembly with a reduced footprint, while locating the power switch controller remote from the heated wall of the tank.

FIG. 25 illustrates a second exploded view of the arrangement of FIG. 24. The controller PCB assembly can be connected to the thermal cut-out switch via a mounting bracket 25.320 attached to the thermal cut-out switch.

FIG. 26 illustrates an assembly of a thermal cut-out switch 26.310 and a double PCB assembly 26.302, 26.306.

FIG. 26 is a section view along G-G in FIG. 27.

FIG. 28 is a side view showing controller PCB 28.302 cantilever mounted on relay PCB 23.306.

Optionally, the PCB mounting bracket 29.320 can be integrated into the housing of the thermal cut-out switch 29.310 as shown in FIG. 29.

The mounting arrangement to mount the PCB assembly on the thermal cut-out switch can be achieved by assembling a mounting bracket to the thermal cut-out switch, the mounting bracket carrying the relay board to which the controller board has been connected.

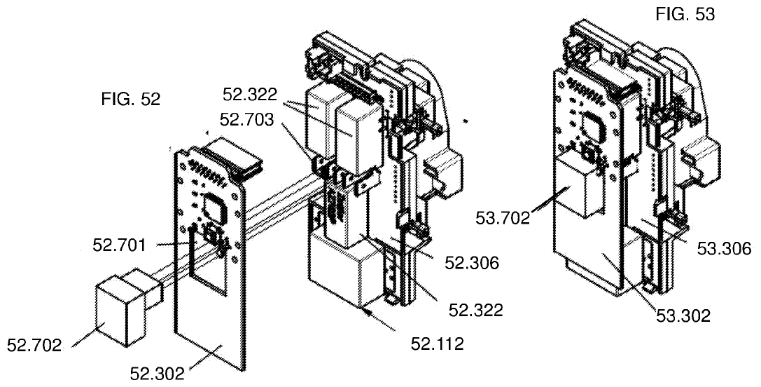

Additional controller configurations are described below with reference to FIGS. 52 & 53.

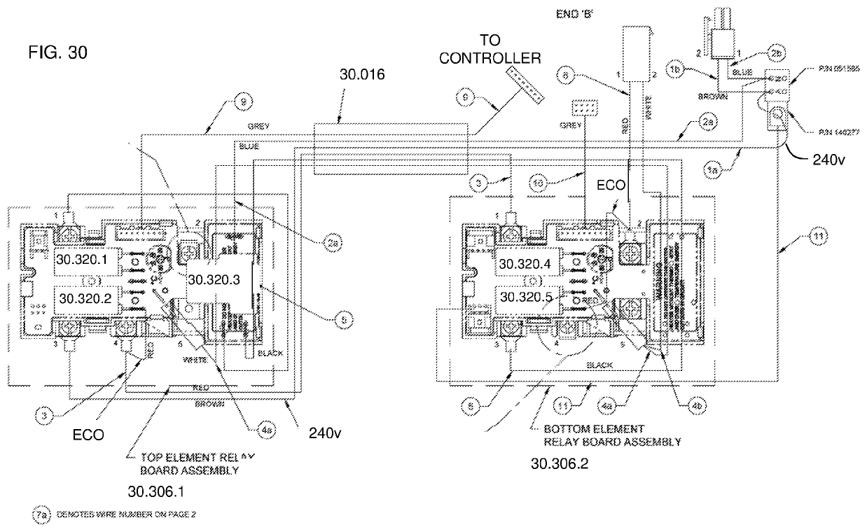

FIG. 30 illustrates a pair of relay PCB 30.306.1 and 30.306.2 connected by cable 30.016. Relay PCB 30.306.1 includes three relays 30.320.1, 30.320.2, and 30.320.3 to control an upper heating element. Relay PCB 30.306.2 carries relays 30.320.4 and 30.320.5 to control a lower heating element.

In FIG. 30:
1a=top ECO pin 3.lead;
1b=control power lead;
2a=relay_T_B common lead;
2b=control power lead;
3=top ECO pin 4 lead;
4a=top ECO pin 6 lead;
4b=control exit lead;
5=relay_T_B normally open lead;
6=relay_T_B normally closed lead;
7a=top ECO pin 4 lead;
7b=bottom ECO pin 2 lead;
8=control exit lead;
9=controller board 8 pin connector lead;
10=bottom element relay board lead;
11=CT clamp lead;

Mounting the controller PCB assembly on the thermal cut-out switch spaces the controller PCB assembly from the tank wall so the controller components are not in contact with the heated tank wall, while at the same time, providing a compact footprint. Thus components whose performance may be affected by heat can be mounted on the PCB 29.302.

While the above described and illustrated embodiments utilise temperature sensors which engage or are located on the outside of the tanks illustrated, it will be understood that the temperature sensors, can instead be located inside one or more blind tubes, which can be inserted into the inside of the tank by means of a fitting similar to that illustrated and described with respect to FIG. 11A, so that the temperature sensor will be located inside the tank as in FIG. 19A, and the outside of the blind tube can be sealed with respect to the tank. This can be a bolt in arrangement, or if desired a screw in arrangement could also be utilised. These can be located at different heights in the tank.

The PV water heating system illustrated in FIG. 31 includes a PV collector 31.002, an inverter 31.004, a water tank 31.020, a heating unit 31.016 having two or more elements 31.016.1 to 31.016.x, a temperature sensor 31.022, a number of switches, 31.014.1A to 31.014.m, each associated with a heating element, an AC modulator 31.060, utility grid supply 31.050, bidirectional utility grid meter 31.052, utility grid switch 31.054, and controller 31.040. Because heating element 31.016.1 is powered via the modulator, the switch 31.014.1A is optional, as the modulator output can be reduced to zero.

The PV collector 31.002 is connected to inverter 31.004 which converts the DC voltage output from the PV collector to an alternating voltage supply suitable for delivery to the utility grid. A water storage tank 31.020 has a first multi-element heating unit which is inserted in the lower portion of the tank via a sealed flange 31.017. While temperature sensor 31.022 is shown inserted via flange 31.017, it could be inserter via a separate sealed opening, which could be in the top of the tank. Temperature sensor 31.022 is located to measure the temperature of the water proximate the heating unit with two or more individual heating elements 31.016.1 to 31016.x. It is understood that the tank may be equipped with two or more temperature sensors at different vertical locations.

Circuit 31.001 delivers power to other domestic devices. The other domestic uses will normally take precedence over the water heater for the delivery of PV energy.

The output from the inverter 31.004 is connectable to at least one of the elements 31.016.1 to 31.016.x via corresponding ones of the switches 31.014.1A to 31.014.m.

In the embodiment of FIG. 31, modulator 31.060 modulates the AC inverter output supplied to one of the heating elements 31.016.1.

Controller 31.040 is adapted to receive system information, such as sensor information from temperature sensor 31.022 via link 31.022.1, and utility grid current flow information from current sensor 31.053 via link 31.053.1. This enables the controller to monitor the direction of energy flow to or from the utility grid. The current sensor can be a modular device with internal communication capability which may enable the current sensor to send the information to the controller by a number of different links, such as household power line, Bluetooth, WiFi, or physical cable. Alternatively, the current flow can be obtained from the power utility's bi-directional meter 31.052 if the power utility consents to this. The current sensor provides feedback to the controller on the effect of the adjustment of the modulator output by the controller.

The controller is adapted to control the switches 31.014.1 to 31.014.m via control links 31.014.1.1 to 31.014.m.1. The controller also controls the modulator 31.060 via link 31.060.1. The controller can be a programmable controller or other suitable microprocessor controlled device adapted to respond to the inputs and to control circuit elements, such as switches 31.014A, 31.014B, 31.014m. The controller can control the connection of the alternating inverter output or the utility grid power to one or more of the heating elements.

The utility grid power supply 31.050 can be connected to the heating elements via the individual element switches and utility grid breaker switch 31.054.

The two or more individual heating elements 31.016.1 to 31016.x can be connected individually or in combinations of two or more elements to a source of electric power, such as solar collector 31.002 via inverter 31.004, or utility grid power 31.050. Because element 31.016.1 is modulated, it can be connected to two switches 31.014.1A and 31.014.1B. Controller 31.040 controls the switches such that switch 31.014.1A connects PV supply to modulator 31.060 when PV supply is available and the temperature of the water in the tank is below a maximum allowable temperature (the maximum temperature threshold). When there is no PV supply (eg, at night), the controller can open switch 31.014.1A and the controller can operate switch 31.014.1B to connect utility grid power to heating unit if the water is below a second, normally lower, temperature threshold. The controller can also take account of time-of-day tariffs to reduce the cost of using the utility grid power.

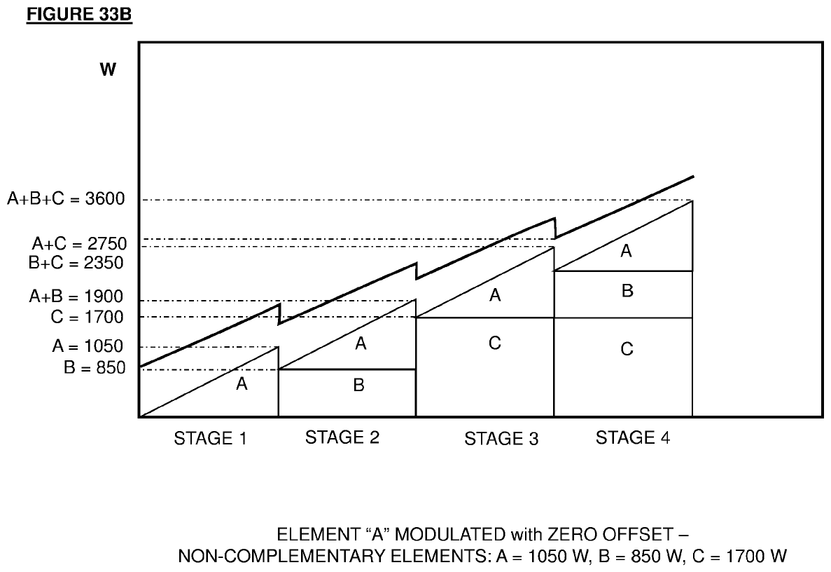

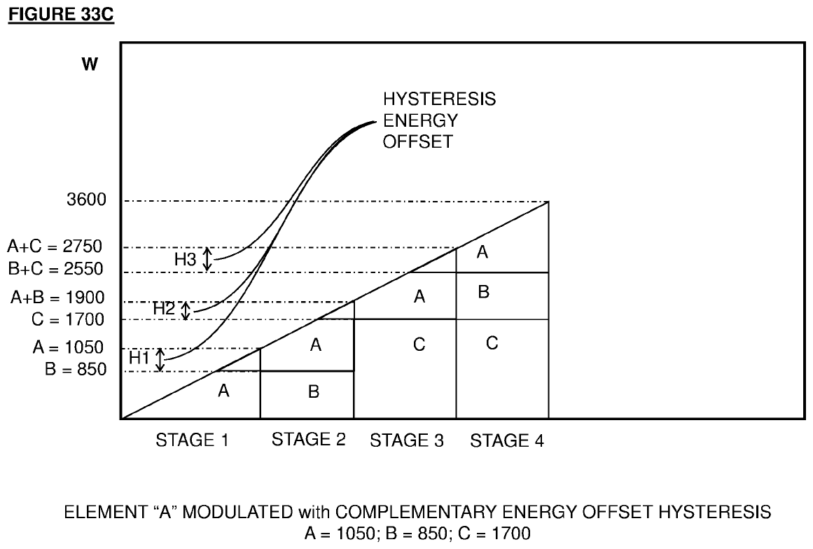

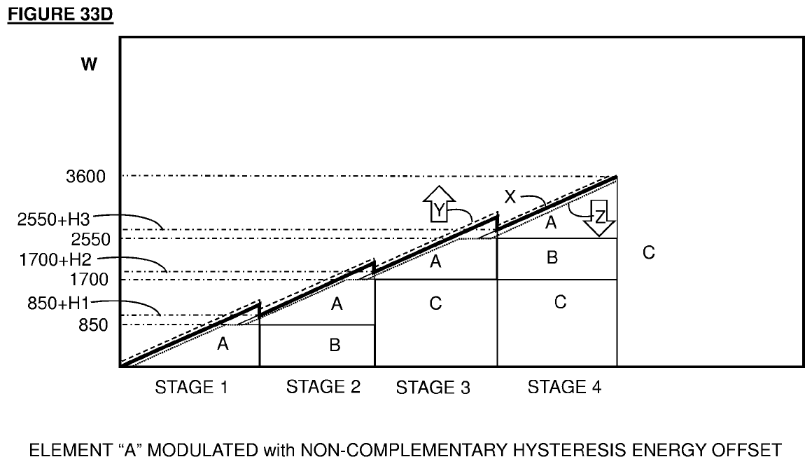

The resistance of the elements can be equal, or one or more of the elements can have a different resistance from the other elements. The arrangement of FIG. 31 will be described with the heating unit having three heating elements A, B, C, the highest power element C having a resistance of Q ohms, and the other two elements A, B having equal resistances of 2 Q ohms. In the example of FIG. 33, elements A and B have a power rating of 900 W, and element C has a rating of 1800 W, for a 240 v AC supply, providing a combined power rating of 3600 W.

The controller receives inputs from the temperature sensor 31.022 and the utility grid current sensor 31.053 or the bidirectional utility grid power meter 31.052. When a large amount of power is generated by the PV collector, it may exceed the demand from the other domestic uses 31.001. In previous feed-in system, the excess power from the PV collector would have been fed into the utility grid, the meter 31.052 calculating the amount of power delivered to the utility grid and the power utility company would credit the home owner with the amount of power at the specified feed-in tariff.

According to an embodiment of the invention, when the controller 31.040 detects that power is flowing from the PV collector to the utility grid, it can activate the water heater circuits to divert the PV energy to the water heater. Only if the amount of PV collector power exceeds the demands of both the water heater and the other domestic uses is the excess PV collector power delivered to the utility grid.

The switchable heating element configuration shown in FIG. 33 has the advantage of enabling a continuous variation of output power from the modulator while only one element in this example, element A, which can correspond with element 31.016.1, is powered via the modulator 31.060.

In the exemplary embodiment, with complementary heating elements, element A is a 900 W element, element B is a 900 W element, and element C is an 1800 W element, or more generally, elements A & B each have an impedance value of 2 R, while element C has a value of R.

It is assumed that, in an initial state, the heating elements are unpowered, and the current sensor indicates current flowing out from the inverter into the utility grid. When the controller detects such a state, it initiates a process to divert the excess energy from the utility grid into the water heater, while continuously monitoring the current flow direction via the current sensor. The current sensor can sample the current at a sufficiently high sampling rate to enable the controller to track the effect of each adjustment of the modulator output.

In Stage 1, only element A is energized (switch 31.014.1A closed). The controller controls the modulator so that the output of the modulator initially starts at zero volts, and then increases the modulator output until full power of 900 W is delivered to element A or until the current sensor detects that current flow out to the utility grid has ceased.

If the current sensor detects that current is still flowing out to the utility grid, the controller initiates Stage 2. At Stage 2, the controller switches on element B at its full 900 W power while also reducing the modulator output to zero, so that no power is delivered to element A. Element A can then be ramped up from zero to 900 W, giving a combined power of 1800 W from the combination of elements A and B. Again, if the current flow out to the utility grid stops before the full power is delivered to elements A & B, the controller will stop increasing the output from the modulator.

In Stage 3, elements A & B are switched off, and element C is switched on maintaining the power at 1800 W. Element A is again ramped up from zero to 900 W, resulting in power usage of 2700 W, being the combination of elements A and C. Again, if the current flow out to the utility grid stops before the full power is delivered to elements A & C, the controller will stop increasing the output from the modulator.

In Stage 4, element A is switched of and element B is switched fully on providing an initial power consumption of 2700 W. Again, element A is switched on and can be ramped up from zero to 900 W, resulting in 3600 W being delivered to the water tank via the combination of elements A, B, and C. Again, if the current flow out to the utility grid stops before the full power is delivered to elements A, B & C, the controller will stop increasing the output from the modulator. If the current is still flowing out to the utility grid, the bi-directional meter 31.052 will continue to credit the customer for the energy supplied.

Optionally, the utility grid can be connected to element 31.016.1 via switch 31.014.1B while bypassing the modulator 31.060. When there is no useful output from the PV collector, eg, at night time, and utility grid power is needed to heat the water, switch 31.014.1A is opened, so the utility grid power is not fed via the modulator 31.060 to element 31.016.1.

The inverter can be designed to draw power from the PV collector up to the maximum power point of the PV collector at the current level of insolation. When there is insufficient solar energy to fully meet the other domestic demand, the inverter ensures the delivery of the available PV energy to the load before utility grid power is drawn. The inverter may do this by adjusting the phase and amplitude of the inverter output voltage relative to the utility grid voltage.

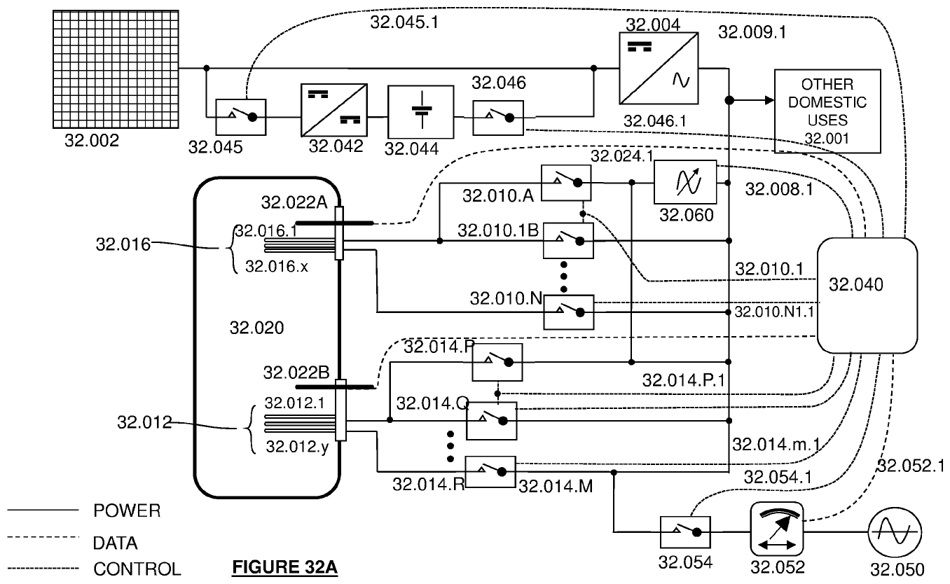

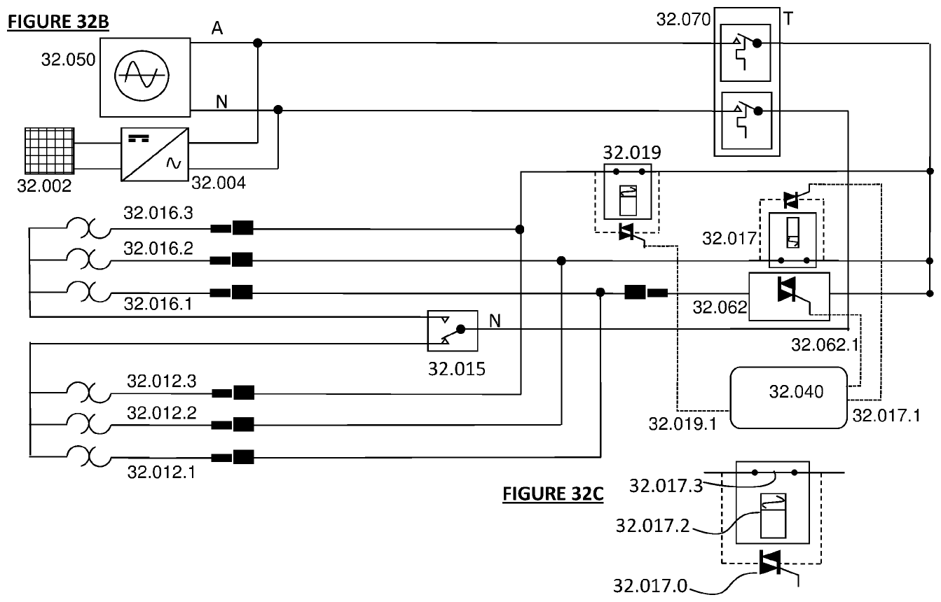

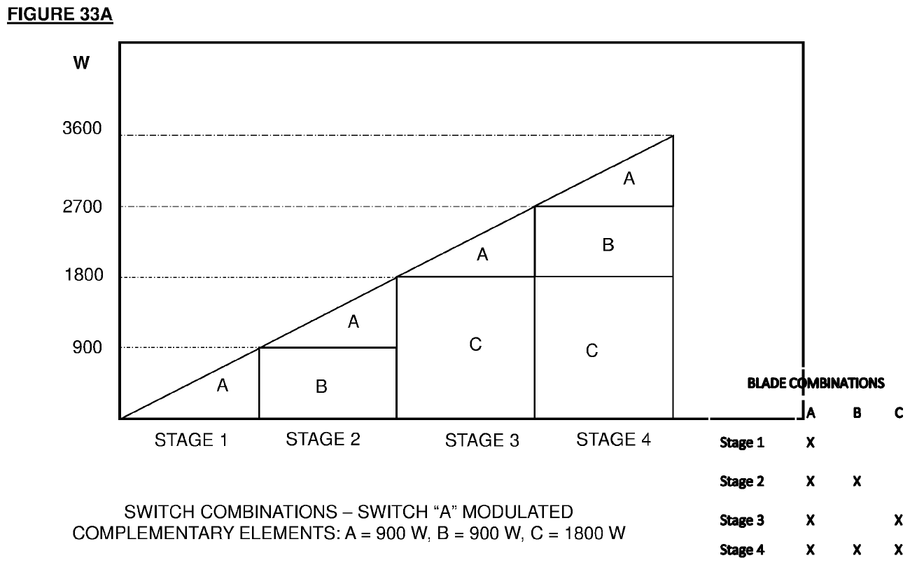

In the description of FIG. 31B, a distinction is made between thermostat and temperature sensors. A thermostat is a mechanical device whose physical thermal characteristics are such as to change state at a set temperature. A temperature sensor can act as a thermometer to provide a continuous reading of temperature. An additional feature of FIG. 31B is the use of neutral switching, explained in more detail below with reference to FIG. 32B, the line A being active, and the line N being neutral. This enables the controller 31.040 to select either the upper heating unit 31.016 or the lower heating unit 31.012.

FIG. 31B illustrates a water heater having first and second heating units 31.012 located in a lower portion of the tank, and 31.016 located in an upper portion of the tank. A thermostat arrangement including a temperature monitor 31.100 and a thermostat switch 31.102 can be provided in a minimal configuration.

The thermostat can operate independently of the controller 31.040.

In one mode of operation of the minimal configuration without optional temperature sensors 31.022A, 31.022B, the thermostat can be set to an upper temperature threshold, eg, 75° C. Where there is excess PV energy as indicated by, for example, the flow of current out to the utility grid, and when the water in heated by the lower heating unit 31.012 reaches the upper temperature threshold as sensed by the thermostat temperature monitor 31.100, the thermostat switch 31.102 will interrupt the flow of current to modulator 31.060 and the heating element switches 31.014. This results in the excess PV energy being delivered to the utility grid.

Normally, power from the utility grid will only be delivered to the water heater during off-peak periods. If utility grid power heating of the water in the tank is required in an off-peak period when not PV energy is available, the controller can be programmed with the utility tariff schedule and select the upper heating unit 31.016 so the utility grid power is only used to heat the water in the upper portion of the tank. If the thermostat is the only temperature sensitive device in the tank, the mains power will heat the water to the upper temperature threshold. This method thus limits the use of utility grid power. The off-peak utility grid power may be used to heat the upper portion of the tank to limit the consumption of utility grid power. A second heating unit, such as 31.012 can be used when there is excess variable source energy, such as PV energy, to heat the whole tank to the upper temperature threshold as detected by the thermostat. Alternatively, a second temperature sensor 31.022B being used to monitor the temperature in the lower section of the tank.

Optionally, at least a first temperature sensor 31.022A can be located in an upper portion of the tank.

In a second configuration, including temperature sensor 31.022A, the controller can utilize the information from temperature sensor 31.022A to set a second, lower temperature threshold, eg, 60° C. in the upper portion of the tank when utility grid power is being used to reduce the usage of grid power.

In a further configuration, when PV energy is used to heat the whole tank using lower heating unit 31.012, a further temperature sensor 31.022B can be provided to measure the temperature in the lower portion of the tank. When the tank is heated to a chosen temperature threshold, the controller can switch the heating units off, and divert excess PV energy to the utility grid.

The controller can be programmed with the off-peak times, and can also be adapted to receive off-peak time information via a communication link with the utility company, so that the controller is aware of pre-programmed off-peak times, or so that the controller can be informed of variable load periods when it is preferable to power the water heater from the utility grid when no variable source power is available.

FIG. 31C represents a system similar to that of FIG. 31A, but with a reduced number of heating elements illustrates an embodiment of the invention having one modulated switchable element 31.016.P, and one switchable, non-modulated element 31.016.Q. These elements can be separately mounted in the tank, and the temperature sensor 31.022 can also be separately mounted in the tank. This embodiment is adapted to perform the switching and modulation operations of Stage 1 and Stage 2 of FIG. 33A.

FIG. 32A illustrates a PV feed-in and water heating system having two multi-element heating units according to the invention, the system including: water tank 32.020, a first heating unit 32.016 having one or more heating elements 32.016.1 to 32.016.x, a second heating unit 32.012 having two or more elements 32.012.1 to 32.012.y, a first temperature sensor 32.022, a PV collector 32.002, battery charge switch 32.045, DC to DC regulator 32.042 which may also have an associated smoothing filter, battery 32.044, battery output switch 32.046, inverter 32.004, a group of first element switches, 32.010.A to 32.010.N, each associated with an element of the first heating unit, a second group of second element switches 32.014.P to 32.014.R, an AC modulator 32.060, utility grid supply 32.050, bidirectional utility grid meter 32.052, utility grid breaker switch 32.054, and controller 32.040. The modulator 32.060 is connected to supply either element 32.016.1 or element 32.012.1 depending on whether switch 32.010.A or 32.014.P is closed under control of controller 32.040.

In a manner similar to that discussed in relation to FIG. 31, the controller 32.040 receives inputs from the temperature sensor 32.024 and the bidirectional utility grid power meter 32.052.

As discussed with reference to FIG. 31, when a large amount of power is generated by the PV collector, it may exceed the demand from the other domestic uses. The controller 32.040 can deliver the PV collector power to the following entities in order of preference:

1. Other domestic uses 32.001;

2. water heater 31.020;

3. utility grid feed in via bidirectional meter 32.052.

In the embodiment shown in FIG. 32A, battery 32.044 can be used to store energy from the PV collector 32.002 when the PV collector output exceeds demand from the premises and the water heater is at maximum temperature, in which case controller 32.040 closes battery charge over switch 32.045 and enables the PV current to be directed into the battery via DC regulator 32.042 in priority before PV collector power is delivered to the utility grid.

Battery output switch 32.046 can connect or disconnect the battery from the rest of the circuit. When the battery is fully charged and there is no demand from the premises, the PV power can be fed into the utility grid via the bidirectional meter 32.052. The battery charging system will normally have a charge detector to determine when the battery is fully charged.

The tank is fitted with two heating units, an upper heating unit 32.016 and a lower heating unit 32.012. Heating unit 32.016 is a multi-element heating unit 32.012.1 to 32.012.y with associated switches 32.010.A to 32.010.N and can be adapted to be connected to either the PV supply or the utility grid supply. The lower heating unit can have one or more elements and can be adapted to operate with utility grid power or PV collector power. Switch 32.054 connects the utility grid to the internal wiring, including the water heater and the other domestic uses circuit. As shown in FIG. 31, the tank can be fitted with only one heating unit having two or more heating elements.

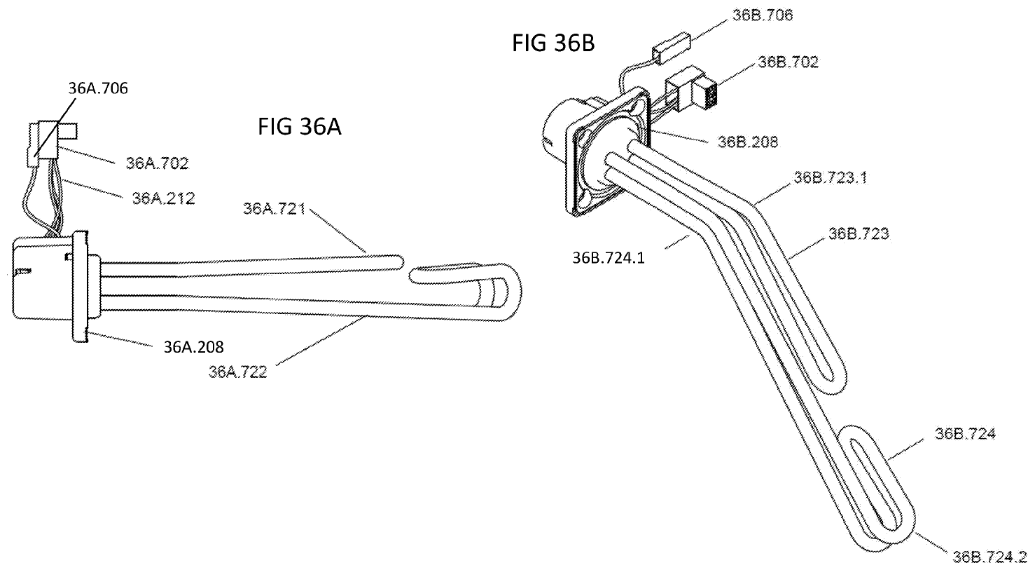

The controller, modulator and multi-element heating unit with attachment flange, as shown in FIG. 36, can be provided in a form suitable for retro-fit assembly to an existing tank to replace a single element heating unit with attachment flange. A current transformer to measure the incoming or outgoing current would also be provided, and the temperature sensor would be replaced or fitted with an adaptor to ensure compatibility with the controller.

The controller can be programmed to activate the upper heating unit 32.016 to heat the upper portion of the tank before the lower heating unit is activated.

The arrangement of FIG. 32A can also be operated in a manner to quickly deliver heated water in the upper portion of the tank, while also heating the remainder of the water in the tank. A proportion of the PV energy can be delivered to the upper heating unit 32.016, and the remainder of the excess PV energy can be delivered to the lower heating unit 32.012. All the heating elements of the upper heating unit can be powered, while only one of the lower heating elements need be powered. The lower heating element will create convection circulation, so while the water in the upper portion of the tank heats rapidly, the water in the remainder of the tank is also heated. The lower heating element can be disposed asymmetrically in the tank to enhance the circulation. Thus, for example, three quarters of the available excess PV energy can be delivered to the upper heating unit, and one quarter can be delivered to the lower heating unit, eg, by selecting only one of the heating elements of the lower heating unit.

FIG. 32B illustrates a wiring connection arrangement according to an embodiment of the invention, and FIG. 32C illustrates details of triac/relay combination used in an embodiment f the invention. The embodiment of FIG. 32B provides the same heating unit control functionality as the arrangement of FIG. 32A, but requires fewer switches. The active A and neutral N lines of the wiring circuit are shown as the arrangement of FIG. 32B utilizes neutral line switching to enable a reduction in the number of switches.

The utility grid power 32.050 and the output from the PV collector's 32.002 inverter 32.004 connect to the active and neutral lines.

All the neutral connections of each element in the first heating unit are connected together. Similarly, all the neutral connections of each element in the second heating unit are connected together. A thermal cutout switch [32.070] may be mandated by safety regulations.

The heating element switches 32.062, 32.017, and 32.019 include triacs connected to controller 32.040 via links 32.062.1, 32.017.1, and 32.019.1 respectively. Switches 32.017 and 32.019 are adapted to act as ON/OFF switches and incorporate relays such as 32.017.2 with metal contacts 32.017.3 in parallel with the triac 32.017.0 so the metal contacts carry the current when the switches are closed. When the controller instructs the switch to open, the triacs are designed to open after the relay operates to avoid arcing of the metal contacts.

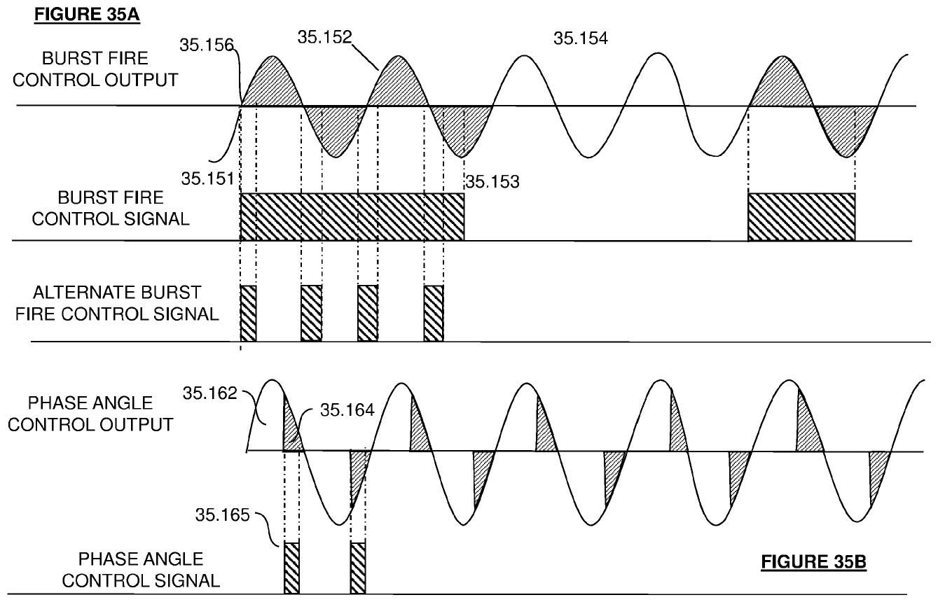

The triac 32.062 is designed to act as a modulator, so the controller can vary the amount of current passing through the triac to heating element 32.016.1 or 32.013.1, depending on the state of switch 32.015. The controller controls the modulator by applying a signal to the control electrode of the triac to turn the triac on, while removing the signal causes the current to cease at the next zero crossing as shown in FIG. 35. With a purely resistive load, the current and voltage are in phase. Using phase angle control as discussed below with reference to FIG. 35B, the triac [32.062] is switched on during each successive half cycle by a short pulse from the controller. Thus the triac [32.062] is used as a modulator under control of the controller [32.040]. While the triac [32.062] is shown as separate from the controller [32.040] it is understood that the controller and the triac can be incorporated in a single module. The controller implements a control routine based on the temperature and current flow direction information to generate the control signals for the triacs.

Triac/relay combinations 32.017 and 32.019 discussed further with reference to FIG. 32C, control (under command of the controller) the connection of the heating elements 32.016.2 and 32.016.3 of the first heating unit to the active line. The connection of element 32.016.1 to the active line is controlled by triac 32.062. Similarly, the active connections of elements 32.012.2 and 32.012.3 of the second heating unit are controlled by the Triac/relay combinations 32.017 and 32.019, while the active connection of element 32.012.1 is controlled by triac 32.062. The triac 32.062 performs both the modulation and switching function to deliver modulated AC power to the elements 32.016.1 and 32.012.1. Change-over switch 32.015 is adapted to complete the power circuit to either the first heating unit or the second heating unit by closing or opening the corresponding neutral path to the first or second heating unit.

FIG. 32C illustrates the parallel connection of a triac 32.017.1 and a relay connection 32.017.3. The relay coil 32.017.2 operates the relay connection. The relay connection is a metal connecting path and thus has lower conduction losses than the triac. When the combined triac/metal relay switch is closed the current flows via the metal contact because of the lower resistance of the metal contact path. The triac has the advantage of being able to implement zero-crossing switching. Thus, when the combined switch is to be opened, the metal relay contacts are opened, diverting the current via the triac. The triac can then interrupt the current at the zero-crossing.

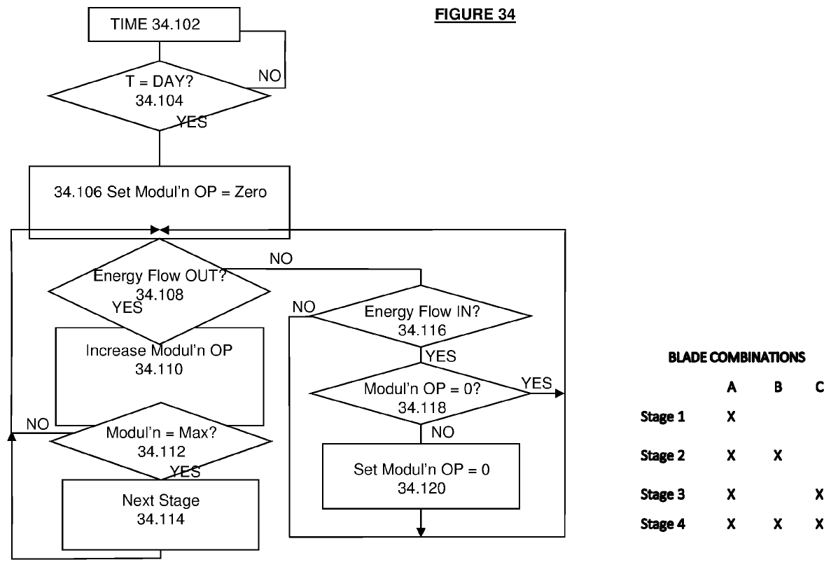

The controller is configured with the operating characteristics of the modulator, so it knows when the modulator is at its maximum output setting. The controller is adapted to increase the modulator output in incremental steps, and to receive current flow monitoring information from the current transformer or utility grid meter so the controller can assess the result of each change in the modulator output. In addition, the inverter is adapted to set its output to correspond with the solar collector maximum power point MPP. FIG. 34 illustrates a method of controlling the delivery of energy from the PV collector to the heating unit:
Step 34.102-34.104 Start condition, e.g., Time (e.g.: sunrise+30 minutes) or output from inverter;
Step 34.106 Stage 1 Switch A Set modulator 32.060 to zero;
step 34.108 Monitor energy flow in or out
Step 34.110 If flow out, increase modulator output;
Step 34.112 Check if modulator output is at maximum;
Step 34.114 If not maximum, return to step 34.108, which begins a continuous process of monitoring the flow of current to or from the utility grid;
Step 34.116 If at maximum, switch to next stage (e.g., Stage 2—switch A+B) and return to step 34.108;
If step 34.108 indicates there is no flow out, go to step 34.116 and check if there is inward flow from the utility grid;
If there is no inward utility grid flow, return to step 34.108;
If there is inward utility grid flow, check if modulation output is zero at step 34.118;
If modulation output is zero, return to step 34.108;
If modulation output is not zero, set modulation output to zero at step 34.120 and return to step 34.108 to continue monitoring the current flow to or from the utility grid.

The method of FIG. 34 provides a continuous feedback process in which the controller monitors the flow of current to or from the utility grid, and when there is flow to the utility grid from the inverter, the controller powers the modulator until either all the available energy from the inverter is used in meeting the domestic load and partially powers the water heater, or until both the domestic load and water heater are fully powered from the inverter, and any surplus energy is exported to the utility grid. If there is insufficient energy available from the inverter, the inverter is designed to share the load with the utility grid, ensuring that all the energy from the solar collector is consumed before drawing power from the utility grid. The current transformer or utility grid meter provide continuous feedback to the controller as to the effect of each adjustment of the modulator output when there is surplus PV energy being exported to the utility grid.

The modulation of the voltage in four stages can be smooth and linear from zero to maximum. However, other modulation schemes may be implemented such as starting at the top of Stage 2 and then moving up or down depending on the utility grid meter flow direction. Alternatively, where the controller monitors the actual level of energy flow as well as the direction, this can be used by the controller to calculate a starting point modulation likely to cancel the flow, and can then increase or decrease modulation depending on the flow direction.

FIG. 35 shows two types AC power modulation which can be implemented using triacs.

FIG. 35A illustrates burst fire control, in which power is modulated by switching the current on 35.152 for a number of AC cycles and off for another group of cycles 35.154. The burst fire control signal BFCS 35.151 to 35.153 from the controller [32.040] can be maintained for a number of half cycles, and the trailing edge of the BFCS can occur before the end of the last half cycle as the triac will continue to conduct until the zero crossing of the last half cycle in which thee BFCS was removed. Switching can be timed to coincide with the zero crossings 35.156 of the current. By adjusting the duty cycle, the power delivered can be modulated. Burst fire control can cause problems such as flickering of lights when it is carried out on utility grid power.

In an alternative BFCS arrangement shown in FIG. 35A, the controller can generate short control pulses spanning the zero crossings at the beginning of each half cycle for the duration of the required current burst. The short pulses can commence before the zero crossing of the previous half cycle and continue after the zero crossing.

FIG. 35B illustrates phase angle control, in which current is switched on for a portion of each cycle 35.164 and is switched off for the rest of the cycle 35.162. The phase angle control signal PACS from the controller can be a short pulse 35.16.5, sufficient to turn the triac on, but ends within the same half cycle so that the zero crossing extinguishes the current. Again zero-crossing switching is used in switching off to mitigate arcing. Phase angle control generates a significant amount of electromagnetic interference EMI due to the asymmetric nature of the current. FIG. 35B illustrates leading edge phase angle control suitable for use with triacs, as the zero crossing of the waveform is used to extinguish the current.

While the embodiments of the invention may utilize phase angle control as discussed with reference to FIG. 35B, the invention may utilize any of the available modes of modulation.

By limiting the amount of energy delivered by phase angle control, i.e., modulating a lower power element such as a 500 W or 900 W element instead of modulating, for example, a single 3600 w element, the amount of interference can be limited.

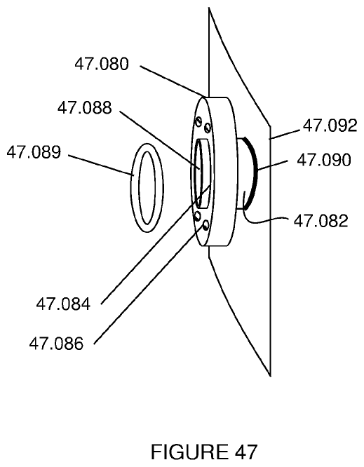

FIG. 36A shows a first embodiment of a two blade heating element. The elements are mechanically affixed to flange 36A.208, from which they are electrically insulated. The elements are designed to pass through an aperture in the tank wall. The flange is designed to sealably close the aperture. Each heating element has electrical terminals, which pass through the flange attachment to the exterior of the tank and which are connected to power connector 36A.702 via electrical wires 36A.212 to enable power to be supplied to the heating elements individually or collectively, and via neutral connector 36A.706 to the system neutral. A connector 36A.702 is adapted to connect to controller's power supply blades (52.704 in FIG. 52) to provide electrical power to the blades as determined by the controller. A first U-shaped blade 36A.721 can have a substantially straight configuration. A second U-shaped blade 36A.722 has the end of the blade formed with a 180 return curve. The profile of the two blades is such that the blades can be inserted through the element insertion aperture 37.088 in tank wall 47.092 shown in FIG. 47.

FIG. 36B shows a second embodiment of a two blade heating element. In this embodiment the U-shaped blade 36B.024 has a first bend 36B724.1 in the plane of the U-shaped blades legs, and a second bend 36B.724.2 nearer the U-bend of the blade. The shorter blade 36B.723 has a bend 36B.723.1 near to the bend 36B.724.1 of the longer blade so the segments of the short blade remain substantially parallel to the corresponding sections of the long blade. This enables both blades to be inserted into a water heater tank through the aperture 47.088 while ensuring that the long blade does not contact the wall of the tank. For example, where the resistivity of the blade material is the same in both blades, and one blade is of a substantially greater power rating than the other blade, the lower rated blade will be substantially shorter than the higher rated blade because power is inversely proportional to resistance. The two blade heating element unit of FIG. 36B is connected by means of power connector 36B.702 and neutral connector 36B.706.

The description in the preceding two paragraphs is in respect of 2 bladed elements illustrated in FIGS. 36A and 36B. However, it will be understood that these can be replaced by a three bladed element as illustrated in FIG. 46, and as described below. In FIG. 46, by way of example, is illustrated, a heating unit 46.200 having three separately switchable heating elements 46.202, 46.204, 46.206, with 46.202 being largely obscured by 46.204. While only two elements are clearly visible to avoid an over-complex drawing, it is understood that the heating unit can have more than two or more elements. By using different resistivities or resistances for the blades, the blade element 46.206 can have a lower resistance, and hence a greater energy rating, than elements 46.202 and 46.204. The blade element 46.206 has a greater length than 46.202 and 46.204, and thus a greater surface area, to provide greater contact with water in the tank to provide more efficient heat transfer.

The elements of a water heater with switchable elements can be switched using electromechanical relays. Such relays are subject to degradation over time, as physical wear and electrical erosion damage the switch contacts. It is thus desirable to reduce the operation of the electromechanical relays.

An embodiment of the invention proposes the use of hysteresis to reduce the number of times a relay needs to switch during the day.

In one alternative embodiment of the invention, hysteresis can be provided by using an offset energy input for the modulated element during the element switching operation. The heating elements B, A, C can be rated at 850, 1050, and 1700 watts respectively, again providing a maximum rating of 3.6 kW for the three elements in parallel. However, instead of using the lowest rated element (850 W in this embodiment) as the modulated element, one of the higher rated elements is chosen as the modulated element. By selecting one of the higher rated elements, the frequency with which the electromechanical relays connecting the elements to the energy supply can be reduced.

In one embodiment, such as that shown in FIG. 31A, the switching protocol for this alternative arrangement having one modulated input element A rated at 1050 W, and two unmodulated elements, B, rated at 850 W, and C, rated at 1700 W, includes the steps of:
when there is excess solar energy available, switch in element A with the modulator set to provide a first power input level, which may be zero W;
ramp up the energy to element A until the available excess solar input is reached or until the maximum power (1050 W) is applied to element A;
where the available excess solar input exceeds the element A's rated input, the energy input to the 1050 W element can be reduced to a second value, which can be, for example, zero W FIG. 33B, or which may be chosen to complement element B, e.g., 200 W FIG. 33C, so that the combined rating of the modulated element A and the unmodulated element B is equivalent to the energy rating of element A (1050 W);
at the same time, element B, is switched in in parallel with element A;
the energy input to element A is again ramped up until the available excess solar input is reached or until the maximum power (1050 W) is applied to element A, giving a combined input of 1900 W;
where the available excess solar input exceeds the combined rating of elements A & B, the energy to element A is again reduced;
element B is switched off;
element C is switched in in parallel with element A;
element A is ramped up to its maximum rating or until the available excess solar input is reached;
where the energy to element A again reaches energy rating of element A, power to element A is again reduced, element B is switched in in parallel with elements A & C; and element A is again ramped up to its maximum rating or until the available excess solar input is reached.

FIG. 33B shows the power delivery profile when element A is set to zero modulation at a transition. This produces a saw-tooth profile due to the differences in the impedances of the elements A, B, and C not being chosen to product a smooth profile as shown in FIG. 33A.

However, by using the controller to apply a complementary non-zero modulation to element A at each transition, it is possible to provide a smooth linear profile with hysteresis to prevent hunting at the transitions. As shown in FIG. 33C, where element A is switched to a complementary, non-zero value at each transition to achieve an approximately continuous linear range of energy input to the water heater, there is an overlap at each transition. A first overlap between 850 W and 1050 W occurs between the single element (element A) configuration and the A+B configuration. Similarly, an overlap occurs between 1700 W and 1900 W at the A+B to A+C transition, and a third overlap occurs between the A+C and A+B+C transition from 2350 W and 2750 W.

These overlaps can be used as hysteresis in the switching protocol implemented by the controller, so that a switching of the electromechanical relays does not need to occur within these overlaps. Switching in either direction need only occur at the edges of the overlaps. Thus, with falling solar input, switching would be programmed to occur at the lower edge of the overlap, while, for increasing solar input, switching could be programmed to occur at the upper edge of the overlap. This can reduce the frequency with which the electromechanical relays need to switch. The offset modulation of element A can be used to provide a smooth power profile with unmatched elements, to provide switching transition hysteresis, or both.

It is not necessary that the offset modulation cancels the saw-tooth profile of FIG. 33B entirely. Another offset modulation value can be chosen to provide sufficient hysteresis to reduce hunting during temporary fluctuations in solar input. FIG. 33D illustrates an arrangement in which the offset modulation applied to element A on switching between different combinations of elements is less than that required to completely eliminate the sawtooth profile, resulting in a reduced sawtooth profile (heavy line X). When solar input is increasing, the switching follows the reduced sawtooth profile X as indicated by dashed line Y (offset from line X for illustrative purposes). When the solar input is decreasing, the switching pattern follows the dotted line Z (also offset from line X for illustrative purposes).

### EXAMPLE 1

Initially, the system starts with the modulation of A set to zero, and B and C switched off. In Stage 1, as the solar input increases to provide excess soar energy, the modulation of A is increased. When the modulation of A reaches its maximum energy input (A=1050 W), the modulation of A is switched to H1 and B is switched in (Stage 2). Because B+H1<A, the modulation of A is increased so A=B+H1, and the modulation of A continues to increase as the solar input increases. Assuming the solar input begins to fall during Stage 2, switching back to Stage 1 occurs when the input equals the energy rating of B (850 W). Thus, with increasing solar input, switching from Stage 1 to Stage 2 occurs at 850+H1 W, while, with falling solar input, switching from Stage 2 to Stage 1 occurs at 850 W. Similar offset procedures are followed between Stage 2 and Stage 3, and between Stage 3 and Stage 4. Thus the offset of modulation of A by setting its switching value to H1 instead of zero provides hysteresis which prevents “hunting” of the system due to temporary fluctuations less than H1.

Alternative or additional methods of providing hysteresis can be used. For example, a time delay for switching the elements can be programmed into the controller to take account of transient fluctuations of solar input. A suitable duration of the hysteresis time delay may be determined empirically from meteorological observations. The time period may be variable, depending on the prevailing cloud coverage. In some instances, a delay of 30 seconds may be chosen, or a longer period may be chosen. A manual input may be provided with the controller so a user can set the hysteresis delay, or online information may be used to select the delay duration. The controller may be connected to, and programmable via a communication device providing internet access to online cloud-cover information and local geographical location information which can be used to select a suitable hysteresis time delay.

A potential source of unwanted operation of the electromechanical relays is the random variation of solar input, due, for example, partial or complete occlusion of the solar collector, for example, when clouds overshadow the solar collector. This may be overcome by allowing the utility grid power to deliver power to the heating elements during such transient events. This method of operation can also reduce the switching of electromechanical relays. This can be achieved because the solar energy voltage can fall below the level of the mains voltage for the period of the transient occlusion.

FIGS. 37 to 51 are applicable to an embodiment of the invention in which heating elements of a water heater can be remotely controlled.

In FIG. 37, a water heating system includes a water heater tank 37.002, having a dual blade electrical heating element unit with separately controllable electrical heating blades 37.008, 37.010, located near the lower end of the tank. A first temperature sensor 37.012 senses the temperature of the water above the heating element unit, and a second temperature sensor senses 37.014 the temperature near the top of the tank. Heating blade 37.008 is connected to mains power by a first switch 37.018, and heating blade 37.010 is connected to mains power via a second switch 37.020.

A controller 37.016 receives temperature information from the temperature sensors 37.012, 37.014. In addition, a power line signal detector 37.024 is connected to detect signals on the mains supply line 37.015 and to notify the controller of signals which the signal detector detects.

A power utility management centre 37.036 is adapted to send signals to a signal injector 37.038 in the power supply line 37.015 via communication link 37.037. The line signal detector 37.024 is adapted to detect the signals injected into the power supply line by the utility management centre.

The controller 37.016 is adapted to control the switches 37.018, 37.020 and the associated heating element blades 37.008, 37.010, in response to inputs from the temperature sensors 37.012, 37.014, and from the power line signal detector 37.024.

Thus, for example, the default setting of the controller can be to apply power to both heating blades when the temperature of the water is below a first temperature threshold value. The controller can respond to the temperature sensor status information by reducing power to the heating element unit by switching off one of the blades when the temperature sensors indicate the thermal content of the water in the tank is at the first threshold value, and by cutting off power to both blades when the thermal content reaches a second threshold value higher than the first temperature threshold value.

The controller can also respond to signals received from the utility management centre via the line signal detector by reducing or cutting off power to the heating element blades in accordance with the received signals in response to information indicating the network load is at a predetermined level. The signals from the utility management centre can be given priority over the temperature sensor information where the action required by the line signals conflicts with the temperature sensor status information.

The communication link 37.037 between the utility management centre 37.036 and the signal injector 37.038 can utilize any suitable communication technology, such as internet, wireless, landline, etc.

FIG. 38 is similar to FIG. 37, the difference being that there are two single blade heating elements 38.008, 38.010. Heating element 38.010 is located near the bottom of tank 38.002, while heating element 38.008 is located in an upper portion of the tank.

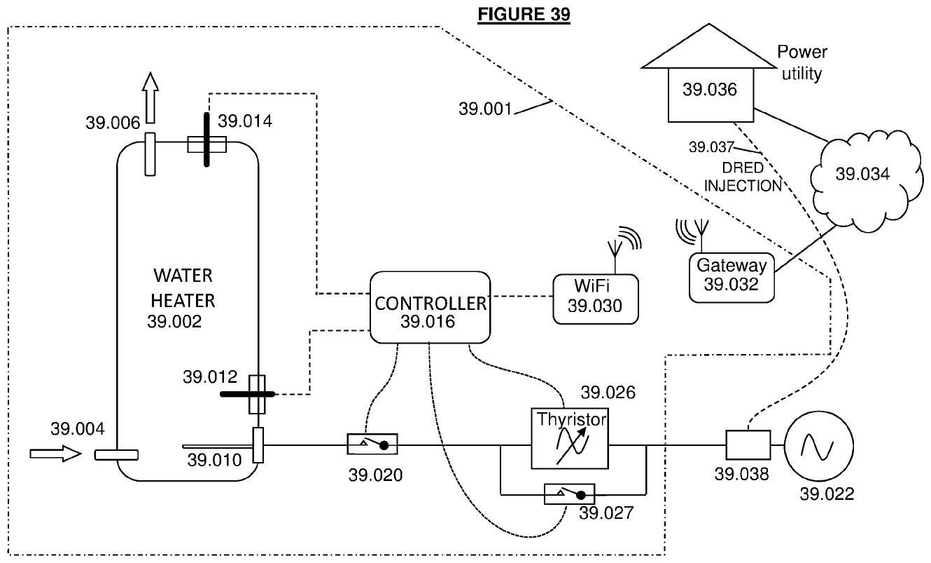

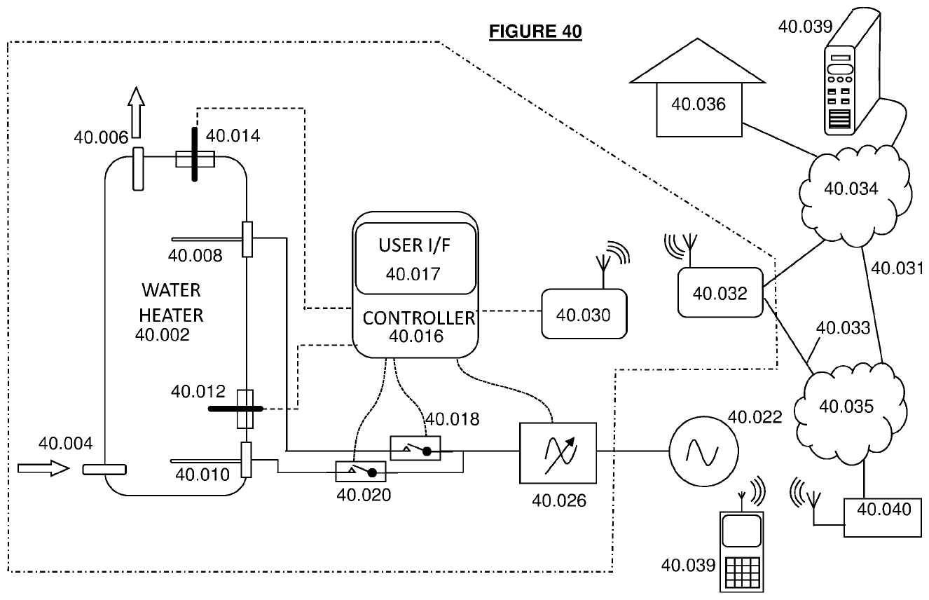

FIG. 39 is a schematic diagram of a water heater control system according to an embodiment of the invention installed at customer premises 39.001.

The water tank 39.002 has a cold water inlet 39.004 and a hot water outlet 39.006. Temperature sensors 39.012 and 39.014 sample the temperature of the water at a lower region and an upper region of the tank respectively.

An electrical heating element 39.010 is located near the bottom of the tank. Electrical power is delivered to the heating element from the mains supply 39.022 via a modulator 39.026, such as a thyristor or triac or other power regulating means. A mechanical relay switch 39.020 can be installed in series with the modulator in the circuit between the power supply 39.022 and the heating element 39.010. A shunt relay switch 39.027 can be installed in parallel with the modulator. The shunt relay can be closed to divert current around the modulator by the controller when unmodulated power is to be applied to the heating element 39.010.

A controller 39.016 receives temperature information from the temperature sensors 39.012, 39.014. The controller also receives input information and control signals via a wireless communicator 39.030. The wireless communicator can use any suitable wireless protocol such as Zigbee, Bluetooth, Wi-Fi and the like.

A network manager 39.036, which may be the power utility company or power retailer, is connected to the wireless communicator 39.030 via a communication network 39.034 and a local communication gateway 39.032 which is adapted to implement the same communication protocol as the wireless communicator 39.030.

The controller can be a programmable controller. The controller can be programmed to control the modulator 39.026 to control the amount of power delivered to the heating element 39.010. The controller is programmed to open switch 39.027 when modulated power is to be delivered to the heating element. The controller can be programmed to control the modulator to reduce the amount of power delivered to the heating element in accordance with instructions received from the network manager 39.036 or in accordance with a program stored in the controller.

The power supply utility 39.036 can inject a control signal into the power supply via control link 39.037 and control signal injector 39.038, which can be implemented, for example, using a coupling transformer.

The control link can be provided by any suitable communication link, such as wired, wireless via public cell phone network, private wireless network, or via a communications network 39.034 such as the internet.

FIG. 40 illustrates a water heating system according to an embodiment of the invention. A water heater tank 40.002 has a lower heating element 40.010 and an upper heating element 40.008. Temperature sensors 40.012 and 40.014 sense the temperature of the water in a lower portion of the tank and in an upper portion of the tank.

Controller 40.016 has inputs from the temperature sensors and a wireless communicator 40.030, which uses a suitable communication protocol and is adapted to communicate with the controller 40.016.

The controller can include a user interface 40.017 which can include user input capability, such as keypad, touch screen, operation menu scroll button, display and the like. The controller can be programmed to display operating modes, consumption statistics, and the like to enable the user to manage the operation of the water heater and monitor the usage and to select an operating mode.

The wireless communicator 40.030 communicates with a premises gateway 40.032 which is connected to a communication network 40.034. A utility manager 40.036 can communicate with the controller 40.016 via the network, gateway, and wireless communicator. The communication between the utility manager and the controller can be unidirectional or bidirectional.

Mains power 40.022 is connected to both heating elements 40.008, 40.010 via an electrical power modulator 40.026. The heating elements 40.008, 40.010 can be selectively connected to or disconnected from the output of the modulator via respective switches 40.018, 40.020.

The controller 40.016 is programmed to control the modulator 40.026 and the switches 40.018, 40.020 is response to signals from the temperature sensors 40.012, 40.014 and from the wireless communicator 40.030.

In a further embodiment of the invention, a user can be enabled to remotely control the water heater using a remote user device which may be, for example, a mobile phone (40.039), a mobile computer, a fixed computer, or the like. In the embodiment shown in FIG. 40, the user is enabled to communicate with the controller 40.016 via a smart phone 40.039. The smart phone can communicate with a cell base station 40.040 which is in communication with the gateway 40.032 via communication network 4.035 which is in communication with communication network 40.034. A program or app installed on the user device 40.039 or accessed from a network-based web page enables the user to monitor and control the water heater via controller 40.016.

Alternatively, network 40.035 can communicate with network 40.034. This alternative communication path also facilitates communication between the user device 40.038 and utility manager 40.036. The user can, for example, access a web page of the utility manager which may be located in a networked server connected to the network 40.034 and managed by the utility manager 40.036.

The utility server 40.039 can receive continuous data from controller and user can have read only access. A separate segment of server can enable user to modify user profile and water heating system management program, opt in/opt out of line signaling and the like.

Alternatively, gateway (or controller) can serve as relay between smart phone and server.

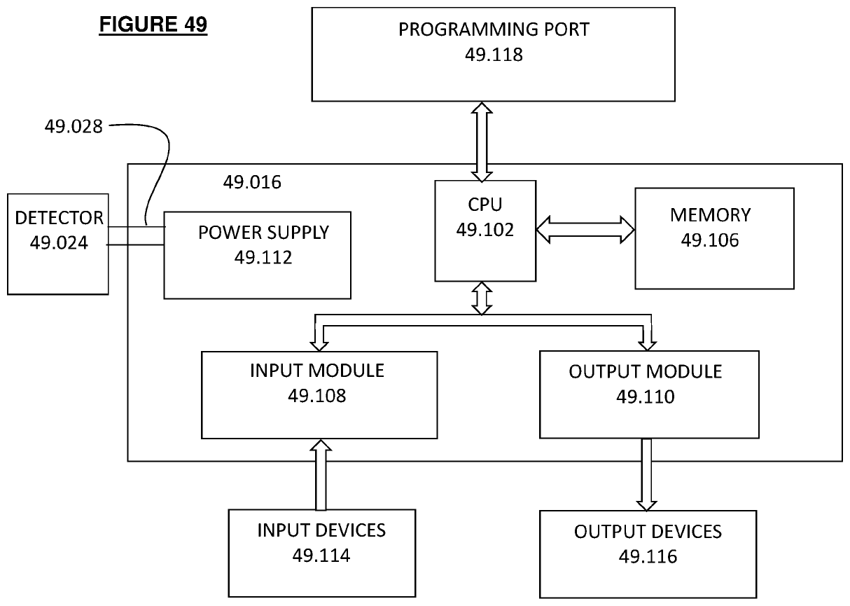

In one embodiment of the invention using the arrangement of FIG. 40 by way of example, the network manager 40.036 or the customer 40.039 can remotely configure the controller 40.016 to install or modify an operating program installed in the controller. FIG. 49 is a functional block diagram of a controller having a processor 49.102, functionally interconnected with memory 49.106, input module 49.108, output module 49.110, and programming port 49.118. Input devices 49.114 such as temperature sensors, line signal detectors, and power meters can be connected to the input module. The output module 49.110 can send control signals to output devices 49.116 such as heating element switches and power modulators. The programming port 49.118 can receive programming instructions from the power utility manager 40.036 or the customer 40.039 via a communication link such as wireless interface 40.030 which communicates with external communication networks via communication gateway 40.032, whereby programming instructions can be stored in memory 49.106. Additionally the customer or the network manager can initiate preconfigured programs stored in the memory 49.106. The signal detector 49.024 may require a source of external power. In one embodiment, power supply 49.116 of the controller 49.016 can be provided with an auxiliary power outlet 49.028. This facilitates the mounting of the signal detector 49.024 proximate to the water heater. In a further embodiment the signal detector can be integrated with the controller 49.016.

The utility manager instructions can be prioritized over local or remote customer inputs.

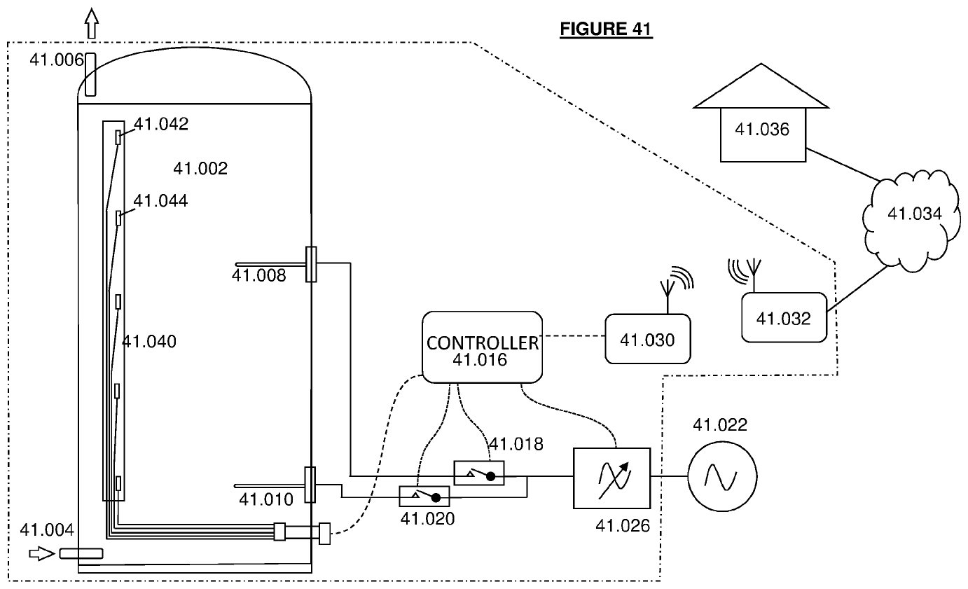

FIG. 41 illustrates a water heater system according to an embodiment of the invention, in which a continuous temperature sensor strip 41.040 is applied to the exterior of the tank 41.002. The water heater includes two electrical heating elements 41.008, 41.010, and temperature sensor strip 41.040. Controller 41.016 controls switches 41.018, 41.020 connecting heating elements 41.008, 41.010, to the power supply 41.022. A single modulator 41.026 is controlled by the controller to modulate the voltage applied to both heating elements. The continuous temperature sensor strip includes a layer of temperature sensitive resistive material carried in a suitable substrate with a number of spaced apart contacts such as 41.042, 41.044 in electrical contact with the temperature sensitive material, effectively providing a number of contiguous temperature sensors, between adjacent contacts. The contacts are connected to the controller 41.016. This enables the controller monitor the temperature of the water in segments corresponding to each region. The controller is programmed to utilize the temperature information to control the operation of the heating elements and modulator.

The power supply management centre 41.036 can communicate with the controller via communication network 41.034, premises gateway 41.032 and internal wireless communicator 41.030. The management centre can send control signals to the controller to, inter alia, control the switches 41.018, 41.020 and modulator 41.025. As described below, the communication between the management canter and the water heater control system can be bi-directional.

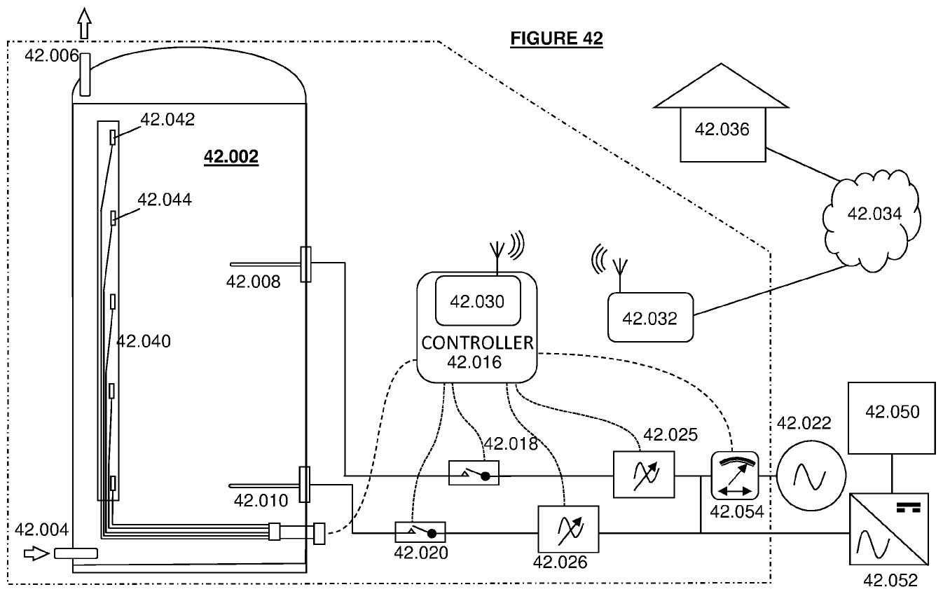

FIG. 42 illustrates a system similar to that of FIG. 41, with the addition of a solar energy power source 42.050, inverter 42.052, two-way power meter 42.054. The system can be designed so that, when sufficient solar power is available to supply other premises loads, such as lighting air-conditioning, refrigeration etc., any additional solar power is delivered to the water heater in priority over delivering solar power to the power grid 42.022. The two-way meter 42.054 monitors the power in and out of the premises. The power meter can be connected to the controller 42.016, and the times and amounts of power can be recorded by the controller for transmission to the power utility management centre 42.036. Optionally, the wireless communicator 42.030 can be incorporated in the controller 42.016.

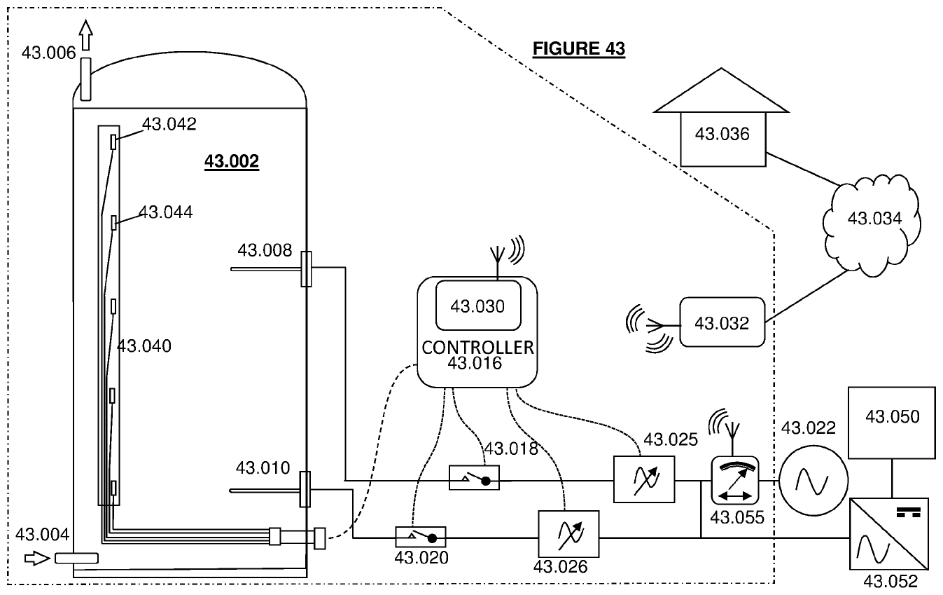

FIG. 43 shows a water heater control system according to an embodiment of the invention. The arrangement of FIG. 43 is similar to that of FIG. 42. However, the two-way meter 43.055 is fitted with wireless communication capability enabling it to communicate with gateway 43.032. The gateway can be configured to relay information from meter 43.055 to either the utility management centre 43.036 or to the controller 43.016 for storage and forwarding to the management centre.

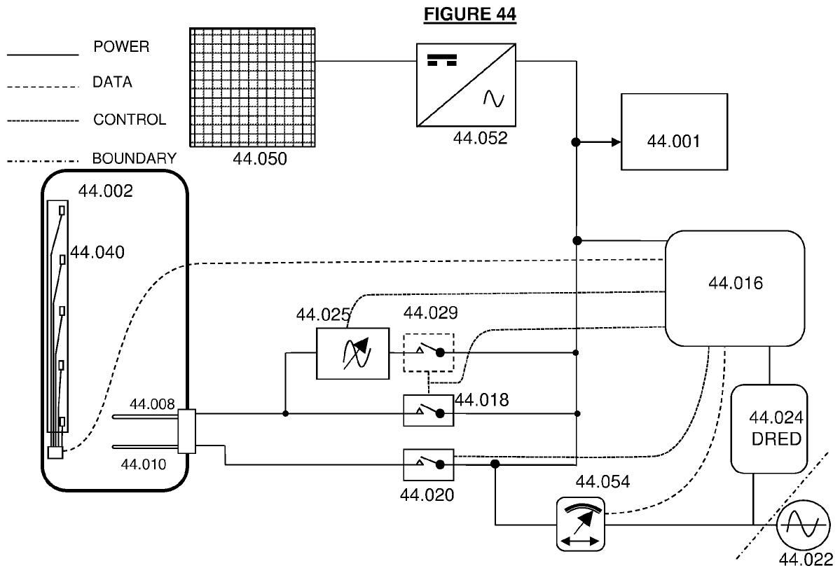

FIG. 44 illustrates a water heater control system according to an embodiment of the invention. A two-blade heating element unit 44.008, 44.010 is located near the lower portion of tank 44.002. The blades are individually controllable. Element 44.008 is connected to the mains power supply 44.022 via modulator 44.025. A shunt switch 44.018 can be provided to take the load from the modulator when full power is to be applied to element 44.008. An optional series switch 44.029 can be located in series with modulator 44.025. Switches 44.018, 44.029 can be configured to operate in a make-before-break mode such that switch 44.018 closes before switch 44.029 opens.

The heating element unit's second blade 44.020 is connected to the mains power supply via switch 44.020.

The utility management centre (not shown) can apply one or more signal bursts to the mains power supply line. A line signal detector 44.024 monitors the power input line to detect the signal bursts. and notify the controller 44.016 when a signal is detected and the nature or characteristics of the signal burst. The signal bursts can take various forms, such as a single frequency with bursts of different duration, indicating the nature of the operation to be carried out by the controller 44.016. The signal bursts can be chosen to cause the controller to reduce or shut off the power delivered to the water heater.

Alternatively, the signal bursts can be a combination of two or more signals of differing frequencies. For example, two frequencies, f1, f2, can be used to provide four different operating modes, eg, full power (both signals absent), moderately reduced power (40 to 60%) (f1 alone), half power (f2 alone), and substantially reduced power (e.g., 25 to 33 percent) (f1+f2). The available power adjustment is dependent on the resistance values of the heating element blades.

The injected signals can be detected by a suitable filter arrangement.

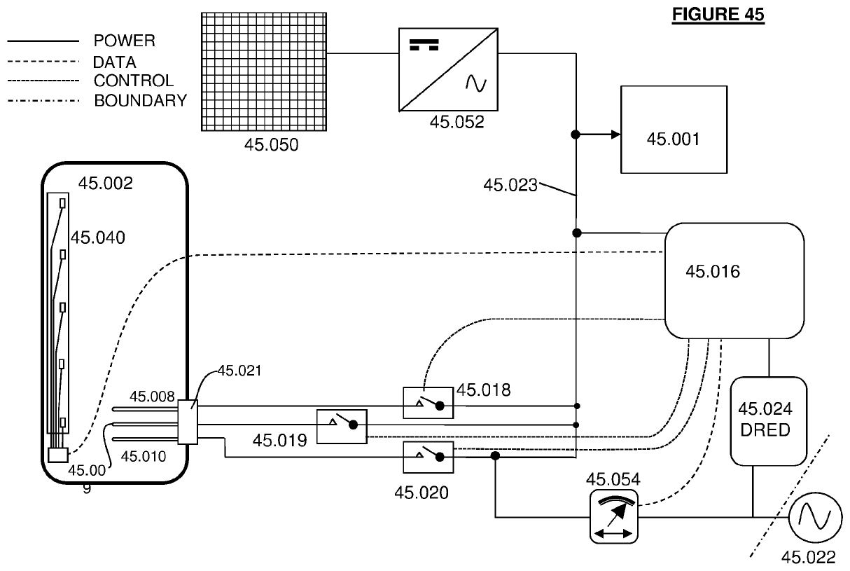

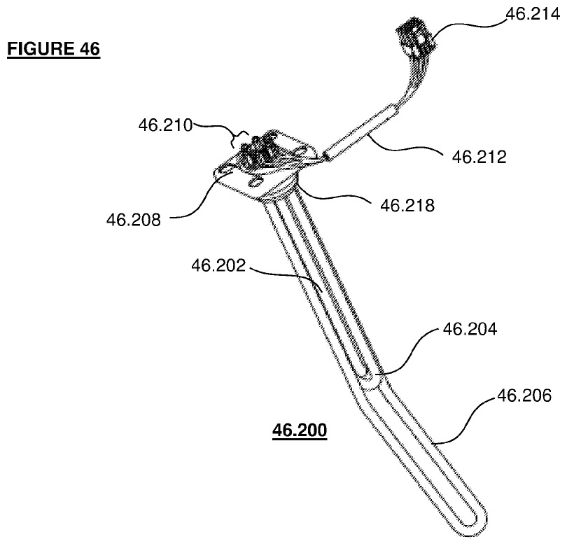

FIG. 45 shows a water heating system according to an embodiment of the invention. The water heater includes a heating element unit having three individually controllable blades, 45.008, 45.009, 45.010, each having an associated power switch 45.018, 45.019, 45.020. Line signal detector 45.024. Because the heating element unit is a single assembly of three heating element blades, only one element aperture in the tank wall is required to provide three individually controllable element blades.

The system of FIG. 45 includes both solar power, 45.050, 45.052, and mains power 45.022 delivering power to the water heater 45.002 and to other premises loads, 45.001 via a premises power bus 45.023. A two-way power meter 45.054 is adapted to accumulate readings of power in and power out of the premises bus. Alternatively, the readings from the meter 45.054 can be accumulated in the controller 45.016.

Line signal detector 45.024 is adapted to monitor the mains line to detect the presence of control signals and forward the control signals to the controller 45.016.

A three-blade electrical heating element unit 45.021 is sealingly connected to an aperture in the wall of the tank 45.002. The three heating element blades 45.008, 45.009, 45.010 are connected to the premises power bus 45.023 via switches 45.018, 45.019, 45.020. These switches are controlled by controller 45.016.

The controller is programmed to control the switches 45.018, 45.019, 45.020 in accordance with the control signals detected by the signal detector 45.024. For example, the control signals can require one of a number of different power levels to be applied to the heating element blades depending on the load on the power utility network. The power ratings of the heating element blades 45.008, 45.009, 45.010 can be chosen to meet the power input options determined by the power utility management entity. For example, the power utility management entity may choose five operating power levels such as: 0%, 25%, 50%, 75%, 100%. This would require element blades having resistance values of R, 2 R, and 2R. Expressed in power terms, this is X Watts, X/2 Watts, and X/2 Watts.

The controller can be programmed so that, when more than sufficient solar power is delivered from the solar collector to meet the internal loads 45.001, solar power is delivered to the water heater or to the mains. The controller can be programmed so that, when power is delivered to the water heater from the renewable power source, such as solar collector 9.505, the external signals are over-ridden so the receipt of external signals to reduce or cut off power to the water heater are not actioned.

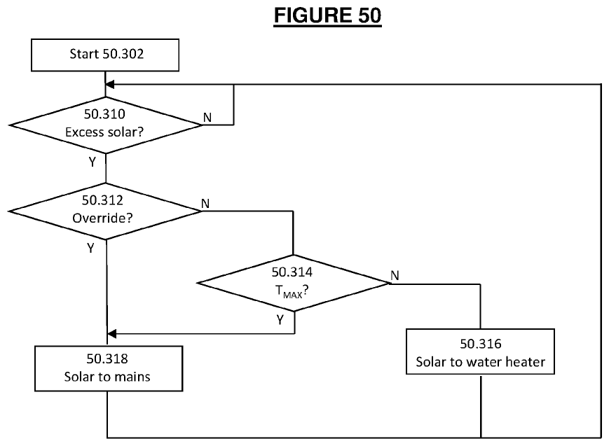

Alternatively, as illustrated in FIG. 50, the controller can be programmed to respond to a further external signal to cause solar power to be delivered to the mains, for example when the load on the mains generating capacity approaches the maximum available mains generated power. When the process is initiated at step 50.302, a first check is made to determine whether excess solar above other internal loads is available at step 50.310. If not, the controller continues to monitor the available solar power. If excess solar power is available a further check is made at step 50.312 to determine if the utility management centre has sent an override signal. If no override signal is received, solar power is delivered to the water heater at step 50.316, and the controller continues to monitor available solar power. If an override signal has been received at step 50.312, excess solar power is delivered to the mains at step 50.318. The controller can monitor the presence of the override signal from the utility management centre and the amount of solar power delivered to the power network and this can be reported to the utility management centre where a specific tariff rate can be applied. This scenario would assist the power utility management centre to maintain stability of the power generation system.

FIG. 52 shows an exploded view of a controller according to an embodiment of the invention. The piggy-back PCB 52.302 includes an aperture 52.701 adapted to enable a connector 52.702 to engage terminals 52.703 on relay board 52.302 which carries a power supply 52.112 and three relays each designated 52.322. As shown in FIG. 52, connector 52.702 provides connection points for wires delivering power to heating element blades. The terminals 53.703 receive electrical power via relays 52.722.

FIG. 53 shows the piggy-back PCB 53.302 mounted to relay board 53.306, with connector 53.702 connected to the power terminals 53.703 and projecting through the aperture 52.702.

FIG. 46 illustrates a three-blade heating element unit 46.200 according to an embodiment of the invention. The three blades 46.202, 46.204, and 46.206 are can have a substantially U-shaped form. The blades can be nested to provide a compact assemble capable of being inserted via a single aperture 47.088 in the tank wall 47.092 such as that illustrated in FIG. 47. One or more of the blades can include a bend to ensure the distal end does not interfere with the tank wall.

An element mounting flange 46.208 includes a number of mounting bolt holes adapted for assembly with corresponding mounting bolt holes 47.086 on tank mounting flange 47.080, as shown in FIG. 47. The tank mounting flange can be connected to the tank wall via a central tube 47.082 which is welded to the tank wall at 47.090 and defines an element insertion aperture 47.088. The tank mounting flange can include a seal seat 47.084 adapted to receive a seal 47.089. A corresponding seal surface 46.218 on the element unit assembly is adapted to sealingly engage the seal 47.089. A number of terminals 46.210 are mounted on the outward side of the element mounting assembly. The element blades can have a common neutral terminal so that only four terminals are required to connect the three blades. A cable 46.202 connects the element terminals to a connector 46.214.

While the preceding paragraphs describe a three-blade heating element unit 46.200, it will be readily understood that the three bladed element unit can be replaced by a two bladed heating element unit as illustrated in FIGS. 36A and or 36B, and as described above in relation thereto.

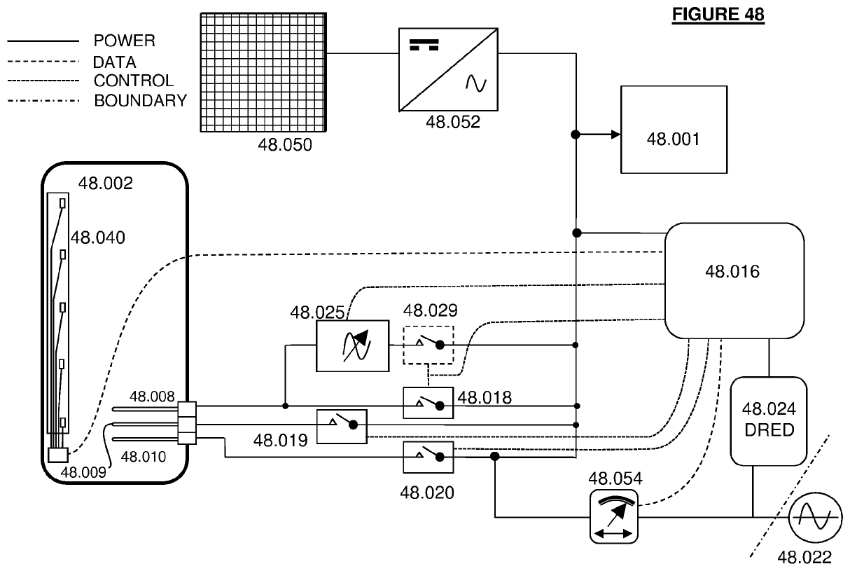

FIG. 48 illustrates a water heater system according to an embodiment of the invention. The arrangement of FIG. 48 is similar to that of FIG. 45 with a modulator 48.025 connecting the blade 48.008 to the premises power bus. This configuration enables the controller 48.016 to provide continuous control of the power from 0% to 100% delivered to the water tank. A shunt switch 48.018 is provided to divert current around the modulator 48.025 when blade 48.008 is operated at its maximum power.

FIG. 49 illustrates a controller 49.016 adapted to control a water heating system in accordance with an embodiment of the invention.

The controller includes a processor 49.102 and memory 49.106, an input module 49.108, an output module 49.116, and a power supply 49.112. Input devices 49.114 can provide input signals to the input module 49.108 which converts the signals from the input devices to a format suitable for the processor 49.102. The output module converts signals from the processor 49.102 to a format suitable for output devices 49.116.

The input devices can include temperature sensors, line signal detectors, power meters, and information or control signals delivered by wireless signals or over wired connections from a gateway, such as 41.032 in FIG. 41.

The processor can be programmed by a program stored in memory 49.106. The processor can store and retrieve data into or out of the memory. In addition, the processor can store control programs in the memory.

The programming port can be adapted to enable remote programming of the controller, for example, via the gateway 41.032. The controller can receive instructions from the power utility management entity to control the power delivered to the water heater, as well as to send consumption information from a meter.

In addition, a programming port 49.118 can be provided to enable programming of the processor.

The processor can include a clock to facilitate time-of-day control of the water heater.

A number of operating programs can be stored in the controller and can be selected to operate the water heater in a specified manner.

The controller can be programmed to respond to a number of control signals from the utility management centre depending on the load status on the electricity generation system.

The detector or DRED control unit 49.024 can include processing capability and storage capability to enable the detector or DRED control unit 49.024 to initiate or process information and or instructions, whether from the water heating system or the power utility management entity. It can include stored instructions and process commands for the water heating system.

One of, each of, or two or more in combination of the controller 49.016, the detector 49.024 and the control signals from the utility management centre, can be used to initiate a legionella control cycle for the water heater, so that legionella destruction conditions are produced in which the temperature is raised above a legionella destruction temperature for a predetermined period of time. For example 65° C. for a period of 5 minutes. Thus for the controller 49.016, the water heater can be programmed to automatically produce legionella destruction conditions. The DRED control unit or detector 49.024 can be likewise programmed to produce legionella destruction conditions in the water heater. The power utility management entity, can provide a control signal to cause the water heating system to produce legionella destruction conditions.

In one embodiment, the utility management centre can send control signals to the controller to increase the normal maximum temperature of the water from a first temperature T1, e.g. 60° C. or 65° C., to a second temperature T2, e.g., 75° C. This can be done, for example, during a low load period on the utility generation equipment to decrease the need to provide mains power to the water heater during a subsequent peak load period. This maximum temperature adjustment can be implemented by using the full rated power, or by using a proportion of the full rated power, such as 50% or 75% until the adjusted maximum temperature is achieved. This will the energy capacity of the water heater to go above, for example, a nominal 0.012 kWh/litre, thus for a 250 litre water heater it will be able to take on an extra 3.0 kWh of energy.

In one embodiment in which a three blade heating element has blade values of 75%, 50%, and 25% of rated power, the utility management centre can send the following control signals to the controller to cause the water heater to operate in one of the following modes:
Mode 1: The water heater is turned off.
Mode 2: The water heater can use a first proportion (e.g., 50%) of normal power using the 50% blade.
Mode 3: The water heater can use a second proportion (e.g., 75%) of normal power using the 75% blade, or alternatively the 50% and 25% blades can be used.
Mode 4: The water heater can heat the water to a higher than normal temperature using 100% of the rated power delivered by the 75% blade and the 25% blade.

Mode 1 can be implemented when there is a first level of load on the power generation system approaching the peak generation capacity. Mode 2 can be implemented when at a second load level below the first load level. Mode 3 can be implemented at a third load level below the second load level. Mode 4 can be implemented at a fourth load level below the third load level. Mode 4 requires the water heater controller to be adapted to change its maximum cutoff temperature from T1 to T2.

An advantage of this configuration is that the 50%, 75% and 100% can be provided by energizing a single blade or two blades, there being no need to energize all three blades.

In an alternative configuration, the blades can have ratings of 50%, 25%, and 25% and still achieve the 50%, 75% and 100% rated power delivery, the 100% rated power delivery being achieved by energizing all three blades. This configuration has the advantage that the highest rated blade needs to carry only 50% of the rated power compared with 75% for the previous configuration.

While the power ratings are expressed as simple fractions of the rated power, other blade ratings can be used and still be in substantial compliance with the network management requirements of the utility management centre as precise compliance with the ratings is not essential. For example blade ratings of 23.6%, 29.2%, and 47.2% of the rated power can be used. While it is possible to achieve the reduced power ratings by intermittently switching full power, or applying full power for reduced time periods, the preferred embodiment utilizes continuous but steady state reduced power.

In a third configuration, the heating element has only one blade with 100% power rating. In this configuration, the power can be applied to the blade using a duty cycle to meet the 50% or 75% power consumption. Alternatively, as described above with reference to FIG. 39, a power modulator 39.026 can be utilized with a single blade to achieve a specified power consumption.

It will be understood that the electronics associated with the above control systems will include on-board over temperature protection, to protect the electronics, in the temperature environments which may result.

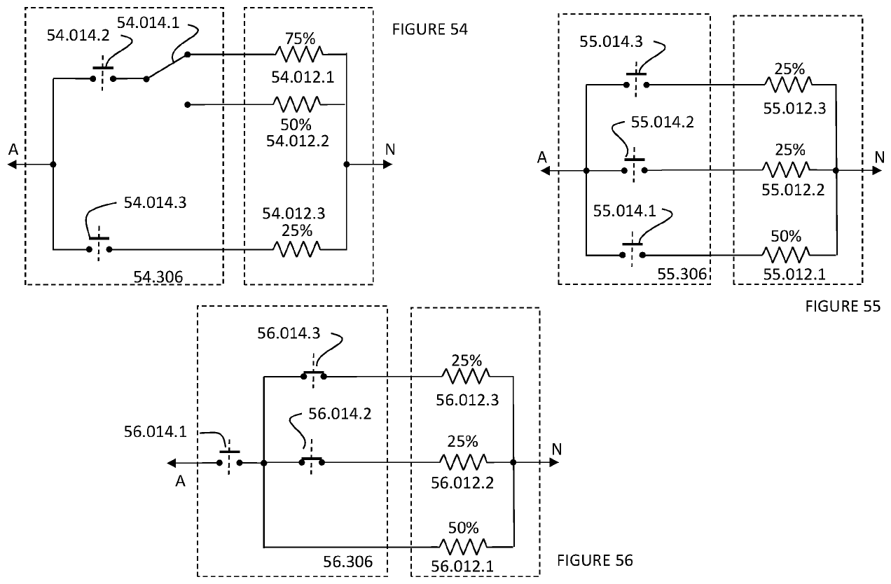

FIGS. 54, 55, and 56 show various switching configurations for a three blade heating element, such as that illustrated in FIG. 46 and identified as item 46.200. FIGS. 54, 55, and 56, exemplify various switching configurations can be employed to provide the variations in power drawn by the water heater. In FIG. 54, there are three blades: blade 54.012.1 having a power rating of 75% of full rated power of the water heater; blade 54.012.2 having a power rating of 50% of full rated power of the water heater; and blade 54.12.3 having a power rating of 25% of full rated power of the water heater. They have a common neutral connection N. Blades 54.012.1 and 54.012.2 are connected to the active line A by a series arrangement of first relay contact 54.014.2 and a change-over relay contact 54.014.1, with the contacts 54.014.1 being a change-over switch. Blade 54.012.3 is connected to the active line A by relay contact 54.014.3. In this arrangement 100% load can be achieved by the combination of blade 54.012.1 and 54.012.3. 75% load can be achieved either by blade 54.012.1 on its own, or by a combination of blades 54.012.2 and 54.012.3. 50% load can be achieved by blade 54.012.2 on its own. 25% load can be achieved by blade 54.012.3 on its own. Change-over switch 54.014.1 ensures that the maximum rated load of 100% is not exceeded by the connection of blades 54.012.1 and 54.012.2 at the same time.

In FIG. 55 the blades are rated at 50%, 25% and 25% of full rated power. In this arrangement, each blade has a dedicated relay, and all three blades need to be connected to provide 100% of rated power usage.

The arrangement of FIG. 56 also has blades rated at 50%, 25%, and 25%. The normally open relay 56.014.1 is common to all blades, and blades 56.012.2 and 56.012.3 each have an additional normally closed relay 56.014.2, 56.014.3 respectively in series with relay 56.014.1. Blade 56.012.1 is rated at 50%, so the lowest power usage available in this configuration is 50%. 75% can be achieved by using blade 56.012.2 or 56.012.3 with blade 56.012.1. 100% requires all three blades. To deliver 100% rated power, only normally open relay 56.014.1 needs to be closed. To deliver 75% power, one of normally closed relays 56.014.2 or 56.014.3 is opened. To deliver 50% power, both normally closed relays 56.014.2 or 56.014.3 are opened.

In the arrangements of the preferred embodiment the maximum switching power is of the order of 1.8 KW for a 3.6 KW water heater, and this reduces the load on the relays and extends relay life. The relay coils are preferably of low power, say of the order of 0.4 W each. With 3 independent relays the system described will be tolerant of single relay failures with any one element failure resulting in loss of either 25% or 50% of heating power. The relays 55.014.1, 55.014.2 and 55.014.3 as illustrated in FIG. 55 are normally open, whereby if one of these relays were to fail, then this results in loss of either 25% or 50% of heating power. In like manner, the relays 54.014.2 and 54.014.3 means that if 54.014.3 fails then the system can still provide 75% or 50% power. Should 54.014.2 fail, the system can provide 25% power. Also in like manner, the relays 56.014.1, 56.014.1, and 56.014.3 mean that if either 56.014.2 or 56.014.3 fails then the system can still provide 50% or 75% power. Whereas if 56.014.1 were to fail, no power would be provided. The relay systems can be constructed with normally open or normally closed relays depending upon which failure mode is desired for an electrical system under consideration. If normally closed relays were to be selected then the water heaters thermostat cut off or ECO will be relied upon to operate when maximum temperature is achieved.

As discussed above with reference to FIG. 40, a remote user can also provide input commands and receive information from the controller via a mobile device or fixed remote device via the gateway and communication network.

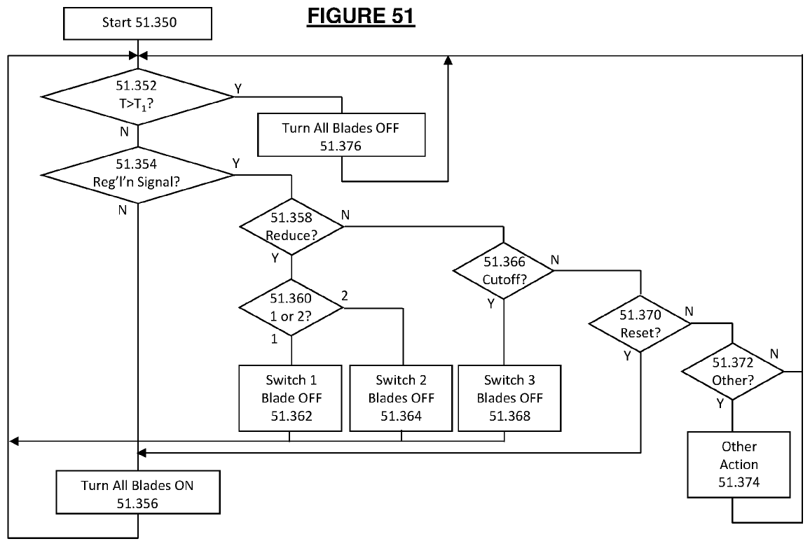

FIG. 51 is a flow chart illustrating a method of operating a water heating system in accordance with an embodiment of the invention.

At step 51.352 the controller monitors the temperature or thermal content of the tank to determine whether it is below a first threshold value T1.

If the temperature is at the threshold value, the controller turns all the heating element blades off at step 51.376 and the controller returns to step 51.352 to monitor the temperature or thermal content.

In the event that the temperature is below the threshold value, the controller checks for the presence of an external regulation signal at step 51.352.

If no external regulation signal is present, the controller turns the heating element blades on at step 51.356.

If an external regulation signal is present, the controller analyses the external regulation signal to determine what action is required by the external regulation signal at steps 51.358, 51.360, 51.366, and 51.370. cancel/reset

At steps 51.358, 51.360, the controller determines whether the external regulation signal requires a reduction or cut off of power to the heating element blades, and, where a reduction is required, how many blades are to be switched off. 1 or 2 of the blades is then turned off at steps 51.362, 51.364.

If the external regulation signal is not a reduction signal, the controller then determines whether it is a cutoff signal at step 51.366, or a reset (cancel) signal at step 51.370.

If the external regulation signal is a cutoff signal, the controller switches all blades off at step 51.368.

If the external regulation signal is a reset signal, the controller switches all blades on at step 51.356, and the controller returns to step 51.352 to monitor the temperature or thermal content.

Optionally, if the external regulation signal is not a reset signal, the controller can check whether the external regulation signal requires other action at steps 51.372, and implement the other action at step 51.374 before returning to the temperature/thermal content monitoring step 51.352.

Other actions can include different operational modes. One such mode can be vacation mode, which can be instigated by the customer, for example, using a remote device such as 40.039 as described with reference to FIG. 40.

### APPLICATION OF THE INVENTION

The embodiments described above in paragraphs 230 to 362 with respect to FIGS. 1 to 30 are applicable to the construction and operation of water heaters.

Whereas the embodiments described above in relation to paragraphs 363 to 447, with respect to FIGS. 31 to 36, are applicable to solar electric heating, and has an advantage over direct solar thermal heating of water because, when the insolation is insufficient to heat the water or heat transfer fluid in the solar thermal collector to a temperature above the temperature of the water in the tank, no heat is added to the water in the tank. Solar photovoltaic, on the other hand has the advantage that, as long as there is sufficient insolation to power the solar PV collector, energy can be added to the water in the tank. Thus solar photovoltaic heating can operate to heat the water at lower levels of insolation.

The method of combining switching and modulation provides a means for continuously varying the current supplied to the heating unit. The current drawn from the PV collector can be continuously varied. This means that the current drawn from the PV collector can be matched to the maximum power point of the PV collector, enabling efficient use of the insolation at all levels.

The inventive concept can be applied to solar PV water heating systems having one or more multi-element heating units that are controlled by combining both modulation (varying power) and switching to achieve linear variable power control over the range zero to X kw's.

A three-element design can be chosen for a total 2 kW rating in 500 W steps. Changing the number of elements and the modulator size (modulation increment) allows for many different variations on the design. The concept can be applied to discrete elements and that the modulator may or may not use the full rating of the individual elements in all cases to achieve the linear ramp up from 0 to the desired X kW.

An example of a tri-element heating unit can cover the range zero to 2.0 Kw (@240 v=28.8Ω; (r=V²/P). A element indexing step of 500 W can be used as this is common to many “off the shelf”, Australian approved devices that use Triac based power modulation control. However other element ratings can be used.

The combination of progressively increasing the modulator output and progressively switching in additional elements facilitates the ability to provide a continuous range of input power to the heating unit from the PV collector.

The heating elements of the present invention can be designed as a replacement for a single element, the shape and size of the multi-element heating unit being adapted as a direct replacement for an existing single element heating unit. Thus a heating assembly with controller, modulator, element switching and multi-element heater can be provided as a replacement heating system for an existing single element water heater.

The embodiments described above in respect of paragraphs 448 to 516, with respect to FIGS. 37 to 56, are also applicable to electrical element units, electrical water heater systems, water heater controllers, and methods of operating electrical water heaters.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1-89. (canceled)

90. A water heating system including:
a water tank; and
at least one electrical heating element unit;
the electrical heating unit including one, two, three, or more, independently controllable blades;
each blade being connected to an electrical power line via at least one corresponding power control arrangement;
wherein each electrical heating unit is inserted into the tank via a corresponding aperture in the tank.

91. The water heating system as claimed in claim 90, wherein the power control arrangement includes any one or combination of:
a switch; and
a power modulation device, which optionally produces a continually variable power output.

92. The water heating system as claimed in claim 90, wherein the water heating system includes a controller adapted to control each power control arrangement.

93. The water heating system as claimed in claim 92, wherein the controller is adapted to change the maximum water temperature setting between a first temperature and a second temperature higher than the first temperature in response to a maximum temperature control signal, the system preferably including a renewable energy supply, wherein the controller is adapted to change the maximum water temperature setting between a first temperature and a second temperature higher than the first temperature when sufficient renewable power is available.

94. The water heating system as claimed in claim 90, wherein the controller is responsive to external control signals to operate one or more of the power control devices to control the amount of power delivered to the or each electrical heating element unit, and wherein the external control signal is optionally selected from one or more of: power line signaling; wireless; and, physical line.

95. The water heating system as claimed in claim 90, wherein the water heating system is powered by solar power or mains power.

96. The water heating system as claimed in claim 90, wherein the water heating system can include one or more of the following: a directional power meter; a connection terminal for each blade and a common terminal common to all blades.

97. A method of controlling the delivery of electric power to an electrical water heater including one or more electrical heating blades, the method including the steps of:
monitoring for the presence of one or more external power regulation signals;
in the absence of an external power regulation signal, delivering mains power to the, or each, blade in accordance with a first routine; and
in the presence of an external regulation signal,
analyzing the external regulation signal; and
depending on the analysis of the external regulation signal, either
varying the power delivered to the blades, or
cutting off the power to the blades;
wherein the external regulation signal is optionally selected from:
one or more power variation signals; and, a cut off signal.

98. An electric water heater including a water tank, at least one heating element blade, each blade being separately controllable via power control means, a controller adapted to control the power control means, the controller including an instruction store, the controller having a programming input via which instructions can be stored in the instruction store or memory, wherein instructions are optionally sent to the programming input via a communication link.

99. The electric water heater as claimed in claim 98, including one or more electrical heating elements, each heating element being connected to an externally accessible connection means, wherein the tank is configured with one or more of the following:
a) temperature sensing means adapted to obtain a measurement of the temperature of the water in the tank;
b) a power control device being connected to the externally accessible connection means;
c) one or more temperature control switches each connected to a corresponding one of the heating elements; and
d) a heat sink.

100. The electric water heater tank as claimed in claim 99, including any one or combination of:
one or more heating element control means each connected to a corresponding one of the heating elements;
the element controller means includes one or more thermal cut-out switches each associated with one of the electrical heating elements, each thermal cut-out switch including first temperature sensing means adapted to cause the cut-out switch to cut off power to the corresponding heating element when the temperature of the water reaches a first threshold temperature;
the element control means being connected to the externally accessible connection means;
the heating element control means including at least one temperature controller associated with a corresponding heating element, each temperature controller including second temperature sensing means and a power control switch adapted to cut off power to the corresponding heating element when the temperature of the water reaches a second threshold temperature equal to or lower than the first temperature threshold;
at least one power switch controller controlling corresponding power switches; and
the power control switches are mounted on or near respective ones of the first element controllers.

101. The electric water heater as claimed in claim 100, including a first heating element, and one or more further heating elements located at different heights within the tank, and two or more element controllers, each associated with a corresponding one of the heating elements;
the heating elements having electrical connections projecting through the wall of the tank;
each element controller being mounted adjacent to, or the vicinity of, the electrical connections of the heating elements.

102. The electric water heater as claimed in claim 101,
wherein a wiring harness is used to connect the first heating element to the other heating elements and includes a single connector adapted to connect both signalling and power wires to one or more controllers,
wherein said first heating element and/or said one or more further heating elements include two or more blades,
wherein said element controller optionally includes an electric cut-out and or relays to control blades of said first heating element and or said one or more further heating elements, and
wherein said blades are optionally of the same resistance and or power output rating or are of differing resistance and or power output rating.

103. The electric water heater as claimed in claim 98, including:
electrical connections for the heating elements projecting through the wall of the tank;
at least one thermosensor; and
a combined wiring harness having an externally accessible first external connector adapted to connect both power wires and signalling wires to external circuitry via a complementary second external connector.

104. The electric water heater as claimed in claim 103, including any one or combination of:
a jacket, and wherein the external connector is located either within or outside a jacket;
the combined wiring harness including a signalling connector adapted to connect one or more signalling wires to a signalling cable to the external connector;
the wiring harness including a power connector adapted to deliver power from the external connector to the or each heating element;
an external controller, the signalling wires being connected to the controller; and
one or more external power switches being responsive to the external controller to control delivery of power to the heating elements.

105. The electric water heater as claimed in claim 100, including a power control element, and a heat sink, the tank including a cold water inlet proximate the lower end of the tank, the heat sink being mounted proximate the lower end of the tank, the power control element being mounted on the heat sink, wherein a first heat sink mounting attachment is optionally attached to the wall of the tank proximate to the lower end of the tank.

106. The electric water heater as claimed in claim 100, including temperature sensing means adapted to obtain a measurement of the temperature of the water in the tank, the temperature sensing means and each heating element being connected to an externally accessible connection means.

107. The water heater as claimed in claim 106, including any one or combination of:
one or more heating element control means each being connected to a corresponding one of the heating elements;
the heating element control means including one or more thermal cut-out switches adapted to disconnect the or each electrical heating element when the temperature of the water exceeds a first threshold temperature;
the heating element control means including one or more temperature control switches, each switch being adapted to disconnect power from a corresponding one of the electrical heating elements when the temperature of the water exceeds a second threshold temperature;
the or each temperature control switch control means is connected to the externally accessible connection means;
said temperature sensing means being adapted to obtain temperature of water at different heights of said tank; and
said temperature sensing means being located outside or inside of said tank.

108. A method of installing the water heater as claimed in claim 99, wherein the tank is configured with at least a temperature sensor and one or more heating elements connected to an externally accessible connection means, the method including the steps of installing the tank at a user's premises, and connecting a variable power supply and controller to the externally accessible connection means.

109. The method as claimed in claim 108 including any one or combination of:
the tank being configured with a heat sink and power control device;
the tank being configured with temperature control switches proximate the or each heating element;
the step of installing temperature control switches upstream of the connection means; and
the step of installing the power control device upstream of the connection means.
